(19) United States
(12) Patent Application Publication
(10) Pub. No.: US 2026/0220199 A1
(43) Pub. Date: Jul. 30, 2026

(54) GRAPH-BASED MODELS WITH RUN-TIME BI-DIRECTIONAL NODES

(71) Applicant: Infosys Limited, Bangalore (IN)

(72) Inventor: Steven SCHILDERS, Columbus, IN (US)

(73) Assignees: Infosys Limited, Bangalore (IN); InvertIT Inc., Columbus, IN (US)

(21) Appl. No.: 19/040,422

(22) Filed: Jan. 29, 2025

(51) Int. Cl. G06F 16/901

(52) U.S. Cl. CPC G06F 16/9024

(57) ABSTRACT

An overlay system is provided that includes a storage element and processing circuitry coupled thereto. The storage element stores an executable graph-based model having a plurality of run-time bi-directional nodes and a plurality of run-time connection links. Each run-time bi-directional node includes a node template and a node instance. The processing circuitry receives a stimulus and identifies a first run-time bi-directional node based on the stimulus. The processing circuitry determines a first run-time connection link based on the identification of the first run-time bi-directional node. The first run-time bi-directional node is coupled to a second run-time bi-directional node via the first run-time connection link. The processing circuitry further identifies the second run-time bi-directional node and executes the operation associated with the stimulus based on the first run-time bi-directional node, the second run-time bi-directional node, and the first run-time connection link.

### FIELD OF THE DISCLOSURE

Various embodiments of the present disclosure relate generally to graph-based models. More specifically, various embodiments of the present disclosure relate to executable graph-based models with run-time bi-directional nodes.

### BACKGROUND

Graph-based models may be extensively utilized across various fields, including artificial intelligence and database management. These models comprise nodes (e.g., vertices) and edges, where vertices represent real-world entities, and edges signify the relationships among these entities. In a standard graph-based model, a node is linked to another node through an edge, with the edge defining a specific relationship or role between them.

When implementing a graph-based model, a primary node is initially loaded based on its requirement. This process may include performing a lookup operation to identify additional nodes associated with the primary node, which may also be required to be loaded into the model. Subsequently, both the primary node and all associated nodes may be loaded into the graph-based model. However, this approach poses several challenges. Conducting lookup operations to identify associated nodes can be resource-intensive and time-consuming, leading to increased operational costs and extended execution times. In practical applications, especially with highly interconnected large-scale nodes, this process may introduce substantial latency, adversely impacting the overall system performance.

In light of the foregoing, there exists a need for a technical and reliable solution that overcomes the abovementioned problems.

Limitations and disadvantages of conventional and traditional approaches will become apparent to one of skill in the art, through the comparison of described systems with some aspects of the present disclosure, as set forth in the remainder of the present application and with reference to the drawings.

### SUMMARY

Methods and systems for facilitating run-time bi-directional nodes in executable graph-based models may be provided substantially as shown in, and described in connection with, at least one of the figures.

An overlay system disclosed herein provides for a storage element configured to store an executable graph-based model that includes a plurality of run-time bi-directional nodes and a plurality of run-time connection links. Each run-time bi-directional node of the plurality of run-time bi-directional nodes includes (i) a node template that corresponds to a predefined bi-directional node structure and (ii) a node instance that corresponds to an implementation of the node template. The overlay system further provides for processing circuitry that is coupled to the storage element. The processing circuitry is configured to receive a stimulus associated with the overlay system. The processing circuitry is further configured to identify, based on the stimulus, a first run-time bi-directional node from the plurality of run-time bi-directional nodes. The processing circuitry is further configured to determine a first run-time connection link, of the plurality of run-time connection links, coupled to the first run-time bi-directional node, the first run-time connection link including a first outward connection object defining association with the first run-time bi-directional node and a first inward connection object defining association with a second run-time bi-directional node of the plurality of run-time bi-directional nodes. The processing circuitry is further configured to identify, based on the first run-time connection link, the second run-time bi-directional node. The processing circuitry is further configured to execute an operation associated with the stimulus based on the first run-time bi-directional node, the second run-time bi-directional node, and the first run-time connection link.

In some embodiments, the first outward connection object and the first inward connection object have a primary role and a secondary role, respectively. The primary role and the secondary role, collectively, indicate a capacity in which the first run-time bi-directional node and the second run-time bi-directional node are mutually associated. The operation associated with the stimulus is executed in conformity with the primary role and the secondary role.

In some embodiments, the executable graph-based model further includes a plurality of run-time bi-directional overlay nodes with each run-time bi-directional overlay node including (i) an overlay node template that corresponds to a predefined bi-directional overlay node structure, and (ii) an overlay node instance that corresponds to an implementation of the overlay node template. The processing circuitry is further configured to determine a first set of run-time bi-directional overlay nodes, of the plurality of run-time bi-directional overlay nodes, that is associated with the first run-time bi-directional node. Each of the first set of run-time bi-directional overlay nodes is configured to extend functionality of the first run-time bi-directional node. The operation associated with the stimulus is executed further based on the first set of run-time bi-directional overlay nodes.

In some embodiments, the executable graph-based model further includes a plurality of generic run-time overlay nodes with each generic run-time overlay node including (i) an overlay node template that corresponds to a predefined generic overlay node structure, and (ii) an overlay node instance that corresponds to an implementation of the overlay node template. The processing circuitry is further configured to determine a first set of generic run-time overlay nodes, of the plurality of generic run-time overlay nodes, that is associated with the first run-time bi-directional node. Each of the first set of generic run-time overlay nodes is configured to extend the functionality of the first run-time bi-directional node. The operation associated with the stimulus is executed further based on the first set of generic run-time overlay nodes.

In some embodiments, the first set of run-time bi-directional overlay nodes is associated with the first run-time bi-directional node by way of one of a group consisting of a direct association and a second run-time connection link of the plurality of run-time connection links.

In some embodiments, the executable graph-based model further includes a plurality of run-time bi-directional overlay nodes with each run-time bi-directional overlay node including (i) an overlay node template that corresponds to a predefined bi-directional overlay node structure, and (ii) an overlay node instance that corresponds to an implementation of the overlay node template. The processing circuitry is further configured to determine a second set of run-time bi-directional overlay nodes, of the plurality of run-time bi-directional overlay nodes, that is associated with the second run-time bi-directional node. Each of the second set of run-time bi-directional overlay nodes is configured to extend functionality of the second run-time bi-directional node. The operation associated with the stimulus is executed further based on the second set of run-time bi-directional overlay nodes.

In some embodiments, the executable graph-based model further includes a plurality of run-time bi-directional overlay nodes with each run-time bi-directional overlay node including (i) an overlay node template that corresponds to a predefined bi-directional overlay node structure, and (ii) an overlay node instance that corresponds to an implementation of the overlay node template. The processing circuitry is further configured to determine a third set of run-time bi-directional overlay nodes, of the plurality of run-time bi-directional overlay nodes, that is associated with the first outward connection object. Each of the third set of run-time bi-directional overlay nodes is configured to extend functionality of the first outward connection object. The operation associated with the stimulus is executed further based on the third set of run-time bi-directional overlay nodes.

In some embodiments, the executable graph-based model further includes a plurality of run-time bi-directional overlay nodes with each run-time bi-directional overlay node including (i) an overlay node template that corresponds to a predefined bi-directional overlay node structure, and (ii) an overlay node instance that corresponds to an implementation of the overlay node template. The processing circuitry is further configured to determine a fourth set of run-time bi-directional overlay nodes, of the plurality of run-time bi-directional overlay nodes, that is associated with the first inward connection object. Each of the fourth set of run-time bi-directional overlay nodes is configured to extend functionality of the first inward connection object. The operation associated with the stimulus is executed further based on the fourth set of run-time bi-directional overlay nodes.

In some embodiments, a node-type of a run-time bi-directional node of the plurality of run-time bi-directional nodes is an edge node-type.

In some embodiments, the first run-time bi-directional node is further coupled to a third run-time bi-directional node of the plurality of run-time bi-directional nodes by way of a third run-time connection link of the plurality of run-time connection links. The third run-time connection link includes a second outward connection object and a second inward connection object that define association with the first run-time bi-directional node and the third run-time bi-directional node, respectively. The first outward connection object and the second outward connection object constitute an outward group object associated with the first run-time bi-directional node. The operation associated with the stimulus is executed further based on the outward group object, the third run-time bi-directional node, and the third run-time connection link.

In some embodiments, the operation is executed based on the first run-time bi-directional node communicating with the second run-time bi-directional node and the third run-time bi-directional node by way of the outward group object.

In some embodiments, the executable graph-based model further includes a plurality of run-time bi-directional overlay nodes with each run-time bi-directional overlay node including (i) an overlay node template that corresponds to a predefined bi-directional overlay node structure, and (ii) an overlay node instance that corresponds to an implementation of the overlay node template. The processing circuitry is further configured to determine a fifth set of run-time bi-directional overlay nodes, of the plurality of run-time bi-directional overlay nodes, that is associated with the outward group object. Each of the fifth set of run-time bi-directional overlay nodes is configured to extend functionality of the outward group object. The operation associated with the stimulus is executed further based on the fifth set of run-time bi-directional overlay nodes.

In some embodiments, the executable graph-based model further includes a plurality of generic run-time overlay nodes with each generic run-time overlay node including (i) an overlay node template that corresponds to a predefined generic overlay node structure, and (ii) an overlay node instance that corresponds to an implementation of the overlay node template. The processing circuitry is further configured to determine a second set of generic run-time overlay nodes, of the plurality of generic run-time overlay nodes, that is associated with the outward group object. Each of the second set of generic run-time overlay nodes is configured to extend functionality of the outward group object. The operation associated with the stimulus is executed further based on the second set of generic run-time overlay nodes.

In some embodiments, the first run-time bi-directional node is further coupled to a fourth run-time bi-directional node and a fifth run-time bi-directional node, of the plurality of run-time bi-directional nodes, by way of a fourth run-time connection link and a fifth run-time connection link, of the plurality of run-time connection links, respectively. The fourth run-time connection link includes a third inward connection object and a third outward connection object that define association with the first run-time bi-directional node and the fourth run-time bi-directional node, respectively. The fifth run-time connection link includes a fourth inward connection object and a fourth outward connection object that define association with the first run-time bi-directional node and the fifth run-time bi-directional node, respectively. The third inward connection object and the fourth inward connection object constitute an inward group object associated with the first run-time bi-directional node. The operation associated with the stimulus is executed further based on the inward group object, the fourth run-time bi-directional node, the fifth run-time bi-directional node, the fourth run-time connection link, and the fifth run-time connection link.

In some embodiments, the operation is executed further based on the first run-time bi-directional node communicating with the fourth run-time bi-directional node and the fifth run-time bi-directional node by way of the inward group object.

In some embodiments, the executable graph-based model further includes a plurality of run-time bi-directional overlay nodes with each run-time bi-directional overlay node including (i) an overlay node template that corresponds to a predefined bi-directional overlay node structure, and (ii) an overlay node instance that corresponds to an implementation of the overlay node template. The processing circuitry is further configured to determine a sixth set of run-time bi-directional overlay nodes, of the plurality of run-time bi-directional overlay nodes, that is associated with the inward group object. Each of the sixth set of run-time bi-directional overlay nodes is configured to extend functionality of the inward group object. The operation associated with the stimulus is executed further based on the sixth set of run-time bi-directional overlay nodes.

In some embodiments, the first run-time connection link is a run-time bi-directional node.

In some embodiments, the first run-time connection link has a role node-type.

In some embodiments, the first run-time connection link is indicative of a dependency between the first run-time bi-directional node and the second run-time bi-directional node. The dependency between the first run-time bi-directional node and the second run-time bi-directional node is one of a group consisting of: an own-owned dependency, a use-used dependency, and a share-shared dependency.

In some embodiments, based on the dependency being the own-owned dependency, the first run-time bi-directional node owns the second run-time bi-directional node.

In some embodiments, based on the dependency being the share-shared dependency, the first run-time bi-directional node shares the second run-time bi-directional node with one or more run-time bi-directional nodes of the plurality of run-time bi-directional nodes.

In some embodiments, based on the dependency being the use-used dependency, the first run-time bi-directional node uses the second run-time bi-directional node based on an absence of simultaneous use of the second run-time bi-directional node by one or more other run-time bi-directional nodes of the plurality of run-time bi-directional nodes.

In some embodiments, at least one of the first inward connection object and the first outward connection object is associated with a set of attributes pertaining to a loading strategy associated with at least one of from a group consisting of the first run-time bi-directional node and the second run-time bi-directional node.

In some embodiments, prior to the execution of the operation associated with the stimulus, the processing circuitry is further configured to load, in the executable graph-based model, at least one of a group consisting of: the first run-time bi-directional node, the second run-time bi-directional node, or the first run-time connection link.

In some embodiments, the loading of the first run-time bi-directional node includes loading of an associated node template and an associated node instance.

In some embodiments, the processing circuitry is further configured to load, in the executable graph-based model, one or more sets of run-time bi-directional overlay nodes that are associated with at least one of a group consisting of: the first run-time bi-directional node, the second run-time bi-directional node, the first inward connection object, or the first outward connection object.

In some embodiments, the processing circuitry is further configured to load, in the executable graph-based model, one or more sets of generic run-time overlay nodes that are associated with at least one of a group consisting of: the first run-time bi-directional node, the second run-time bi-directional node, the first inward connection object, or the first outward connection object.

In some embodiments, based on the loading of the first run-time bi-directional node, the processing circuitry is further configured to load at least one of a group consisting of (i) one or more run-time bi-directional nodes of the plurality of run-time bi-directional nodes or (ii) one or more generic run-time nodes of a plurality of generic run-time nodes of the executable graph-based model, with which the first run-time bi-directional node has a dependency. The dependency is one of a group consisting of: an own-owned dependency, a share-shared dependency, and a use-used dependency.

In some embodiments, the first run-time bi-directional node is further configured to inherit at least one of a group consisting of (i) a sixth run-time bi-directional node of the plurality of run-time bi-directional nodes or (ii) one or more generic run-time nodes of a plurality of generic run-time nodes of the executable graph-based model. Based on the loading of the first run-time bi-directional node, the processing circuitry is further configured to load at least one of the group consisting of (i) the sixth run-time bi-directional node or (ii) the one or more generic run-time nodes.

In some embodiments, upon execution of the operation associated with the stimulus, the processing circuitry is further configured to unload at least one of a group consisting of: the first run-time bi-directional node, the second run-time bi-directional node, or the first run-time connection link, from the executable graph-based model.

In some embodiments, based on the unloading of the first run-time bi-directional node, the processing circuitry is further configured to unload at least one of a group consisting of (i) one or more run-time bi-directional nodes of the plurality of run-time bi-directional nodes or (ii) one or more generic run-time nodes of a plurality of generic run-time nodes of the executable graph-based model, with which the first run-time bi-directional node has a dependency. The dependency is one of a group consisting of: an own-owned dependency, a share-shared dependency, and a use-used dependency.

In some embodiments, the first run-time bi-directional node is further configured to inherit at least one of a group consisting of (i) a second set of run-time bi-directional nodes of the plurality of run-time bi-directional nodes or (ii) a third set of generic run-time nodes of a plurality of generic run-time nodes of the executable graph-based model. Based on the unloading of the first run-time bi-directional overlay node, the processing circuitry is further configured to unload at least one of the group consisting of (i) the second set of run-time bi-directional nodes or (ii) the third set of generic run-time nodes.

In some embodiments, the executable graph-based model further includes a plurality of generic run-time nodes with each generic run-time node including (i) a generic node template that corresponds to a predefined node structure, and (ii) a generic node instance that corresponds to an implementation of the generic node template. A node-type of each generic run-time node of the plurality of generic run-time nodes is one of a group consisting of: a vertex node-type, an edge node-type, a role node-type, and an overlay node-type. The processing circuitry is further configured to determine a first generic run-time node, of the plurality of generic run-time nodes, that is associated with the first run-time bi-directional node by way of a first generic role that indicates a capacity in which the first run-time bi-directional node is associated with the first generic run-time node. The operation associated with the stimulus is executed further based on the first generic run-time node and the first generic role.

In some embodiments, the second run-time bi-directional node is further associated with a seventh run-time bi-directional node of the plurality of run-time bi-directional nodes by way of a sixth run-time connection link. The sixth run-time connection link includes the first inward connection object and a fifth outward connection object that define association with the second run-time bi-directional node and the seventh run-time bi-directional node, respectively.

In some embodiments, the first run-time bi-directional node and the second run-time bi-directional node have a same node template and different node instances.

In some embodiments, a method is disclosed. The method comprises receiving, by processing circuitry of an overlay system, a stimulus. An executable graph-based model is stored in a storage element of the overlay system. The executable graph-based model includes a plurality of run-time bi-directional nodes and a plurality of run-time connection links. Each run-time bi-directional node includes (i) a node template that corresponds to a predefined bi-directional node structure, and (ii) a node instance that corresponds to an implementation of the node template. The method further comprises identifying, by the processing circuitry, based on the stimulus, a first run-time bi-directional node from the plurality of run-time bi-directional nodes. The method further comprises determining, by the processing circuitry, a first run-time connection link, of the plurality of run-time connection links, coupled to the first run-time bi-directional node, the first run-time connection link including a first outward connection object defining association with the first run-time bi-directional node and a first inward connection object defining association with a second run-time bi-directional node of the plurality of run-time bi-directional nodes. The method further comprises identifying, by the processing circuitry, based on the first run-time connection link, the second run-time bi-directional node. The method further comprises executing, by the processing circuitry, an operation associated with the stimulus based on the first run-time bi-directional node, the second run-time bi-directional node, and the first run-time connection link.

These and other features and advantages of the present disclosure may be appreciated from a review of the following detailed description of the present disclosure, along with the accompanying figures in which like reference numerals refer to like parts throughout.

### BRIEF DESCRIPTION OF THE DRAWINGS

Embodiments of the present disclosure may be illustrated by way of example and are not limited by the accompanying figures. Similar references in the figures may indicate similar elements. Elements in the figures may be illustrated for simplicity and clarity and have not necessarily been drawn to scale.

FIG. 1 is a graph that illustrates a composition of an executable graph-based model, consistent with disclosed embodiments of the present disclosure;

FIG. 2 is a block diagram that illustrates a system environment of an overlay system for execution, management, and configuration of the executable graph-based model, consistent with disclosed embodiments of the present disclosure;

FIG. 3A is a block diagram that illustrates a standard structure of a generic run-time node within the executable graph-based model, consistent with disclosed embodiments of the present disclosure;

FIG. 3B is a block diagram that illustrates a standard structure of a run-time bi-directional node within the executable graph-based model, consistent with disclosed embodiments of the present disclosure;

FIG. 4A is a block diagram that illustrates an executable generic run-time node within the executable graph-based model, consistent with disclosed embodiments of the present disclosure;

FIG. 4B is a block diagram that illustrates an executable run-time bi-directional node within the executable graph-based model, consistent with disclosed embodiments of the present disclosure;

FIG. 5 is a block diagram that illustrates a composition of the executable generic run-time node that enables persistent storage of data and processing logic associated therewith consistent with disclosed embodiments of the present disclosure;

FIG. 6 illustrates a block diagram that depicts features of run-time bi-directional nodes, consistent with disclosed embodiments of the present disclosure;

FIGS. 7A-7D are block diagrams that, collectively, illustrate a process of loading run-time bi-directional nodes, consistent with disclosed embodiments of the present disclosure;

FIG. 8 is a block diagram that illustrates an exemplary scenario of associations among run-time bi-directional nodes, consistent with disclosed embodiments of the present disclosure;

FIG. 9 illustrates a block diagram that depicts a plurality of bi-directional nodes in the executable graph-based model, consistent with disclosed embodiments of the present disclosure;

FIG. 10. illustrates a block diagram that depicts a mathematical representation of a neural network model that is implemented by way of the executable graph-based model, consistent with disclosed embodiments of the present disclosure;

FIG. 11. is a block diagram that illustrates a neural network model for classification of images, consistent with disclosed embodiments of the present disclosure;

FIG. 12 shows an example computing system for carrying out methods of the present disclosure, consistent with disclosed embodiments of the present disclosure;

FIG. 13 illustrates a flowchart of a method for processing a stimulus using a run-time bi-directional node, consistent with disclosed embodiments of the present disclosure; and

FIG. 14 illustrates a flowchart of a method for executing an operation associated with stimulus, consistent with disclosed embodiments of the present disclosure.

### DETAILED DESCRIPTION

The detailed description of the appended drawings is intended as a description of the embodiments of the present disclosure and is not intended to represent the only form in which the present disclosure may be practiced. It is to be understood that the same or equivalent functions may be accomplished by different embodiments that may be intended to be encompassed within the spirit and scope of the present disclosure.

### Overview:

With exponential growth in the field of computing, graph-based models have found their application in numerous domains leading to various technologies being implemented using the graph-based model. A technology that is implemented by way of a graph-based model has each unit associated therewith realized as a node of the graph-based model. Such use of the graph-based model enables complete control over even the smallest unit of the technology. Data and processing logic associated with the technology may be stored in the graph-based model in the form of nodes. This allows for the data and processing logic to be used by accessing relevant nodes. While using a node of the graph-based model, nodes that may be associated with the initial node may also be required to be used. In addition, for the initial node to be used, the initial node is required to be loaded in the graph-based model. While loading the initial node, a look-up operation may be performed to determine association of the initial node with the other nodes. Subsequently, based on the identification of the association with the initial node, the associated nodes may be also loaded along with the initial node. For example, a first vertex may be associated with a second vertex by way of an edge node that may include a role indicative of a capacity in which the first node may be associated with the second node. For optimized use of resources, the first and second nodes may be unloaded from the graph-based model when not used for a specific time duration. In an instance, the first node may be required to perform one or more operations associated with the graph-based model. In such an instance, the first node may be loaded in the graph-based model. Additionally, based on association with the first node, the second node may also be required to be loaded in the graph-based model.

Therefore, a look-up operation, in the graph-based model or an edge table associated with the graph-based model, may be performed to determine one or more nodes (for example, the second node) associated with the first node. Subsequently, based on the determined association with the first node, the second node and the edge node may be loaded in the graph-based model. The execution of the lookup operation to identify the associated nodes may be time-consuming and resource-intensive, leading to increased costs and execution time. In real-world scenarios, especially when a large number of nodes are interconnected, this can result in significant latency. Further, the associations among the large number of nodes may also require an equally large number of edge nodes to be instantiated in the graph-based model. Such edge nodes may also be required to be identified and loaded in order to determine the association among the nodes, which further complicates loading of the node and the associated nodes.

The present disclosure is directed to facilitation of run-time bi-directional nodes in an executable graph-based model of an overlay system. The executable graph-based model is a customized hypergraph with hyper-edges that may be realized by way of executable nodes. The realization of a node refers to an instantiation of the node in the executable graph-based model and actuating one or more operations associated with the node in the overlay system. Each executable node may be associated with a particular node-type. For example, an edge node corresponds to a base node with an edge node-type. Nodes (for example, base nodes and executable nodes) may be connected with other nodes by way of roles included in an edge node therebetween. In some embodiments, roles may be represented by way of nodes of role node-type. A role node between two nodes may be indicative of a context regarding an association therebetween. The executable graph-based model also may include a plurality of overlay nodes that incorporate in-situ features (for example, execution of operations associated with run-time bi-directional nodes) in the overlay system. Each overlay node may be associated with one or more nodes (for example, a vertex node, an edge node, or the like) of the executable graph-based model and may include a corresponding processing logic that when executed implements a functionality thereof on the associated nodes. Hence, the processing logic is implemented within the executable graph-based model and is not required to be retrieved from any external system.

The overlay system disclosed herein facilitates run-time bi-directional nodes in the executable graph-based model. A run-time bi-directional node is realized by way of a hyper-edge in the executable graph-based model. Each run-time bi-directional node being a hyper-edge may include a role by way of which it may be associated with another run-time bi-directional node. A first run-time bi-directional node may be associated with another run-time bi-directional node by way of a run-time connection link that may include an outward connection object and an inward connection object. The outward connection object may be indicative of a primary role associated with the first run-time bi-directional node by which the first run-time bi-directional node may be associated with the second run-time bi-directional node. The inward connection object may be indicative of a secondary role associated with the second run-time bi-directional node by which the second run-time bi-directional node may be associated with the first run-time bi-directional node. Therefore, the primary role and the secondary role may be indicative of a capacity in which the first run-time bi-directional node and the second run-time bi-directional node may be mutually associated. A run-time bi-directional node may be loaded in the executable graph-based model based on its requirement. In an instance, when the run-time bi-directional node may not be required, the run-time bi-directional node may be stored along with the first run-time connection link in a storage element of the overlay system. Therefore, in instances when the run-time bi-directional node may be loaded, the first run-time connection link may also be loaded. Additionally, since the first run-time connection link may also include the secondary role associated with the second run-time bi-directional node, the second run-time bi-directional node may also be loaded.

Thus, the loading of one run-time bi-directional node can lead to the loading of all associated run-time bi-directional nodes by way of connection links. This eliminates the requirement of executing multiple look-up operations for identifying the associated run-time bi-directional nodes. Hence, the run-time bi-directional nodes may be loaded in significantly less time, thus increasing throughput and decreasing latency associated with operations performed in the overlay system.

### FIGURE DESCRIPTION

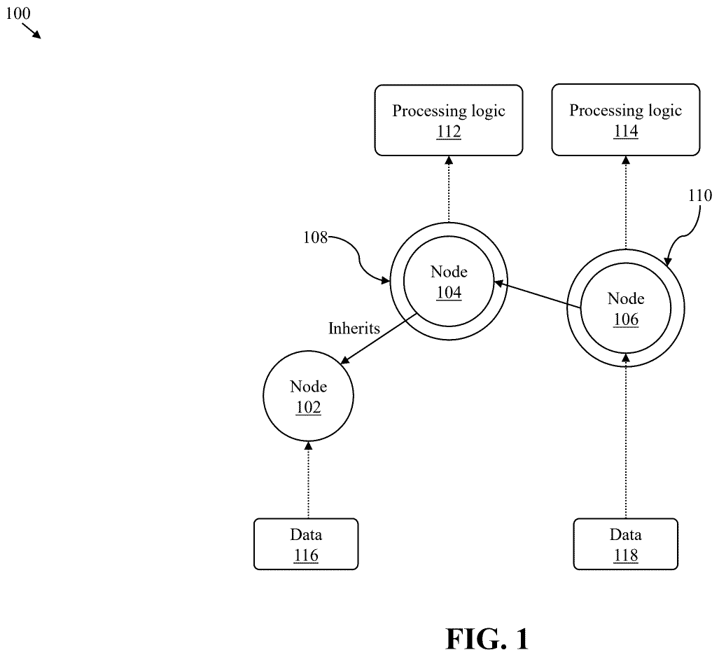

FIG. 1 is a graph that illustrates a composition of an executable graph-based model 100, consistent with disclosed embodiments of the present disclosure. Referring to FIG. 1, the executable graph-based model 100 is generally formed of a data structure (e.g., a graph-based model or a graphical model) comprising a plurality of nodes 102-106 which can be functionally extended with processing logic via the use of overlays. For example, as shown in FIG. 1, the nodes 104 and 106 may be functionally extended with processing logic via the use of overlay nodes 108 and 110, respectively. Although not shown, the node 102 can be similarly extended with processing logic via the use of one or more overlays. Each overlay may include processing logic, such as processing logic 112 and 114 which may be associated with the overlay nodes 108 and 110, respectively. At run-time, data, such as data 116 and 118, may be associated with the nodes 102 and 106, respectively. Further, the overlay nodes 108 and 110 of the nodes 104 and 106, respectively, provide the functionality to respond to stimuli and interact with, manipulate, or otherwise process the data based on the stimuli. Further, the node 104 inherits the node 102, and hence, also inherits the data 116 which may be associated with the node 102. In some embodiments, the node 102 may be extended to have one or more overlays. In such embodiments, the node 104 may further inherit the overlays of the node 102.

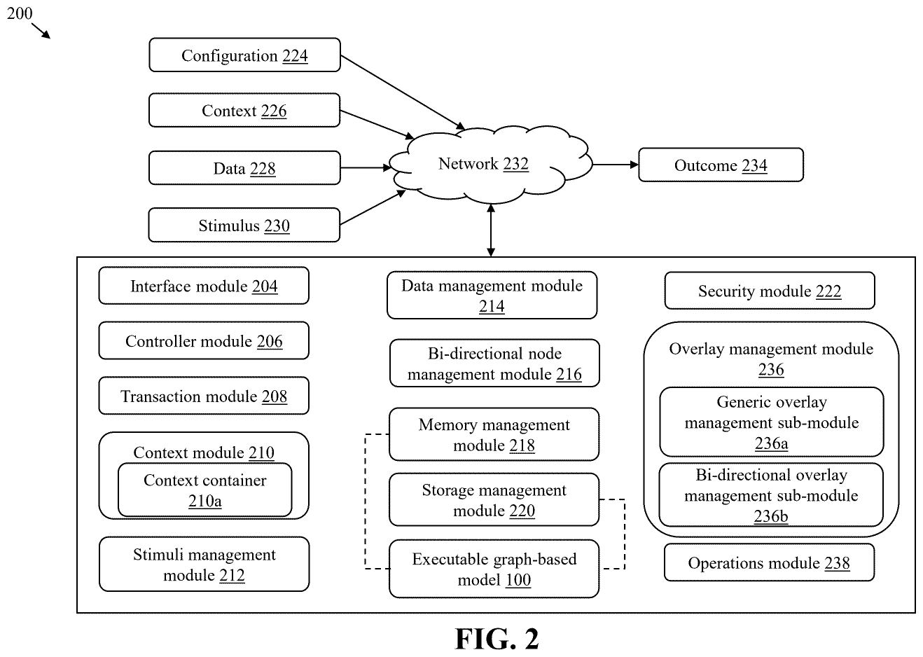

Each element within the executable graph-based model 100 (both the data and the processing functionality) is implemented by way of a node. A node forms the fundamental building block of all executable graph-based models. A node may be an executable node. A node that is extended by way of an overlay node forms an executable node. One or more nodes may be extended to include overlays in order to form the executable graph-based model 100. As such, the executable graph-based model 100 may include one or more nodes that can be dynamically generated, extended, or processed by one or more other modules within an overlay system (shown in FIG. 2). Throughout the description, the terms “overlay node” and “overlay” may be used interchangeably.

Notably, the structure and functionality of the data processing may be separate from the data itself when offline (or at rest) and may be combined dynamically at run-time. The executable graph-based model 100 thus maintains the separability of the data and the processing logic when offline. Moreover, by integrating the data and the processing logic within a single model, processing delays or latencies may be reduced because the data and the processing logic exist within the same logical system. Therefore, the executable graph-based model 100 applies to a range of time-critical systems where efficient processing of the stimuli is required.

FIG. 2 is a block diagram that illustrates a system environment 200 of an overlay system 202 for execution, management, and configuration of the executable graph-based model 100, consistent with disclosed embodiments of the present disclosure. Referring to FIG. 2, the overlay system 202 may include the executable graph-based model 100. The overlay system 202 further may include an interface module 204, a controller module 206, a transaction module 208, a context module 210, a stimuli management module 212, a data management module 214, a bi-directional node management module 216, a memory management module 218, a storage management module 220, and a security module 222. FIG. 2 further shows a configuration 224, a context 226, data 228, a stimulus 230, a network 232, and an outcome 234. Additionally, the overlay system 202 of the present disclosure may include an overlay management module 236 and an operations module 238. In some embodiments, all the modules of the overlay system 202 except for the executable graph-based model 100 may collectively form processing circuitry that facilitates operations associated with a plurality of nodes including generic run-time nodes and run-time bi-directional nodes, in the executable graph-based model 100. A generic run-time node may refer to nodes, in the executable graph-based model 100, with an edge node-type, a role node-type, or a vertex node-type. A generic run-time node with the vertex node-type is coupled to another generic run-time node with the vertex node-type by way of a node with the edge node-type indicative of a role of the generic run-time node. A run-time bi-directional node refers to a node with an edge node-type that associates with another run-time bi-directional node by way of a run-time connection link that may include a primary role for the run-time bi-directional node and a secondary role for the other run-time bi-directional node.

The overlay system 202 may include suitable logic, circuitry, interfaces, and/or code, executable by the circuitry, that may be configured to facilitate one or more operations associated with the run-time bi-directional nodes in the executable graph-based model 100.

The interface module 204 may include suitable logic, circuitry, interfaces, and/or code, executable by the circuitry, configured to provide a common interface between internal modules of the overlay system 202 and/or external sources. The interface module 204 provides an application programmable interface (API), scripting interface, or any other suitable mechanism for interfacing externally or internally with any module of the overlay system 202. The configuration 224, the context 226, the data 228, and the stimulus 230 may be received by the interface module 204 via the network 232. Similarly, outputs (e.g., the outcome 234) produced by the overlay system 202 may be passed by the interface module 204 to the network 232 for consumption or processing by external systems. In one embodiment, the interface module 204 supports one or more messaging patterns or protocols such as the simple object access protocol (SOAP), the representational state transfer (REST) protocol, or the like. The interface module 204 thus allows the overlay system 202 to be deployed in any number of applications such as operational environments, or architecture deployments. Although not illustrated in FIG. 2, the interface module 204 is communicatively coupled (e.g., connected either directly or indirectly) to one or more other modules or elements within the overlay system 202 (such as the controller module 206, the context module 210, the executable graph-based model 100, or the like). In one embodiment, the interface module 204 is communicatively coupled (e.g., connected either directly or indirectly) to one or more overlays within the executable graph-based model 100.

The controller module 206 may include suitable logic, circuitry, interfaces, and/or code, executable by the circuitry, configured to handle and process interactions and executions within the overlay system 202. As will be described in more detail below, stimuli (such as the stimulus 230) and their associated contexts (such as the context 226) provide the basis for all interactions within the executable graph-based model 100. Processing of such stimuli may lead to the execution of processing logic associated with one or more overlays within the executable graph-based model 100. The processing of the stimuli within the overlay system 202 may be referred to as a system transaction. The processing and execution of stimuli (and associated overlay execution) within the overlay system 202 is handled by the controller module 206. The controller module 206 manages all received input stimuli (e.g., the stimulus 230) and processes them based on a corresponding context (e.g., the context 226). The context 226 determines the priority that is to be assigned to the processing of the corresponding stimulus by the controller module 206 or the context module 210. This allows each stimulus to be configured with a level of importance and prioritization within the overlay system 202.

The controller module 206 may maintain the integrity of the modules within the overlay system 202 before, during, and after a system transaction. The transaction module 208, which may be associated with the controller module 206, is responsible for maintaining the integrity of the overlay system 202 through the lifecycle of a transaction. Maintaining system integrity via the controller module 206 and the transaction module 208 allows a transaction to be rolled back in an event of an expected or unexpected software or hardware fault or failure. The controller module 206 is configured to handle the processing of the stimulus 230 and transactions through architectures such as parallel processing, grid computing, priority queue techniques, or the like. In one embodiment, the controller module 206 and the transaction module 208 may be communicatively coupled (e.g., connected either directly or indirectly) to one or more overlays within the executable graph-based model 100.

As stated briefly above, the overlay system 202 utilizes a context-driven architecture, whereby the stimulus 230 within the overlay system 202 may be associated with the context 226 which is used to adapt the handling or processing of the stimulus 230 by the overlay system 202. That is to say that the handling or processing of the stimulus 230 is done based on the context 226 associated therewith. Hence, the stimulus 230 is a contextualized stimulus. The context 226 may include details such as username, password, access token, device information, time stamp, one or more relevant identifiers (IDs), or the like, that may be required for processing of the stimulus 230 within the executable graph-based model 100. Each context within the overlay system 202 may be extended to include additional information that is required for the processing of the stimulus (e.g., a query, a command, or an event).

The context module 210 may include suitable logic, circuitry, interfaces, and/or code, executable by the circuitry, configured to manage the handling of contexts within the overlay system 202. The context module 210 is responsible for processing any received contexts (e.g., the context 226) and translating the received context to an operation execution context. In some examples, the operation execution context is larger than the received context because the context module 210 supplements the received context with further information necessary for the processing of the received context. The context module 210 passes the operation execution context to one or more other modules within the overlay system 202 to drive communication of data associated with the operation execution context. Contexts within the overlay system 202 can be external or internal. While some contexts apply to all application areas and problem spaces, some applications may require specific contexts to be generated and used to process the received stimulus 230. As will be described in more detail below, the executable graph-based model 100 is configurable (e.g., via the configuration 224) so as only to execute within a given execution context for a given stimulus.

As shown, the context module 210 may include a context container 210a that may include a set of defined contexts. Each defined context of the set of defined contexts pertains to a context that may be associated with one or more operations for facilitating application and management of the plurality of nodes (for example, the run-time bi-directional nodes) in the overlay system 202. That is to say that one or more contexts of the set of defined contexts may be indicative of the one or more operations to be executed by way of one or more bi-directional nodes in the overlay system 202. The one or more operations may be executed when a context of a corresponding stimuli matches one of the set of defined contexts.

The stimuli management module 212 may include suitable logic, circuitry, interfaces, and/or code, executable by the circuitry, configured to process externally received stimuli (e.g., the stimulus 230) and any stimuli generated internally from any module within the overlay system 202. The stimuli management module 212 is communicatively coupled (e.g., connected either directly or indirectly) to one or more overlays within the executable graph-based model 100 to facilitate the processing of stimuli within the executable graph-based model 100. The overlay system 202 utilizes different types of stimuli such as a command (e.g., a transactional request), a query, or an event received from an external system such as an Internet-of-Things (IoT) device. As previously stated, a stimulus (such as the stimulus 230) can be either externally or internally generated. In an example, the stimulus 230 may be a message that is internally triggered (e.g., generated) from any of the modules within the overlay system 202. Such internal generation of the stimulus 230 indicates that something has happened within the overlay system 202 and subsequent handling by one or more other modules within the overlay system 202 may be required. Internal stimulus 230 can also be triggered (e.g., generated) from the execution of processing logic associated with overlays within the executable graph-based model 100. In another example, the stimulus 230 may be externally triggered and may be generated based on an input received via a user interface associated with the controller module 206. The externally triggered stimulus 230 may be received in the form of a signal, a textual, audio, or visual input. The externally triggered stimulus 230 may be associated with the intent of a user to execute an operation indicated by the stimulus 230. The operation is executed in accordance with information included in the context 226 associated with the stimulus 230.

The stimuli management module 212 may receive the stimuli (such as the stimulus 230) in real-time or near-real-time and communicate the received stimuli to one or more other modules or nodes of the executable graph-based model 100. In some examples, the stimuli may be scheduled in a batch process. The stimuli management module 212 utilizes any suitable synchronous or asynchronous communication architectures or approaches in communicating the stimuli (along with associated information). The stimuli within the overlay system 202 may be received and processed (along with a corresponding context) by the stimuli management module 212, which then determines the processing steps to be performed for the communication of data associated with each stimulus. In one embodiment, the stimuli management module 212 processes the received stimuli in accordance with a predetermined configuration (e.g., the configuration 224) or dynamically determines what processing needs to be performed based on the contexts associated with the stimuli and/or based on a state of the executable graph-based model 100. The state of the executable graph-based model 100 refers to the current state of each node of the executable graph-based model 100 at a given point in time. The state of the executable graph-based model 100 is dynamic, and hence, may change based on the processing of data by any of its nodes. In some examples, the processing of a stimulus (such as the stimulus 230) results in the generation, communication, or processing of data that further results in one or more outcomes (e.g., the outcome 234) being generated. Such outcomes may be either handled internally by one or more modules in the overlay system 202 or communicated via the interface module 204 as an external outcome. In one embodiment, all stimuli and corresponding outcomes may be recorded for auditing and post-processing purposes by, for example, the operations module 238 of the overlay system 202.

The data management module 214 may include suitable logic, circuitry, interfaces, and/or code, executable by the circuitry, configured to manage all data or information within the overlay system 202 (e.g., the data 228) for a given application. Operations performed by the data management module 214 include data loading, data unloading, data modeling, and data processing. The data management module 214 is communicatively coupled (e.g., connected either directly or indirectly) to one or more other modules within the overlay system 202 to complete some or all of these operations. For example, data storage is handled by the data management module 214 in conjunction with the storage management module 220.

The bi-directional node management module 216 may include suitable logic, circuitry, interfaces, and/or code, executable by the circuitry, configured to manage design and implementation of run-time bi-directional nodes in the overlay system 202. The bi-directional node management module 216 is further configured to facilitate one or more operations associated with the execution of one or more operations associated with the run-time bi-directional nodes.

The memory management module 218 may include suitable logic, circuitry, interfaces, and/or code, executable by the circuitry, configured to manage and optimize the memory usage of the overlay system 202. The memory management module 218 thus helps to improve the responsiveness and efficiency of the processing performed by one or more modules within the overlay system 202 by optimizing the memory handling performed by these modules. The memory management module 218 uses direct memory or some form of distributed memory management architecture (e.g., a local or remote caching solution). Additionally, or alternatively, the memory management module 218 deploys multiple different types of memory management architectures and solutions (e.g., reactive caching approaches such as lazy loading or a proactive approach such as write-through cache may be employed). These architectures and solutions may be deployed in the form of a flat (single-tiered) or multi-tiered caching architecture where each layer of the caching architecture can be implemented using a different caching technology or architecture solution approach. In such implementations, each cache or caching tier can be configured (e.g., by the configuration 224) independent of the requirements for one or more modules of the overlay system 202. For example, data priority and an eviction strategy, such as least-frequently-used (LFU) or least-recently-used (LRU), can be configured for all or parts of the executable graph-based model 100. In one embodiment, the memory management module 218 is communicatively coupled (e.g., connected either directly or indirectly) to one or more overlays within the executable graph-based model 100. Throughout the description, the terms ‘overlay’ and ‘overlay node’ may be used interchangeably.

The storage management module 220 may include suitable logic, circuitry, interfaces, and/or code, executable by the circuitry, configured to manage the temporary or permanent storage of data associated with the overlay system 202. The storage management module 220 is any suitable low-level storage device solution (such as a file system) or any suitable high-level storage technology such as another database technology (e.g., relational database management system (RDBMS) or NoSQL database). The storage management module 220 is directly connected to the storage device upon which the relevant data is persistently stored. For example, the storage management module 220 can directly address the computer-readable medium (e.g., hard disk drive, external disk drive, or the like) upon which the data is being read or written. Alternatively, the storage management module 220 is connected to the storage device via a network such as the network 232. As will be described in more detail later in the present disclosure, the storage management module 220 uses manifests to manage the interactions between the storage device and the modules within the overlay system 202. In one embodiment, the storage management module 220 is communicatively coupled (e.g., connected either directly or indirectly) to one or more overlays within the executable graph-based model 100. Throughout the description, the term ‘storage device’ is used interchangeably with the term ‘storage element’.

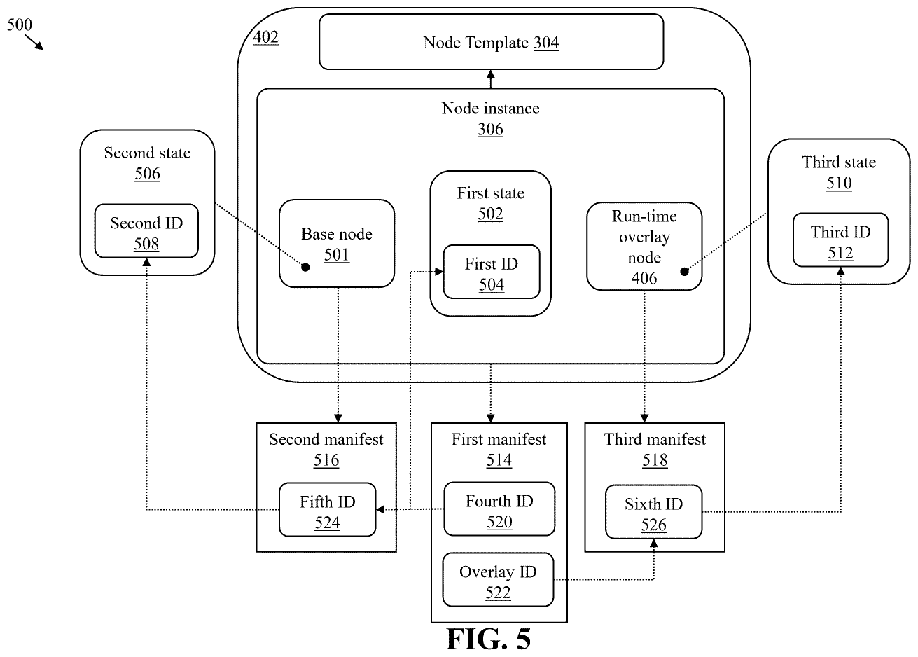

As described, storage, loading, and unloading of the executable graph-based model 100 or one or more components thereof is facilitated by the memory management module 218 and the storage management module 220. The memory management module 218 and the storage management module 220 may facilitate such operations by interacting with the storage device that stores the executable graph-based model 100. The overlay system 202 further may include a plurality of manifest storages. The manifest storages may be used by the memory management module 218 and the storage management module 220 to facilitate storage of manifest states (including manifest template states and manifest instance states) of nodes. The storage element may include a primary storage and a secondary storage. The primary storage may store the executable graph-based model 100 and may also store nodes that may be loaded in the executable graph-based model 100. The secondary storage may store node states, manifests, and manifest states associated with nodes that may be unloaded from the executable graph-based model 100. Storage and retrieval of nodes may be described in detail in conjunction with FIG. 5.

The security module 222 may include suitable logic, circuitry, interfaces, and/or code, executable by the circuitry, configured to manage the security of the overlay system 202. This may include security at a system level and a module level. Security is hardware-related, network-related, or software-related, depending on the operational environment, the architecture of the deployment, or the data and information contained within the overlay system 202. For example, if the system is deployed with a web-accessible API (as described above in relation to the interface module 204), the security module 222 can enforce a hypertext transfer protocol secure (HTTPS) protocol with the necessary certification. As a further example, if the data or information associated with the data associated with the overlay system 202 contains Personally Identifiable Information (PII) or Protected Health Information (PHI), the security module 222 can implement one or more layers of data protection to ensure that the PII or PHI may be correctly processed and stored. In an additional example, in implementations whereby the overlay system 202 operates on United States of America citizen medical data, the security module 222 may enforce additional protections or policies as defined by the United States Health Insurance Portability and Accountability Act (HIPAA). Similarly, if the overlay system 202 is deployed in the European Union (EU), the security module 222 may enforce additional protections or policies to ensure that the data processed and maintained by the overlay system 202 complies with the General Data Protection Regulation (GDPR). In one embodiment, the security module 222 is communicatively coupled (e.g., connected either directly or indirectly) to one or more overlays within the executable graph-based model 100, thereby directly connecting security execution to the data/information in the executable graph-based model 100. The security module 222 thus acts as a centralized coordinator that works in conjunction with the overlay management module 236 for managing and executing security-based overlays.

The overlay management module 236 may include suitable logic, circuitry, interfaces, and/or code, executable by the circuitry, configured to manage all overlays within the overlay system 202. The overlays may be generic run-time overlays or run-time bi-directional overlays. Run-time bi-directional overlays may be nodes that may be associated with one or more run-time bi-directional nodes by way of a direct connection or a run-time connection link. A run-time bi-directional overlay may be associated with a run-time bi-directional node by extending the functionality of the run-time bi-directional node. Alternatively, the run-time bi-directional overlay node may be associated with the run-time bi-directional node by way of a run-time connection link such that the run-time connection link may include a primary role for the run-time bi-directional node and a secondary role for the run-time bi-directional overlay. Generic run-time nodes may be nodes of the executable graph-based model 100 that are not run-time bi-directional nodes. Generic run-time overlays may be associated with generic run-time nodes and/or run-time bi-directional nodes and extend the functionality of the generic run-time nodes and/or run-time bi-directional nodes. Operations performed by the overlay management module 236 include overlay storage management, overlay structure modeling, overlay logic creation and execution, and overlay loading and unloading (within the executable graph-based model 100). The overlay management module 236 is communicatively coupled (e.g., connected either directly or indirectly) to one or more other modules within the overlay system 202 to complete some or all of these operations. For example, overlays can be persisted in some form of physical storage using the storage management module 220 (as described in more detail below). As a further example, overlays can be compiled and preloaded into memory via the memory management module 218 for faster run-time execution.

The overlay management module 236 may include a generic overlay management sub-module 236a and a bi-directional overlay management sub-module 236b. The generic overlay management sub-module 236a is configured to perform operations of the overlay management module 236 that may be associated with the generic run-time overlays. The bi-directional overlay management sub-module 236b is configured to perform operations of the overlay management module 236 that may be associated with the run-time bi-directional overlays.

The operations module 238 may include suitable logic, circuitry, interfaces, and/or code, executable by the circuitry, configured to track operational metrics and the behavior of all modules of the overlay system 202. Operational metrics of a module may be indicative of statistics associated with the performance of the module while performing an operation (for example, communication, data processing, stimulus processing, or the like).

The functionality of two or more of the modules included in the overlay system 202 may be combined within a single module. Conversely, the functionality of a single module can be split into two or more further modules which can be executed on two or more devices. The modules described above in relation to the overlay system 202 can operate in a parallel, distributed, or networked fashion. The overlay system 202 may be implemented in software, hardware, or a combination of both software and hardware. Examples of suitable hardware modules include, but are not limited to, a general-purpose processor, a field programmable gate array (FPGA), and/or an application-specific integrated circuit (ASIC). Software modules can be expressed in a variety of software languages such as C, C++, Java, Ruby, Visual Basic, Python, and/or other object-oriented, procedural, or functional programming languages.

Although it is described that the overlay system 202 may include a single executable graph-based model (e.g., the executable graph-based model 100), the scope of the present disclosure is not limited to it. In other embodiments, the overlay system 202 may include more than one executable graph-based model, without deviating from the scope of the present disclosure. In such a scenario, each executable graph-based model is implemented and managed in a manner that is similar to the executable graph-based model 100.

Having described the overlay system 202 for executing and managing executable graph-based models, the description will now turn to the elements of an executable graph-based model, specifically, the concept of a node. Unlike conventional graph-based systems, all elements (e.g., data, overlays, etc.) within the executable graph-based model 100 may be implemented as nodes. As will become clear, this allows executable graph-based models to be flexible, extensible, and highly configurable.

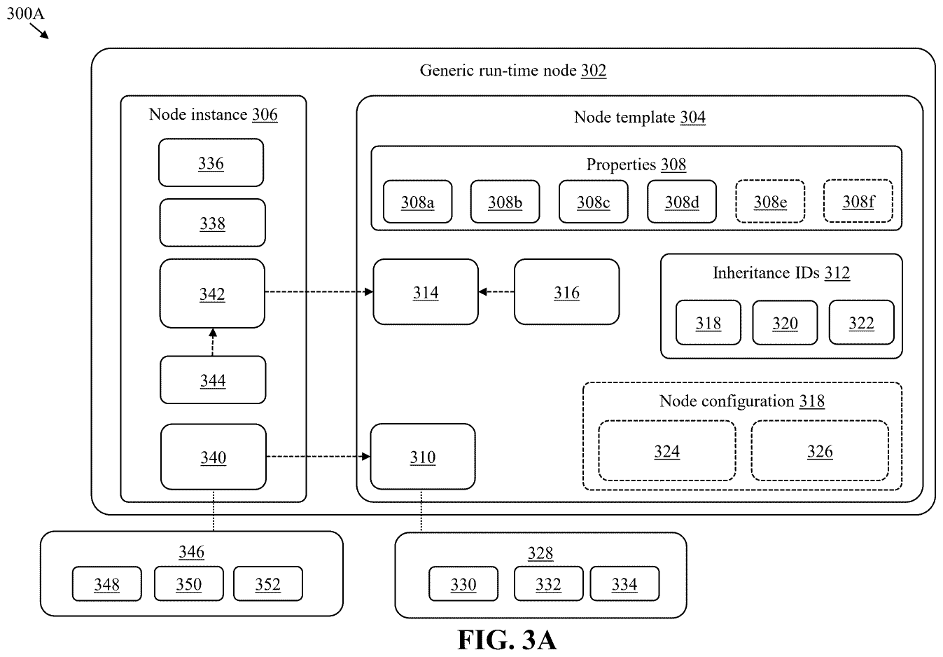

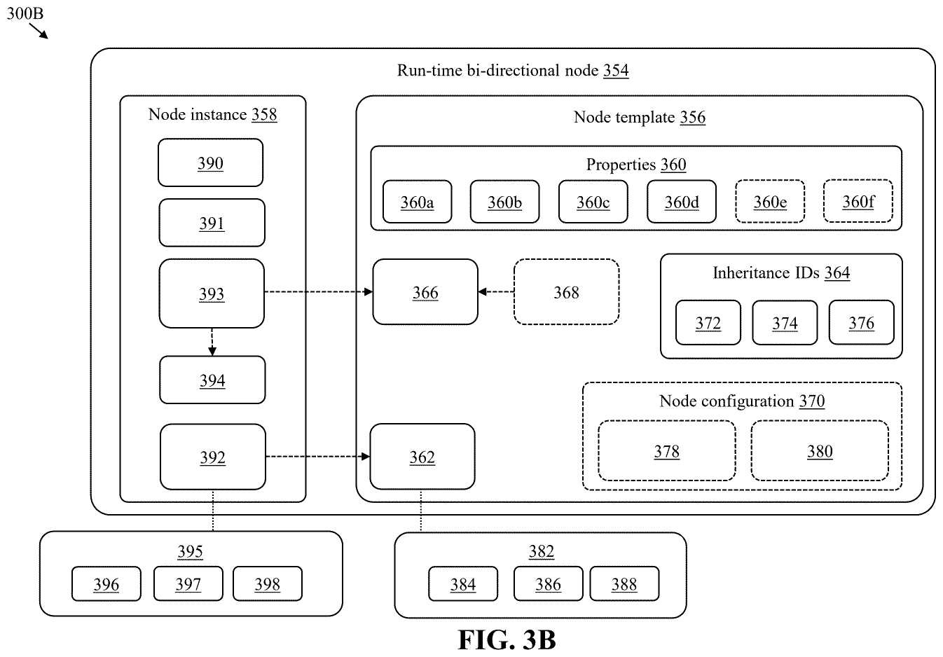

FIG. 3A is a block diagram 300A that illustrates a standard structure of a generic run-time node 302 within the executable graph-based model 100, consistent with disclosed embodiments of the present disclosure. Referring to FIG. 3A, the generic run-time node 302 corresponds to the core structure of the executable graph-based model 100 and forms the foundational building block for all data and processing logic within the executable graph-based model 100. The generic run-time node 302 is shown to include a node template 304 and a node instance 306. The node instance 306 is generated according to the node template 304. The node template 304 forms a data structure for the node instance 306. The generic run-time node 302 is shown in FIG. 3A is a compositional structure that is generated and executed, at run-time as part of the executable graph-based model 100. In other words, the node template 304 is defined as ‘offline’ and the node instance 306 and the run-time node 302 may be run-time structures that may be dynamically generated during execution of the executable graph-based model 100.

The node template 304 comprises a predetermined node structure. Further, the node template 304 defines one or more rules that govern the generation of the node instance 306. The node instance 306 is an implementation of the node template 304. In other words, the node instance 306 is generated based on the predetermined node structure and the one or more rules of the node template 304. The node template 304 cannot be modified during the execution but may be modified during offline mode or at rest. During execution, only the node instance 306 of the generic run-time node 302 may be modified.

The node template 304 may include properties 308, a node type template 310, inheritance IDs 312, and a set of attribute templates 314. The node template 304 may optionally include metadata 316 and node configuration 318. The properties 308 of the node template 304 include a unique identifier (ID) 308a, a version ID 308b, a namespace 308c, a name 308d, and optionally include one or more icons 308e and a set of labels 308f. The inheritance IDs 312 comprise an abstract flag 318, a leaf flag 320, and a root flag 322. The node configuration 318 optionally comprises one or more node configuration strategies 324 and/or one or more node configuration extensions 326. FIG. 3A further shows a plurality of predetermined node type templates 328. The plurality of predetermined node type templates 328 may include a vertex node type template 330, an edge node type template 332, and an overlay node type template 334. Further, the node instance 306 may include a unique ID 336, a version ID 338, a node type instance 340, and a set of attribute instances 342. The node instance 306 may optionally include metadata 344. FIG. 3A further shows a plurality of predetermined node type instances 346. The plurality of predetermined node type instances 346 include a vertex node type instance 348, an edge node type instance 350, and an overlay node type instance 352.

The unique ID 308a is unique for each node template within the executable graph-based model 100. Similarly, the unique ID 336 is unique for each node instance within the executable graph-based model 100. The unique ID 308a and the unique ID 336 may be used to register, manage, and reference the node template 304 and the node instance 306, respectively, within the overlay system 202. The version ID 308b of the node template 304 represents a version of the node template 304. The version ID 308b may be incremented when the node template 304 undergoes a transactional change. Similarly, the version ID 338 of the node instance 306 represents a version of the node instance 306. The version ID 338 may be incremented when the node instance 306 undergoes a transactional change. The namespace 308c of the node template 304, along with the name 308d of the node template 304, is used to organize node templates within the executable graph-based model 100. That is, the node template 304 is assigned a unique name 308d within the namespace 308c such that the name 308d of the node template 304 need not be unique within the entire executable graph-based model 100, only within the context of the namespace 308c to which the node template 304 is assigned. The node template 304 optionally comprises one or more icons 308e which may be used to provide a visual representation of the node template 304. The one or more icons 308e can include icons at different resolutions and display contexts such that the visualization of the node is adapted to different display contexts and settings. The node template 304 also optionally comprises the set of labels 308f which may be used to override the name 308d when the node template 304 is rendered or visualized.

The node template 304 supports the software development feature of multiple inheritance by maintaining references (not shown) to zero or more other node templates, which then act as the base of the node template 304. This allows the behavior and functionality of a node template to be extended or derived from one or more other node templates within an executable graph-based model. The node instance 306 likewise supports multiple inheritance because it is an instance representation of the node template 304. The multiple inheritance structure of the node instance 306 is, however, limited to the corresponding instance realization of the multiple inheritance structure defined by the node template 304, i.e., one node instance 306 is created and managed for each node template 304 defined in the inheritance hierarchy for a node instance of a node template.

The inheritance IDs 312 of the node template 304 provide an indication of the inheritance-based information, which is applicable, or can be applicable, to the node template 304. The node template 304 supports the concept of inheritance of data and processing logic associated with any other node template of the executable graph-based model 100 that is inherited by the node template 304. This allows the behavior and functionality of the node template 304 to be extended or derived from the inherited node template of the executable graph-based model 100. The inheritance IDs 312 of the node template 304 indicate the inheritance-based information, which may apply to the node template 304. The inheritance IDs 312 comprise a set of Boolean flags that identify the inheritance structure of the generic run-time node 302. The abstract flag 318 allows the node template 304 to support the construct of abstraction. When the abstract flag 318 takes a value ‘true’, the node template 304 is flagged as abstract, that is to say that it cannot be instantiated or created within an executable graph-based model (e.g., the executable graph-based model 100). Thus, in an instance when the node template 304 has the abstract flag 318 set to ‘true’, the node template 304 may only form the foundation of other node templates that inherit therefrom. By default, the abstract flag 318 of the node template 304 is set to ‘false’. The leaf flag 320 is used to indicate whether any other node template may inherit from the node template 304. If the leaf flag 320 is set to ‘true’, no other node template may inherit from the node template 304 (but unlike an abstract node, a node with the leaf flag 320 set may be instantiated and created within the executable graph-based model 100). The root flag 322 is used to indicate whether the node template 304 inherits from any other node template. If the root flag 322 is set to ‘true’, the node template 304 does not inherit from any other node. The node template 304 is flagged as leaf (e.g., the leaf flag 320 is set to ‘true’) and/or root (e.g., the root flag 322 is set to ‘true’), or neither (e.g., both the leaf flag 320 and the root flag 322 may be set to ‘false’). It will be apparent to a person skilled in the art that a node cannot be flagged as both abstract and leaf (e.g., the abstract flag 318 cannot be set to ‘true’ whilst the leaf flag 320 is set to ‘true’).

All elements within the executable graph-based model 100 may be defined as node templates or node instances. The functionality of the node template 304 and the node instance 306 may be realized due to the use of the node type templates 328 and the node type instances 346. The node type templates 328 of the node template 304 is used to extend the functionality of the node template 304 by defining the standard set of capabilities, including data and associated behavior. The vertex node type template 330 (also referred to as a data node type) may include a template of common data structures and functionality related to the ‘things’ modeled in the graph (e.g., the data). The vertex node type instance 340 may include the common data structures and functionality related to the ‘things’ modeled in the graph based on the vertex node type template 330. The edge node type template 332 may include a template of common data structures and functionality related to joining two or more nodes. A node instance having the edge node type instance 350 may connect two or more nodes and thus the edge node type instance 350 constructs associations and connections between nodes (for example objects or ‘things’) within the executable graph-based model 100. The edge node type instance 350 is not restricted to the number of nodes that can be associated or connected by a node having the edge node type instance 350. The data structures and functionality of the edge node type instance 350 thus define a hyper-edge which allows two or more nodes to be connected through a defined set of roles. A role defines a connective relationship between the two or more nodes, and hence, allows an edge node to connect two or more nodes such that the two or more nodes may have more than one relationship therebetween. The plurality of predetermined node type templates 328 further may include the overlay node type template 334. The overlay node type template 334 is used to extend the functionality of a node template (e.g., the node template 304) to incorporate processing logic. Similarly, the overlay node type instance 352 is used to extend the functionality of a node instance (e.g., the node instance 306) to incorporate processing logic.

The set of attribute templates 314 corresponds to the data defined by the node template 304. For example, the set of attribute templates 314 may define the names and value types (e.g., integer, string, float, etc.) of one or more attributes but not the values of these attributes. The values of the set of attribute templates 314 may be defined by the set of attribute instances 342 of the node instance 306 through one or more values or instance values. For example, the node template 304 may define a string attribute ‘surname’ and the corresponding node instance 306 may assign the instance value ‘Bell-Richards’ to this string attribute. Each attribute instance of the set of attribute instances 342 may be associated with an attribute template of the set of attribute templates 314. The node template 304 may define one or more default values for the set of attribute templates 314. The default values correspond to the values that the attributes take if no value is assigned. The metadata 316 (e.g., data stored as a name, a value type, and a value triplet) may be associated with either the node template 304 or one or more of the set of attribute templates 314 of the node template 304. Similarly, the node instance 306 also optionally comprises the metadata 344 (e.g., data stored as a name, a value type, and a value triplet) which may be associated with either the node instance 306 or one or more of the set of attribute instances 342.

The node configuration 318 provides a high degree of configurability for the different elements of a node template and/or a node instance. An example of a concrete node configuration strategy is an ID strategy, associated with the configuration of the unique ID 308a of the node template 304. A further example of a concrete node configuration strategy is a versioning strategy, associated with the configuration of the version ID 308b of the node template 304 which supports major and minor versioning (depending on the type of transactional change incurred). The versioning strategy may be adapted to a native filing system of a user device hosting the overlay system 202 or a third-party data storage (for example, Snowflake®, or the like) associated with the overlay system 202.

It will be apparent to a person skilled in the art that each generic run-time node of the executable graph-based model 100 has a standard structure that is similar to the generic run-time node 302 of FIG. 3A.

Throughout the description, the node template of a generic run-time node may be referred to as a generic node template and the node instance of a generic run-time node may be referred to as a generic node instance.

FIG. 3B is a block diagram 300B that illustrates a standard structure of a run-time bi-directional node 354 within the executable graph-based model 100, consistent with disclosed embodiments of the present disclosure. Referring to FIG. 3B, the run-time bi-directional node 354 corresponds to the core structure of the executable graph-based model 100 and forms the foundational building block for all data and processing logic within the executable graph-based model 100. The run-time bi-directional node 354 is shown to include a node template 356 and a node instance 358. The node instance 358 is generated according to the node template 356. The node template 356 forms a data structure for the node instance 358. Notably, the node template 356 corresponds to a predefined bi-directional node structure. That is to say that the node template 356 being the predefined bi-directional node structure includes a reference to each associated bi-directional node template. As the node instance 358 may be an implementation of the node template 356, the node instance 358 may also include references to each associated node instance. Similarly, when the run-time bi-directional node 354 may be a run-time bi-directional overlay node, the node template 356 may be an overlay node template and the node instance may be an overlay node instance. The overlay node instance may be an implementation of the overlay node template. The overlay node template may correspond to a predefined bi-directional overlay node template that includes references to each run-time bi-directional overlay node and each run-time bi-directional node that may be associated therewith by way of a corresponding run-time connection link.

The run-time bi-directional node 354 shown in FIG. 3B is a compositional structure that is generated and executed, at run-time as part of the executable graph-based model 100. In other words, the node template 356 is defined as ‘offline’, and the node instance 358 and the run-time bi-directional node 354 may be run-time structures that may be dynamically generated during the execution of the executable graph-based model 100.

The node template 356 is the same as the node template 304 described in conjunction with FIG. 3A whereas the node instance 358 is same as the node instance 306 described in conjunction with FIG. 3A.

The node template 356 may include properties 360, a node type template 362, inheritance IDs 364, and a set of attribute templates 366. The node template 356 may optionally include metadata 368 and node configuration 370. The properties 360 of the node template 356 include a unique identifier (ID) 360a, a version ID 360b, a namespace 360c, a name 360d, and optionally include one or more icons 360e and a set of labels 360f. The inheritance IDs 364 comprise an abstract flag 372, a leaf flag 374, and a root flag 376. The node configuration 370 optionally comprises one or more node configuration strategies 378 and/or one or more node configuration extensions 380. FIG. 3B further shows a plurality of predetermined node type templates 382. The plurality of predetermined node type templates 382 may include a role node type template 384, an edge node type template 386, and an overlay node type template 388. Further, the node instance 358 may include a unique ID 390, a version ID 391, node type instances 392, and a set of attribute instances 393. The node instance 358 may optionally include metadata 394. FIG. 3B further shows a plurality of predetermined node type instances 395. The plurality of predetermined node type instances 395 include a role node type instance 396, an edge node type instance 397, and an overlay node type instance 398.

The properties 360 of the node template 356 has a description that is similar to the description of the properties 308 described in conjunction with FIG. 3A. In other words, the unique identifier (ID) 360a, the version ID 360b, the namespace 360c, the name 360d, the icons 360e, and the set of labels 360f have descriptions that may be similar to descriptions of the unique identifier (ID) 308a, the version ID 308b, the namespace 308c, the name 308d, the icons 308e, and the set of labels 308f, respectively, shown in FIG. 3A.

The inheritance IDs 364 of the node template 356 has a description that is similar to the inheritance IDs 312 of the node template 304. In other words, the abstract flag 372, the leaf flag 374, and the root flag 376 have descriptions that may be similar to the abstract flag 318, the leaf flag 320, and the root flag 322, respectively, shown in FIG. 3A.

All elements within the executable graph-based model 100 may be defined as node templates or node instances. The functionality of the node template 356 and the node instance 358 may be realized due to the use of the node type templates 362 and the node type instances 392, respectively. The node type template 362 has a description that is similar to the node type template 328 of the node template 304 shown in FIG. 3A. In other words, the edge node type template 386 is the same as edge node type template 332 shown in FIG. 3A and the overlay node type template 388 is the same as the overlay node type template 334 shown in FIG. 3A. Similarly, the edge node type instance 397 is same as the edge node type instance 350 shown in FIG. 3B whereas the overlay node type instance 398 is the same as the overlay node type instance 352 shown in FIG. 3A. The node type template 362 also may include a role node type template 384 may include a template of roles and associations of the node template 356. The role node type template 384 may be used to associate the node template 356 with one or more other node templates. The role node type template 384 may include roles and role attributes and descriptions for the roles by way of which the node template 356 may be associated with one or more other node templates. The role node type instance 396 may be used to associate the node instance 358 with one or more other node instances. The role node type instance 396 may include roles and role attributes and descriptions for the roles by way of which the node instance 358 may be associated with one or more other node instances. Notably, a run-time bi-directional node (for example, the run-time bi-directional node 354) has an edge node-type. That is to say that a node template (for example, the node template 356) and a node instance (for example, the node instance 358) may have an edge node template (for example, the edge node type template 386) and edge node instance (for example, the edge node type instance 397), respectively. Additionally, the run-time bi-directional node (for example, the run-time bi-directional node 354) may have a role node-type or an overlay node-type. That is to say that a node template (for example, the node template 356) may have a role node template (for example, the edge node type template 386) or overlay node template (for example, the overlay node type template 388). Additionally, the node instance (for example, the node instance 358) may have a role node instance (for example, the edge node type instance 397) or overlay node instance (for example, the overlay node type instance 398).

The set of attribute templates 366 has a description that is similar to the description of the set of attribute templates 314 described in conjunction with FIG. 3A. The metadata 368 has a description that is similar to the metadata 316 depicted in FIG. 3A. Similarly, the set of attribute instances 393 has a description that is similar to the set of attribute instances 342 of FIG. 3A and the metadata 394 has a description that is similar to the metadata 344 of FIG. 3A.

The node configuration 370 has a description that may be similar to the node configuration 318 of FIG. 3A. In other words, the description of the node configuration strategies 378 may be similar to the description of the node configuration strategies 324, and the description of the node configuration extensions 380 is similar to the description of the node configuration extensions 326.

In some embodiments, the run-time bi-directional node 354 may be a combination of the edge node-type and the overlay node-type. In such embodiments, the run-time bi-directional node 354 may exhibit properties of the edge node-type as well as the overlay node-type. Also, in such embodiments, the run-time bi-directional node 354 may be a run-time bi-directional overlay node. In some embodiments, the run-time bi-directional node 354 may be a combination of the edge node-type and the role node-type. In such embodiments, the run-time bi-directional node 354 may exhibit properties of the edge node-type as well as the role node-type. Also, in such embodiments, the run-time bi-directional node 354 may be a connection node and form a part (for example, an inward connection object (ICO), an outward connection object (OCO), or the like) of a run-time connection link that couples an associated run-time bi-directional node with another run-time bi-directional node. In some embodiments, the run-time bi-directional node 354 may be associated with another run-time bi-directional node by way of a run-time connection link that may include an ICO and an OCO. The run-time connection link may be composed of a connection link template and a connection link instance such that the ICO may include an ICO template and an ICO instance and the OCO may include an OCO template and an OCO instance. The run-time bi-directional node 354 may be associated with the ICO or the OCO such that the run-time bi-directional node may own the associated ICO or OCO. Further, the associated ICO or the OCO may also be indicative of a primary role or secondary role associated with the run-time bi-directional node 336. In an instance, the run-time bi-directional node 354 may be associated with the ICO. In such an instance, the ICO instance may be associated with a node instance of the run-time bi-directional node 354 and the ICO template may be associated with a node template of the run-time bi-directional node 354. In another instance, the run-time bi-directional node 354 may be associated with the OCO. In such an instance, the OCO instance may be associated with the node instance of the run-time bi-directional node 354 and the OCO template may be associated with the node template of the run-time bi-directional node 354.

For the sake of brevity, a run-time node of the executable graph-based model 100, that is not a run-time bi-directional node, is referred to as a generic run-time node. Additionally, an overlay node of the executable graph-based model 100 that is a run-time bi-directional node is referred to as a run-time bi-directional overlay node.

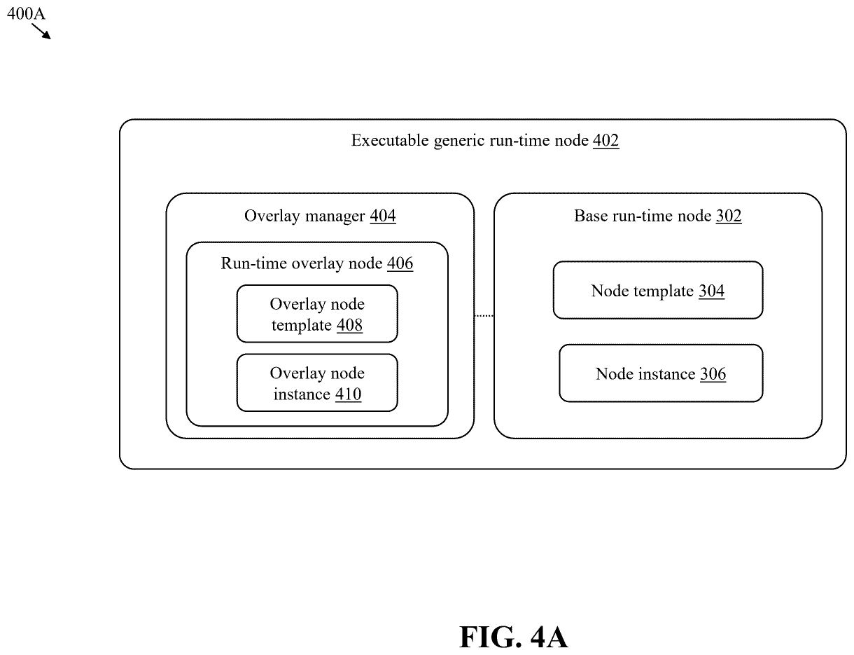

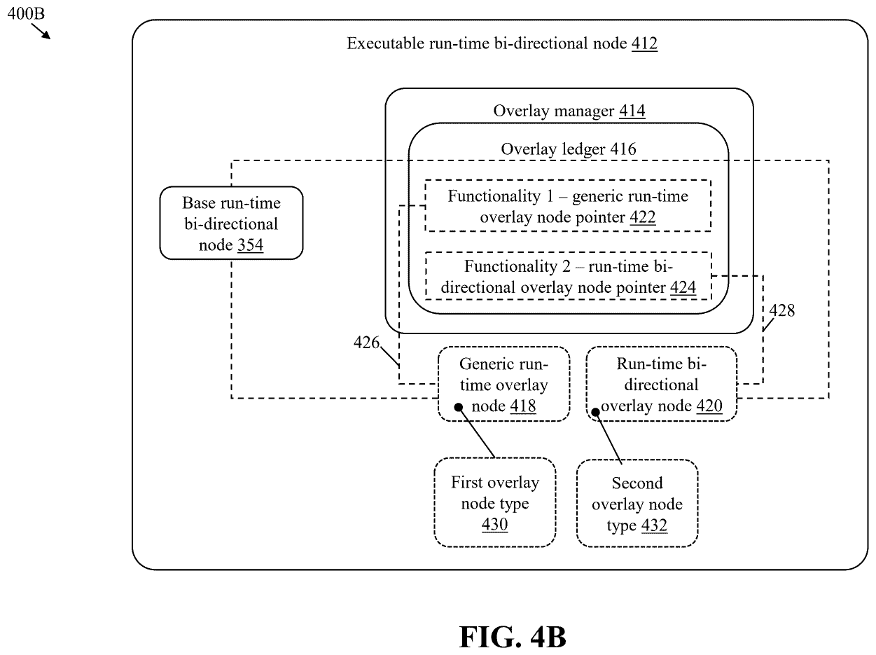

FIG. 4A is a block diagram 400 that illustrates an executable generic run-time node 402 within the executable graph-based model 100, consistent with disclosed embodiments of the present disclosure. Referring to FIG. 4, the executable generic run-time node 402 is shown to include the generic run-time node 302 (hereinafter referred to as ‘the base run-time node 302’) and an overlay manager 404. The overlay manager 404 may include a run-time overlay node 406. The executable generic run-time node 402 provides processing functionality (e.g., processing logic) to the base run-time node 302 via one or more associated overlay nodes (for example, the run-time overlay node 406). Beneficially, the data and processing capability of the base run-time node 302 may be dynamically and significantly extended using the concept of an executable run-time node (for example, the executable generic run-time node 402).

Although, the executable generic run-time node 402 is shown to include a single run-time overlay node (e.g., the run-time overlay node 406), in other embodiments, the executable generic run-time node 402 may include any number of run-time overlay nodes.

The executable generic run-time node 402 extends the base run-time node 302 (or is a subtype of the base run-time node 302) such that all the functionality and properties of the base run-time node 302 may be accessible to the executable generic run-time node 402. The executable generic run-time node 402 also dynamically extends the functionality of the base run-time node 302 by associating the run-time overlay nodes maintained by the overlay manager 404 with the base run-time node 302. The executable generic run-time node 402 may thus be considered a composition of the base run-time node 302 and the run-time overlay node 406. The executable generic run-time node 402 may be alternatively referred to as a generic run-time node with overlay(s). Therefore, the executable generic run-time node 402 acts as a decorator of the base run-time node 302 adding the functionality of the overlay manager 404 to the base run-time node 302.

It will be apparent to a person skilled in the art that the base run-time node 302 refers to any suitable run-time node within the executable graph-based model 100. As such, the base run-time node 302 may be a generic run-time node having a type such as a vertex node type, an edge node type, or the like. Alternatively, the base run-time node 302 may itself be an executable node such that the functionality of the (executable) base run-time node 302 is dynamically extended. In this way, complex and powerful processing functionality can be dynamically generated by associating and extending overlay nodes.

The overlay manager 404 registers and maintains one or more run-time overlay nodes (such as the run-time overlay node 406) associated with the base run-time node 302. The assignment of the run-time overlay node 406 to the base run-time node 302 (via the overlay manager 404) endows the base run-time node 302 with processing logic and executable functionality defined within the run-time overlay node 406. In other words, the run-time overlay node 406 may interact at run-time, with the node template 304 and/or the node instance 306 of the base run-time node 302. In an example, the node template 304 and the node instance 306 may be not executable nodes. That is, neither the node template 304 nor the node instance 306 comprises an overlay manager with one or more run-time overlay nodes. In another example, the node template 304 and/or the node instance 306 may be executable nodes thereby extending the functionality, complexity, and configurability of executable run-time nodes.

Extending the functionality of a base run-time node through one or more run-time overlay nodes is at the heart of the overlay system 202. As illustrated in FIG. 2, the data (e.g., a vertex node as represented by the base run-time node 302 in FIG. 4A) and the functionality that acts upon that data (e.g., an overlay node) can be separated and independently maintained offline, but at run-time, an association between the data node and the run-time overlay node is determined and an executable run-time node is generated (e.g., the executable generic run-time node 402 shown in FIG. 4A).

Each run-time overlay node comprises an overlay node template 408 and an overlay node instance 410. The overlay node template 408 is a node template with the overlay node type template 334. Similarly, the overlay node instance 410 is a node instance with the overlay node type instance 352. The overlay node instance 410 is an implementation of the overlay node template 408. The overlay node template 408 comprises one or more generic rules that may be implemented by the processing logic of the overlay node instance 410. For example, a rule may be defined in an overlay node template specifying that a hashing algorithm is to be used and an overlay instance associated with the overlay template provides a specific implementation of a hashing algorithm (e.g., Message-Digest Algorithm 5 (MD5), Secure Hash Algorithm-1 (SHA-1), SHA-2, etc.).

An overlay node, such as the run-time overlay node 406, is a node having an overlay node type (alternatively referred to as an overlay type) assigned to its node type. Examples of overlay node types include an encryption overlay node type, an obfuscation overlay node type, an audit overlay node type, an analytics overlay node type, a handler overlay node type, a publisher overlay node type, or the like. It will be apparent to a person skilled in the art that the list of overlay types is not exhaustive and the number of different overlay types that can be realized is not limited.

Because an overlay node is itself a node, all functionality of a node described in relation to the base run-time node 302 is thus applicable to an overlay node. For example, an overlay node may include a unique ID, a name, etc., can have attributes (e.g., an overlay node can have its data defined), supports multiple inheritance, and can be configured via node configurations. Furthermore, because an overlay node is a node, the overlay node can have one or more overlay nodes associated therewith (e.g., the overlay node may be an overlay node with an overlay). Moreover, the processing functionality of an overlay node extends to the node type of the node to which the overlay node is applied.

A run-time overlay node, such as the run-time overlay node 406, is not bound to a single executable node or a single executable graph-based model (unlike nodes that have non-overlay node types). This allows run-time overlay nodes to be centrally managed and reused across multiple instances of executable graph-based models. Notably, a node (for example, a base node, an executable node, and an overlay node) may be extended by way of overlays. Further, each overlay node may be extended to have one or more overlays. Such overlays may be termed chaining overlays.

Unlike non-run-time overlay nodes, a run-time overlay node may include processing logic (not shown in FIG. 4) which determines the functionality of the run-time overlay node. The processing logic of a run-time overlay node may include a block of executable code, or instructions, which carries out one or more operations associated with the facilitation of indexing within the executable graph-based model 100. The block of executable code is pre-compiled code, code that requires interpretation at run-time, or a combination of both. Different run-time overlay nodes provide different processing logic to realize different functionality. The overlay manager 404 of the executable generic run-time node 402 is responsible for executing all overlays registered therewith. The overlay manager 404 also coordinates the execution of all associated overlay nodes. As shown in FIG. 4A, the executable generic run-time node 402 associates the base run-time node 302 with the run-time overlay node 406.

In some embodiments, the overlay manager 404 employs a strategy to manage potentially cascading execution flow of overlays such that one overlay may be associated with one or more other overlays. Example strategies to manage the cascading execution of overlays include the visitor pattern and the pipe and filter pattern. Further examples include strategies that apply either breadth-first or depth-first processing patterns, a prioritization strategy, or a combination thereof. All execution strategies may be defined and registered with the overlay manager 404 and may be associated with an overlay via a node configuration extension for the overlay.

FIG. 4B is a block diagram 400B that illustrates an executable run-time bi-directional node 412 within the executable graph-based model 100, consistent with disclosed embodiments of the present disclosure. Referring to FIG. 4B, the executable run-time bi-directional node 412 is shown to include a base run-time bi-directional node (for example, the run-time bi-directional node 354) and an overlay manager 414. Hereinafter, the base run-time bi-directional node is referred to as the run-time bi-directional node 354. The run-time bi-directional node 354 being a bi-directional node may have the edge node-type. The run-time bi-directional node 354 may be associated with a generic overlay node and/or a run-time bi-directional overlay node. The overlay manager 414 has a description that is similar to the description of the overlay manager 404. In addition, the overlay manager 414 creates and maintains an overlay ledger 416.

The overlay ledger 416 may refer to a list of overlays (for example, generic run-time overlays and run-time bi-directional overlays) associated with the base run-time bi-directional node 336 and functionalities associated with each of the overlays. The overlay ledger 416 further may include a pointer associated with each entry in the overlay ledger 416 that points to a corresponding overlay node associated with the base run-time bi-directional node 354. As shown, the base run-time bi-directional node 354 is extended by way of a generic run-time overlay node 418 and a run-time bi-directional overlay node 420. Based on the association of the generic run-time overlay node 418 and the run-time bi-directional overlay node 420 with the base run-time bi-directional node 354, the overlay manager 414 creates entries 422 and 424 for the generic run-time overlay node 418 and the run-time bi-directional overlay node 420, respectively. As shown, for the generic run-time overlay node 418 and the run-time bi-directional overlay node 420, the entries 422 and 424 include functionalities and pointers 426 and 428, respectively, that point to corresponding overlay nodes. For example, the pointer 426 associated with the entry 422 points to the generic run-time overlay node 418, and the pointer 428 associated with the entry 424 points to the run-time bi-directional overlay node 420. The generic run-time overlay node 418 may have a first overlay node type 430 whereas the run-time bi-directional overlay node 420 may have a second overlay node-type 432. Examples of overlay node-type may include, but are not limited to, an encryption overlay node-type and a publisher overlay node-type.

A node with the encryption overlay node-type is an encryption overlay node that is indicative of an encryption technique using which an associated node is to be secured. The encryption overlay node also may include processing logic to secure a corresponding node. Examples of the encryption technique include a symmetric encryption algorithm, an asymmetric encryption algorithm, a combination of these, or any other encryption technique. A node with the publisher overlay node-type is a publisher overlay node that is indicative of an operation of publishing an output of an associated node. The publisher overlay node also may include processing logic to publish the output.

Although, the executable run-time bi-directional node 412 is shown to include the generic run-time overlay node 418 and the run-time bi-directional overlay node 420, in other embodiments, the executable run-time bi-directional node 412 may include any number of generic run-time overlay nodes and/or run-time bi-directional overlay nodes, without deviating from the scope of the present disclosure.

Notably, the structure of the run-time bi-directional overlay node 420 may be the same as the run-time bi-directional node 354 whereas processing logic associated with the run-time bi-directional overlay node 420 may be similar to generic run-time overlay nodes (for example, the generic run-time overlay node 418). In other embodiments, processing logic associated with the run-time bi-directional overlay node 420 may be different from generic overlay nodes in the executable graph-based model 100.

In an instance, one of the generic run-time overlay node 418 and the run-time bi-directional overlay node 420 may be required to be executed. In such an instance, the overlay manager 414 may identify a relevant overlay node based on the functionality of one of the generic run-time overlay node 418 and the run-time bi-directional overlay node 420 as per the overlay ledger 416. Upon identification of the relevant overlay node, the overlay manager 414 may trigger the relevant overlay node by way of a corresponding pointer.

In some embodiments, the data and the processing logic associated with generic run-time overlays and/or run-time bi-directional overlays may be non-persistent. Such generic run-time overlays and run-time bi-directional overlays may be known as stateless overlays. Notably, processing logic and outputs associated with stateless overlays cease to exist based on unloading of the overlays and require to be recreated as and when required.

Throughout the description, an executable run-time node (for example, the executable generic run-time node 402 and the executable run-time bi-directional node 412) is represented by way of two concentric circles. In other words, the executable node is represented by way of an inner circle encircled by an outer circle, where the incircle represents a base node and the outer circle represents an overlay node associated with the base node.

In some embodiments, the data and the processing logic associated with generic run-time overlays and/or run-time bi-directional overlays may be persistent. Such generic run-time overlays and run-time bi-directional overlays may be known as stateful overlays. Notably, processing logic and outputs associated with stateful overlays may be stored in the storage element of the overlay system 202 and may be loaded in the executable graph-based model 100 and used as and when required. The persistent nature of the data and the processing logic associated with an executable node and an associated generic overlay node may be described in detail in conjunction with FIG. 5.

FIG. 5 is a block diagram 500 that illustrates a composition of the executable generic run-time node 402 that enables persistent storage of data and the processing logic associated therewith, consistent with disclosed embodiments of the present disclosure. As described in conjunction with FIG. 4A, the executable generic run-time node 402 may include the base run-time node 302 and one or more run-time overlay nodes (e.g., the run-time overlay node 406). For the sake of brevity of the ongoing description, the persistent storage is explained for the executable generic run-time node 402 including only the run-time overlay node 406. Operations performed to ensure the persistence of one or more additional or cascading overlay nodes may be performed in a similar manner. As discussed previously, the executable generic run-time node 402 may include the node template 304 and the node instance 306. For the sake of brevity of the ongoing description, the persistent storage is described for the node instance 306. Notably, persistent storage for the node template 304 may be performed in a similar manner. Additionally, for the sake of brevity, it is assumed that the run-time overlay node 406 may be associated with the node instance 306 of the executable generic run-time node 402. Therefore, the node instance 306 itself may act as an executable node. For the sake of brevity of the description, hereinafter the node instance 306 when in association with the run-time overlay node 406, is referred to as an executable node 306 with a base node 501. The base node 501 may be the node instance 306 without the associated run-time overlay node 406.

Referring to FIG. 5, the executable node 306 has a corresponding first state 502 having a first ID 504. The base node 501 has a second state 506 having a second ID 508, and the run-time overlay node 406 has a third state 510 having a third ID 512. A manifest (for example, first through third manifests 514-518) is generated for each of the base node 501, the executable node 306 and the run-time overlay node 406. In an embodiment, the manifests may be generated by the storage management module 220. The first manifest 514 may be associated with executable node 306 and has a fourth ID 520 and an overlay ID 522. The second manifest 516 may be associated with the base node 501 and has a fifth ID 524. The third manifest 518 may be associated with the run-time overlay node 406 and has a sixth ID 526. Further, the manifests may be stored at respective storage locations that may be centralized or distributed storage locations associated with the overlay system 202. The manifests may be stored by the storage management module 220.

The first state 502 of the executable node 306 may include data required to reconstruct the executable node 306 (e.g., attributes, properties, etc.). The first state 502 of the executable node 306 is persistently stored along with the first ID 504. The first manifest 514 is generated for the executable node 306 and has (i) the fourth ID 520 (which is the same as the first ID 504), (ii) the storage location of the first state 502 of the executable node 306, and (iii) the overlay ID 522 (which is the same as the sixth ID 526). Notably, the fourth ID 520 is the same as the first ID 504 and the fifth ID 524, hence, the first manifest 514 may include the ID of the state of the base node 501 and the executable node 306. Further, the overlay ID 522 is the same as the sixth ID 526 of the state of the run-time overlay node 406. Therefore, the first manifest 514 may be used to identify and retrieve the states of the base node 501, the executable node 306, and the run-time overlay node 406. Subsequently, the retrieved states may be used to reconstruct the executable node 306 and the run-time overlay node 406. In an instance, the executable node 306 may be further extended to include additional overlay nodes. In such an instance, the first manifest 514 may include state IDs of the additional overlay nodes as well. A first manifest state (not shown) is then generated for the first manifest 514 and persistently stored along with the fourth ID 520.

The second state 506 of the base node 302 may include data required to reconstruct the base node 501 (e.g., attributes, properties, etc.) and is persistently stored along with the second ID 508. The second manifest 516 is generated for the base node 302 and has the fifth ID 524 and the storage location of the second state 506 of the base node 302. The second ID 508 of the second state 506 and the fifth ID 524 of the second manifest 516 may be the same as the first ID 504 of the first state 502 of the executable generic run-time node 402 (which is also the same as the fourth ID 520 of the first manifest 514 of the executable generic run-time node 402). As mentioned above, along with the first state 502, the first manifest 514 may also be used to identify and retrieve the second manifest 516 which in turn may be used to identify the second state 506 of the base node 302. A second manifest state (not shown) is then generated for the second manifest 516 and persistently stored along with the fifth ID 524. Thus, the states, manifests, and manifest states for the executable generic run-time node 402 and the base node 302 include the same, shared, ID. A shared ID can be used in this instance because the states, manifests, and manifest states may be stored separately. The separate storage of the states, manifests, and manifest states exhibit a distributed architecture of the overlay system 202.

The third state 510 of the run-time overlay node 406 may include data required to reconstruct the run-time overlay node 406 (e.g., attributes, properties, processing logic, etc.) and is persistently stored along with the third ID 512. The third manifest 518 is generated for the run-time overlay node 406 and may include the sixth ID 526, which is the same as the third ID 512. Therefore, the first manifest 514 may be further used to identify and retrieve the third manifest 518 which in turn may be used to identify and retrieve the third state 510 of the run-time overlay node 406. A third manifest state (not shown) is then generated for the third manifest 518 and is persistently stored along with the sixth ID 526.

In operation, when the executable generic run-time node 402 is to be loaded, the transaction module 208, in conjunction with the storage management module 220, may execute one or more operations to retrieve the node instance 306. As shown, the node instance 306 points to the node template 304. Therefore, the node template 304 is loaded prior to the node instance 306. Subsequently, in order to load the node instance 306, the first manifest state, stored at a known storage location, may be accessed. Based on the first manifest state, the storage management module 220 may re-construct the first manifest 514 which may include the fourth ID 520 which is the same as the fifth ID 524 of the second manifest 516. Based on the fifth ID 524, the storage management module 220 may identify the second manifest state and may generate the second manifest 516 based on which the second state 506 is identified. Subsequently, the base node 501 is loaded and the storage management module 220 may determine that the base node 501 is a node with overlay. Based on the fourth ID 520 (that is the same as the first ID 504 of the first state 502 of the executable generic run-time node 402) of the first manifest 514, the first state 502 is identified and retrieved. Subsequently, the executable generic run-time node 402 is loaded. Moreover, based on the overlay ID 522 (that is the same as the sixth ID 526 of the third manifest 518) of the first manifest 514, the third manifest state is identified and the third manifest 518 is generated. Subsequently, based on the sixth ID 526 (that is the same as the third ID of the third state) of the third manifest 518, the third state 510 is identified and retrieved. Based on the third state 510, the run-time overlay node 406 is reconstructed and loaded in the executable graph-based model 100.

Based on a context of a stimulus (for example, the stimulus 230) associated with the overlay system 202, the processing circuitry (such as the context module 210) may determine an ID which is the same as the fifth ID 524. Based on the determined ID, the processing circuitry (such as the memory management module 218 and the storage management module 220) may identify the second manifest 516. Subsequently, the processing circuitry (such as the memory management module 218 and the storage management module 220) may identify the second state 506 that has the second ID 508 that matches the fifth ID 524. Further, the processing circuitry (such as the memory management module 218 and the storage management module 220) may retrieve the second state 506 associated with the second manifest 516 from a corresponding storage element. Subsequently, the processing circuitry (such as the memory management module 218 and the storage management module 220) may determine, by checking the manifest storage(s) associated with the overlay system 202, whether there is another manifest (such as the first manifest of the executable generic run-time node 402) with an ID that matches the second ID 508 and the fifth ID 524. Notably, the first manifest 514 may include storage locations of each overlay node (for example, the run-time overlay node 406) of the executable generic run-time node 402. Based on the overlay ID 522 included in the first manifest 514 that matches the sixth ID 526 included in the third manifest 518, the processing circuitry (such as the memory management module 218 and the storage management module 220) may identify and retrieve the third manifest 518 from a manifest storage of a plurality of manifest storages of the overlay system 202. Subsequently, the processing circuitry (such as the memory management module 218 and the storage management module 220) may identify the third state 510 that has the third ID 512 that matches the sixth ID 526. Further, the processing circuitry (such as the memory management module 218 and the storage management module 220) may retrieve the third state 510 associated with the third manifest 518 from a corresponding storage element. To determine whether the run-time overlay node 406 has an overlay node associated therewith, the processing circuitry (such as the memory management module 218 and the storage management module 220) may also perform a check to determine whether any of the plurality of manifest storages of the overlay system 202 may include any other manifest with an ID that matches the sixth ID 526. Since the run-time overlay node 406 does not have an overlay associated therewith, no other manifest has the ID that matches the sixth ID.

Notably, the manifest (the third manifest 518) of the run-time overlay node 406 may include a reference (such as an identifier that is common to the second manifest 516 and the third manifest 518, a link, a path, a storage location, or the like) to the second manifest 516 of the base node 302. Therefore, the re-formation of the executable node 306 may include a re-creation of the run-time overlay node 406 prior to a re-creation of the base node 501. Subsequently, the run-time overlay node 406 and the base node 501 may be organized by associating the base node 501 with the run-time overlay node 406 to re-form the executable node 306 (i.e., the node instance). Subsequently, the node template 304 is loaded in a similar manner and associated with the node instance 306 to load the executable generic run-time node 402.

In some embodiments, the run-time overlay node 406 may not be loaded in case it is not required for executing the operation associated with the stimulus 230. The loaded executable generic run-time node 402 and the run-time overlay node 406 may be unloaded in case they remain unused for a predefined time period, whereas one or more executable run-time nodes (for example, executable generic run-time nodes and executable run-time bi-directional nodes) that may be used at least once during the predefined time period may remain loaded in the executable graph-based model 100. In some embodiments, the data and processing logic associated with a loaded executable run-time node and/or run-time overlay node may be transferred to a local memory of the overlay system 202 if the data and the processing logic remain unused for a first predefined period of time. Further, the data and the processing logic associated with the executable node/overlay node may be transferred to an external storage from the local memory in case the executable run-time node/run-time overlay node remains unused for a second predefined period of time. The second predefined period of time is greater than the first predefined period of time. The term unloading refers to storing a state of a node with a current version of data and processing logic associated therewith at a storage location that is pointed by the corresponding manifest.

In some embodiments, the second state 506 and the second manifest 516 may include a verification code (not shown). Based on verification codes of the second state 506 and the second manifest 516 being a match, the manifest state for the base node 501 may be accessed to reconstruct the base node 501. It will be apparent to a person skilled in the art that other base nodes, node templates, node instances, overlay node templates, overlay node instances, or the like may be reconstructed in a similar manner.

An executable graph-based model (for example, the executable graph-based model 100) may be stored (and loaded) using the above-described composition. Beneficially, each component is stored separately thereby allowing a user to maintain and store their data independently of the storage of the structure and functionality of the executable graph-based model 100.

Notably, the management and storage of manifests is managed by the controller module 206, the memory management module 218, the storage management module 220, a combination of these, or any other module of the overlay system 202. Also, all manifest states may be stored together at a storage location (such as a manifest storage) that is known to the storage management module 220. Such centralized storage of the manifest states ensures that node states associated therewith may be easily accessible.

It will be apparent to a person skilled in the art that although FIG. 5 illustrates only a single run-time overlay node associated with a generic run-time node, in other embodiments, the executable generic run-time node 402 may include additional or different generic run-time overlay nodes. It will also be apparent to a person skilled in the art that only those overlay nodes that may be required for responding to the stimulus 230 may be loaded.

To summarize, for loading a generic run-time node or a run-time bi-directional node associated node template and node instance are required to be loaded. It will be apparent to a person skilled in the art that the executable run-time bi-directional node 412 may be loaded in a manner that is similar to the loading of the executable generic run-time node 402.

The overlay system 202 described in conjunction with FIGS. 1-5 is used to facilitate one or more operations associated with the plurality of bi-directional nodes in the executable graph-based model 100. Various concepts and features associated with the run-time bi-directional nodes may be described in detail later in the description.

Having discussed the persistent storage of an executable generic run-time node, the description now moves towards discussion of various features and persistent storage of executable run-time bi-directional nodes.

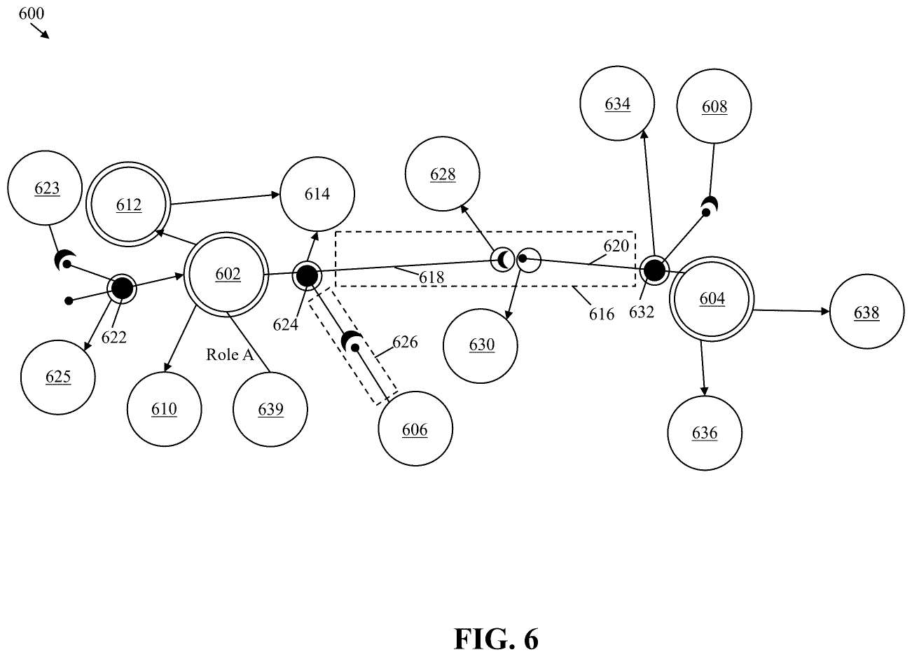

FIG. 6 illustrates a block diagram 600 that depicts features of run-time bi-directional nodes, consistent with disclosed embodiments of the present disclosure. Referring to FIG. 6, shown is the executable graph-based model 100 that may include the plurality of run-time bi-directional nodes including run-time bi-directional nodes 602 through 608. The executable run-time bi-directional node 602 is extended by way of a generic run-time overlay node 610 and a run-time bi-directional overlay node 612 that is further extended by way of an overlay node 614. The overlay node 614 may be a generic run-time overlay node or a run-time bi-directional overlay node.

As shown, the executable run-time bi-directional node 602 may be associated with the executable run-time bi-directional node 604 by way of a run-time connection link 616. The run-time connection link 616 may include an OCO 618 and an ICO 620. In other words, the OCO 618 and the ICO 620, collectively, form the run-time connection link 616. The OCO 618 is owned by the executable run-time bi-directional node 602, whereas the ICO 620 is owned by the executable run-time bi-directional node 604. The OCO 618 may include a primary role associated with the executable run-time bi-directional node 602 whereas the ICO 620 may include a secondary role associated with the executable run-time bi-directional node 604. The primary role may be indicative of a capacity in which the executable run-time bi-directional node 602 may be associated with the executable run-time bi-directional node 604. The secondary role may be indicative of a capacity in which the executable run-time bi-directional node 604 may be associated with the executable run-time bi-directional node 602. The primary role and the secondary role may be complimentary. In other words, the primary role and the secondary role, collectively, may be indicative of a mutual relationship/association between the executable run-time bi-directional nodes 602 and 604. In an example, the executable run-time bi-directional node 602 may represent a manager of a team whereas the executable run-time bi-directional node 604 may represent an associate working under the manager of the team. In such an example, the primary role may be ‘manager’ and the secondary role may be ‘associate’. Hence, the run-time connection link 616 may indicate that the mutual association between the run-time bi-directional nodes 602 and 604 may be of a manager and associate.

In some embodiments, the run-time connection link 616 may be realized as a run-time node (for example, a run-time bidirectional node) with a role node-type. In such embodiments, the OCO 618 and the ICO 620 may also be associated with corresponding generic run-time overlay nodes and/or run-time bi-directional overlay nodes.

In some embodiments, the association between the run-time bi-directional nodes 602 and 604 may be based on a dependency therebetween. The run-time connection link 616 may be further indicative of the dependency between the run-time bi-directional nodes 602 and 604. The dependency between the run-time bi-directional nodes 602 and 604 may be at least one of an own-owned dependency, a use-used dependency, or a share-shared dependency. Such dependency between the run-time bi-directional nodes 602 and 604 may be defined by node templates of the run-time bi-directional nodes 602 and 604 and adhered to by node instances of the run-time bi-directional nodes 602 and 604. In an instance of the own-owned dependency between the run-time bi-directional nodes 602 and 604, the node template of the run-time bi-directional node 602 may define that the run-time bi-directional node 602 owns the run-time bi-directional node 604. The node template of the run-time bi-directional node 604 may define that the run-time bi-directional node 604 may be owned by the run-time bi-directional node 602. Based on such definitions in the node templates of the run-time bi-directional nodes 602 and 604, the node instance of the run-time bi-directional node 604 may be owned by the node instance of the run-time bi-directional node 602.

Similarly, the use-used dependency, the share-shared dependency, or any other dependency between the run-time bi-directional nodes 602 and 604 may be defined by the node templates of the run-time bi-directional nodes 602 and 604 and adhered to by the node instances of the run-time bi-directional nodes 602 and 604.

In some embodiments, when the dependency between the executable run-time bi-directional nodes 602 and 604 may be the own-owned dependency, the executable run-time bi-directional node 602 may own the executable run-time bi-directional node 604. The executable run-time bi-directional node 604 may be exclusive to the executable run-time bi-directional node 602 which may exclusively use the executable run-time bi-directional node 604. In other words, the executable run-time bi-directional node 602 may exclusively use data and/or processing logic associated with the executable run-time bi-directional node 604. In an instance, when the dependency between the executable run-time bi-directional nodes 602 and 604 may be the own-owned dependency, the primary role associated with the executable run-time bi-directional node 602 may be ‘own’ and the secondary role associated with the executable run-time bi-directional node 604 may be ‘owned’.

In some embodiments, when the dependency between the executable run-time bi-directional nodes 602 and 604 may be the use-used dependency, the executable run-time bi-directional node 602 may exclusively use the executable run-time bi-directional node 604 at a given time-instance. In other words, the executable run-time bi-directional node 602 may exclusively use data and/or processing logic associated with the executable run-time bi-directional node 604 at the given time-instance. The executable run-time bi-directional node 604 may be used by other run-time bi-directional node associated therewith at a time instance later or prior to the given time-instance. In an instance, when the dependency between the run-time bi-directional nodes 602 and 604 may be the use-used dependency, the primary role associated with the executable run-time bi-directional node 602 may be ‘use’ and the secondary role associated with the executable run-time bi-directional node 604 may be ‘used’.

In some embodiments, when the dependency between the run-time bi-directional nodes 602 and 604 may be the share-shared dependency, the executable run-time bi-directional node 602 may use the executable run-time bi-directional node 604 while sharing the executable run-time bi-directional node 604 with one or more other run-time bi-directional nodes associated therewith. In other words, the executable run-time bi-directional node 602 may use the data and/or processing logic associated with the executable run-time bi-directional node 604 while sharing the executable run-time bi-directional node 604 with the one or more other run-time bi-directional nodes. In other words, the executable run-time bi-directional node 604 may be simultaneously used by the executable run-time bi-directional node 602 and the one or more other run-time bi-directional nodes. In an instance, when the dependency between the run-time bi-directional nodes 602 and 604 may be the share-shared dependency, the primary role associated with the executable run-time bi-directional node 602 may be ‘share’ and the secondary role associated with the executable run-time bi-directional node 604 may be ‘shared’.

In operation, the processing circuitry (for example, the controller module 206 and the stimuli management module 212) may receive the stimulus 230. Based on the stimulus 230, the processing circuitry (for example, the controller module 206 and the stimuli management module 212) may identify the executable run-time bi-directional node 602. Based on the identification, the processing circuitry (for example, the controller module 206 and the stimuli management module 212) may determine the run-time connection link 616 based on the association of the OCO 618 with the executable run-time bi-directional node 602. Subsequently, the processing circuitry (for example, the controller module 206 and the stimuli management module 212) may identify the executable run-time bi-directional node 602 based on association with the ICO 620 of the run-time connection link 616.

Subsequently, based on the stimulus 230, the executable run-time bi-directional node 602 may receive input from a first set of run-time bi-directional nodes associated therewith an inward group object 622. An inward group object is a logical part of an associated run-time bi-directional node that receives inputs via ICOs of one or more run-time connection links associated therewith. The inward group object 622 may be a convergence point for one or more ICOs of various run-time connection links associated with the executable run-time bi-directional node 602. The first set of run-time bi-directional nodes may include a run-time bi-directional node 623 associated with the executable run-time bi-directional node 602 via an associated run-time connection link such that an OCO of the run-time connection link is associated with the run-time bi-directional node 623 and an ICO of the run-time connection link is associated with the executable run-time bi-directional node 602. Similarly, the first set of run-time bi-directional nodes may include another run-time bi-directional node (not shown) associated with the executable run-time bi-directional node 602 via an associated run-time connection link such that an ICO of the run-time connection link is associated with the inward group object 622. To summarize, an operation associated with the stimulus may be executed based on the first set of run-time bi-directional nodes associated with the executable run-time bi-directional node 602 via the inward group object 622.

In an instance, the inward group object 622 may forward the inputs, received from the run-time bi-directional node 623 and the other run-time bi-directional node, separately to the executable run-time bi-directional node 602. In another instance, the inward group object 622 may forward the inputs, received from the run-time bi-directional node 623 and the other run-time bi-directional node, as a combined input signal to the executable run-time bi-directional node 602. Therefore, the operation associated with the stimulus may be executed further based on the inward group object 622, the run-time bi-directional node 623, and the other run-time bi-directional node communicating with the executable run-time bi-directional node 602 via the inward group object 622. The operation associated with the stimulus may be executed further based on connection links that associate the run-time bi-directional node 623, and the other run-time bi-directional node with the executable run-time bi-directional node 602.

In some embodiments, the inward group object 622 may be associated with one or more overlay nodes (for example, an overlay node 625). The run-time overlay node 625 associated with the inward group object 622 may be a generic run-time overlay node or a run-time bi-directional overlay node). In such embodiments, processing logic associated with the one or more run-time overlay nodes may be executed on the inputs received at the inward group object 622. Subsequently, an output of the execution may be provided to the executable run-time bi-directional node 602 as the input (for example, a stimulus). Therefore, the operation associated with the stimulus may be executed further based on the run-time overlay node 625 associated with the inward group object 622.

In other embodiments, one or more run-time connection links that provide input to the executable run-time bi-directional node 602 may be directly associated with the executable run-time bi-directional node 602. In other words, the one or more run-time connection links that provide the input to the executable run-time bi-directional node 602 may be associated with the executable run-time bi-directional node 602 without being associated with the inward group object 622. In such embodiments, the functionalities of the one or more overlay nodes associated with the inward group object 622 may not be executed on the input received via the one or more run-time connection links that may be not associated with the inward group object 622.

The input received by the executable run-time bi-directional node 602 may act as a stimulus (for example, the stimulus 230). Based on the stimulus, the processing circuitry (for example, the controller module 206, the transaction module 208, or the like) may identify, from the plurality of executable run-time bi-directional nodes, the executable run-time bi-directional node 602 required to execute an operation associated with the stimulus. Based on the identification of the executable run-time bi-directional node 602, the processing logic (for example, the memory management module 218 and the storage management module 220) may be configured to determine the run-time connection link 616, including the OCO 618 and the ICO 620, coupled to the executable run-time bi-directional node 602. The OCO 618 of the run-time connection link may define association with the executable run-time bi-directional node 602 by way of the primary role. Additionally, the ICO 620 of the run-time connection link may define an association with the executable run-time bi-directional node 604 by way of the secondary role. As mentioned previously, the ICO 620 of the run-time connection link 616 is associated with the executable run-time bi-directional node 604. Therefore, based on the run-time connection link 616, the processing logic (for example, the memory management module 218 and the storage management module 220) may be configured to identify the executable run-time bi-directional node 604. In an instance, the executable run-time bi-directional nodes 602 and 604 may not be loaded in the executable graph-based model 100. In such an instance, the processing logic (such as the memory management module 218 and the storage management module 220) may be configured to load the executable run-time bi-directional nodes 602 and 604 in the executable graph-based model 100 prior to utilization thereof for executing the operation associated with the stimulus.

Subsequently, the processing logic (for example, the controller module 206, the transaction module 208, or the like) may use the executable run-time bi-directional node 602 to generate a message (for example, a signal, an event, a query, a command, an instruction, or the like) based on an execution of processing logic associated with the generic run-time overlay node 610, the run-time bi-directional overlay node 612, and the generic run-time overlay node 614 associated with the run-time bi-directional overlay node 612. In an embodiment, the processing circuitry (for example, the controller module 206, the transaction module 208, or the like) may be configured to identify the generic run-time overlay node 610, the run-time bi-directional overlay node 612, and the run-time overlay node 614 associated with the executable run-time bi-directional node 602 prior to their utilization. The message may be generated further based on the generic run-time overlay node 610 and the run-time bi-directional overlay node 612 associated with the executable run-time bi-directional node 602. That is to say, the operation associated with the stimulus is executed further based on the generic run-time overlay node 610, the run-time bi-directional overlay node 612 associated with the executable run-time bi-directional node 602. The operation associated with the stimulus is executed further based on the run-time overlay node 614 associated with the run-time bi-directional overlay node 612.

For communication of the message to the executable run-time bi-directional node 604, the message passes through an outward group object 624 associated with the executable run-time bi-directional node 602. An outward group object is a logical part of an associated run-time bi-directional node that communicates a message via outward connection objects of one or more run-time connection links associated therewith. The outward group object 624 may be a divergence point for one or more OCOs of various run-time connection links associated with the executable run-time bi-directional node 602. For example, the run-time connection link 616 and a run-time connection link 626 may diverge from the outward group object 624. The run-time connection link 616 may associate the executable run-time bi-directional node 602 to the run-time bi-directional node 606 such that the executable run-time bi-directional node 602 may communicate one or more messages to the run-time bi-directional node 606 via the outward group object 624.

At the outward group object 624, the processing circuitry (for example, the controller module 206, the transaction module 208, or the like) may execute the processing logic associated with the run-time overlay node 614 on the message being communicated by the executable run-time bi-directional node 602. Therefore, the operation associated with the stimulus may be executed further based on the outward group object 624 and the overlay node 614 associated therewith. Subsequently, the message may be communicated to the run-time bi-directional nodes 604 and 606 via the run-time connection links 616 and 626, respectively. In other words, the message being communicated via the outward group object 624 may be communicated to each run-time bi-directional node that may be associated with the executable run-time bi-directional node 602 via connection links with corresponding OCOs diverging from the outward group object 624. Therefore, the operation associated with the stimulus may be executed further based on the run-time bi-directional node 606.

While being communicated to the executable run-time bi-directional node 604, the message passes through the OCO 618. Throughout the description, an OCO is depicted by way of a half-moon associated with a solid line and an ICO is depicted herein by way of an oval arrow. In addition, the half-moon enclosed within a circle indicates that the OCO may be associated with an overlay (for example, a generic run-time overlay node or a run-time bi-directional overlay node). An oval arrow-head of the oval arrow enclosed within a circle indicates that the ICO may be associated with an overlay node (for example, a generic run-time overlay node or a run-time bi-directional overlay node).

As shown, the OCO 618 may be associated with a run-time overlay node 628. The run-time overlay node 628 may be a generic run-time overlay node or a run-time bi-directional overlay node. At the OCO 618, the processing circuitry (for example, the controller module 206, the transaction module 208, or the like) may execute processing logic associated with the run-time overlay node 628 on the message received from the outward group object 624. Therefore, the operation associated with the stimulus is executed further based on the run-time overlay node 628. Subsequently, the message passes through the ICO 620. The ICO 620 may be associated with a run-time overlay node 630. The run-time overlay node 630 may be a generic run-time overlay node or a run-time bi-directional overlay node. At the ICO 620, the processing circuitry (for example, the controller module 206, the transaction module 208, or the like) may execute processing logic associated with the run-time overlay node 630 on the message received from the OCO 618. Therefore, the operation associated with the stimulus is executed further based on the run-time overlay node 630. In an embodiment, the processing circuitry (for example, the controller module 206, the transaction module 208, or the like) may be configured to identify the run-time overlay node 630 associated with the ICO 620 prior to its utilization.

Subsequently, the message is communicated to an inward group object 632. The inward group object 632 is a convergence point associated with the executable run-time bi-directional node 604 for receiving inputs from the executable run-time bi-directional node 602 and the run-time bi-directional node 608. At the inward group object 632, the processing circuitry (for example, the controller module 206, the transaction module 208, or the like) may execute processing logic associated with a run-time overlay node 634 of the inward group object 632 on the message received from the ICO 620. The run-time overlay node 634 may be a generic run-time overlay node or a run-time bi-directional overlay node. Therefore, the operation associated with the stimulus may be executed further based on the run-time overlay node 634. In an embodiment, the processing circuitry (for example, the controller module 206, the transaction module 208, or the like) may be configured to identify the run-time overlay nodes 628 and 630 associated with the OCO 618 and ICO 620, respectively, prior to their utilization.

Subsequently, the message may be communicated to the executable run-time bi-directional node 604. At the executable run-time bi-directional node 604, the processing circuitry (for example, the controller module 206, the transaction module 208, or the like) may execute processing logic associated with a run-time overlay node 636 of the executable run-time bi-directional node 604 on the message. The run-time overlay node 636 may be a generic run-time overlay node or a run-time bi-directional overlay node. Therefore, the operation associated with the stimulus may be executed further based on the run-time overlay node 636. In an embodiment, the processing circuitry (for example, the controller module 206, the transaction module 208, or the like) may be configured to identify the run-time overlay node 636 associated with the executable run-time bi-directional node 604 prior to its utilization. Based on the execution of the processing logic associated with the run-time overlay node 636, the operation associated with the stimulus may be completed and a stimulus response may be generated by the executable run-time bi-directional node 604. The stimulus response may be published using a publisher overlay node 638 (i.e., a generic run-time overlay node) associated with the executable run-time bi-directional node 604.

In some embodiments, the executable run-time bi-directional node 602 may be associated with a generic run-time node 639. The executable run-time bi-directional node 602 having an edge node-type may include a role A associated with the generic run-time node 639. The role A may be indicative of a capacity in which the generic run-time node 639 may be associated with the executable run-time bi-directional node 602. The processing circuitry (for example, the controller module 206 or the transaction module 208) may be configured to identify the generic run-time node 639 based on the association thereof with the executable run-time bi-directional node 602. The processing circuitry (for example, the controller module 206 or the transaction module 208) may be further configured to communicate the message to the generic run-time node 639. Therefore, the operation associated with the stimulus may be executed further based on the generic run-time node 639.

In some embodiments, the executable run-time bi-directional node 602 may include an overlay manager (for example, the overlay manager 414 depicted in FIG. 4B). The overlay manager may maintain a ledger (for example, the overlay ledger 416) associated with the executable run-time bi-directional node 602. The ledger may include functionalities of the generic run-time overlay node 610 and the run-time bi-directional overlay node 612. The processing logic (for example, the overlay management module 236) may be configured to trigger, based on the stimulus, the generic run-time overlay node 610 and/or the run-time bi-directional overlay node 612.

It will be apparent to a person skilled in the art that a message being executed between two run-time bi-directional nodes (for example, the executable run-time bi-directional nodes 602 and 604) passes through various junctures (for example, the run-time bi-directional node 602, the outward group object 624, the OCO 618, the ICO 620, the inward group object 632, and the executable run-time bi-directional node 604) in a sequential manner. At each juncture, in case one or more associated overlay nodes (for example, a generic run-time overlay node and/or a run-time bi-directional overlay node) may be present, processing logic of each overlay node is executed on the message and a modified message is transmitted to the subsequent juncture.

The operation associated with the stimulus may be executed further based on nodes associated with the executable run-time bi-directional node 602 via the run-time connection links associated with the inward group object 622, and the executable run-time bi-directional nodes 606 and 608 without deviating from the scope of the disclosure. The executable run-time bi-directional node 602 may use the inward group object 622 to receive one or more messages from the nodes associated therewith via the inward group object 622. Similarly, the executable run-time bi-directional node 602 may communicate with the run-time bi-directional node 606 via the outward group object 624. The executable run-time bi-directional node 602 may receive an input from the run-time bi-directional node 608 via the inward group object 632.

In some embodiments, the executable run-time bi-directional node 602 may be a stateless node or a stateful node. In an instance, when the executable run-time bi-directional node 602 may be the stateless node, the executable run-time bi-directional node 602 may be non-persistent in nature and may cease to exist based on its unloading from the executable graph-based model 100. Therefore, data and processing logic associated with the executable graph-based model 100 may have to be re-generated based on a requirement thereof. In another instance, when the executable run-time bi-directional node 602 may be the stateful node, the executable run-time bi-directional node 602 may be persistent in nature and may be loaded in the executable graph-based model 100 based on a requirement thereof.

Although not shown, the executable run-time bi-directional node 604 may have an outward group object via which the executable run-time bi-directional node 604 may be associated with two or more run-time bi-directional nodes. In some embodiments, the processing circuitry (for example, the controller module 206 and the transaction module 208) may execute the operation associated with the stimulus further based on the two or more run-time bi-directional nodes associated with the executable run-time bi-directional node 604 via the outward group object. The executable run-time bi-directional node 604 may communicate with the two or more run-time bi-directional nodes via the outward group object.

It will be apparent to a person skilled in the art that each run-time bi-directional node that may be required to process the stimulus may have to be loaded in the executable graph-based model 100. In some embodiments, the OCO 618 and/or the ICO 620 may be further associated with a set of attributes (not shown). The set of attributes may be indicative of a loading strategy associated with the executable run-time bi-directional node 602 and/or the executable run-time bi-directional node 604. In an instance, one or more attributes of the set of attributes that may be associated with the OCO 618 may be indicative of the loading strategy of the executable run-time bi-directional node 602. Similarly, one or more attributes of the set of attributes that may be associated with the ICO 620 may be indicative of the loading strategy of the executable run-time bi-directional node 604. The loading strategy may be an eager loading strategy or a lazy loading strategy. When loaded using the eager loading strategy, an executable run-time bi-directional node may be loaded proactively and hence is loaded prior to a time instance of its use. When loaded using the lazy loading strategy, the loading of an executable run-time bi-directional node may be deferred until a time instance of its use. In other words, the executable run-time bi-directional node when loaded using the lazy loading strategy may be loaded based on a requirement thereof. The set of attributes may be accessed by the processing circuitry (for example, the controller module 206 and the transaction module 208) of the overlay system 202 while processing manifests of the executable run-time bi-directional nodes.

For the sake of brevity, the run-time connection link 616 is assumed to be the node with the role node-type. In other embodiments, the run-time connection link 616 may be implemented as roles that may be integral to the run-time bi-directional nodes 602 and 604 which may be run-time bi-directional nodes with the edge node-type. In other words, the primary role may be realized by the executable run-time bi-directional node 602 and the secondary role may be realized as part of the executable run-time bi-directional node 604 without deviating from the scope of the disclosure. In such embodiments, the OCO 618 and the ICO 620 of the run-time connection link 616 may not be associated with any overlay nodes.

It will be apparent to a person skilled in the art that operations being performed by a node of the executable graph-based model 100 may be realized by the processing circuitry (for example, the controller module 206, the transaction module 208, or any other component of the overlay system 202) while using relevant nodes.

For the sake of brevity, a single communication link (for example, the run-time connection link 616) is shown between the executable run-time bi-directional nodes 602 and 604. The run-time connection link 616 allows the executable run-time bi-directional node 602 to communicate with the executable run-time bi-directional node 604. For the executable run-time bi-directional node 604 to be able to communicate with the executable run-time bi-directional node 602, another communication link (not shown) may be instantiated between the executable run-time bi-directional nodes 602 and 604 such that an ICO may be associated with the executable run-time bi-directional node 602 and an OCO may be associated with the executable run-time bi-directional node 604.

Although the executable graph-based model 100 depicted in FIG. 6 shows a network of run-time bi-directional nodes, an identical network of corresponding node instances and another identical network of corresponding node templates, of the run-time bi-directional nodes may be instantiated in the executable graph-based model 100. Such an instantiation of the node instances and node templates realizes the network of the run-time bi-directional nodes.

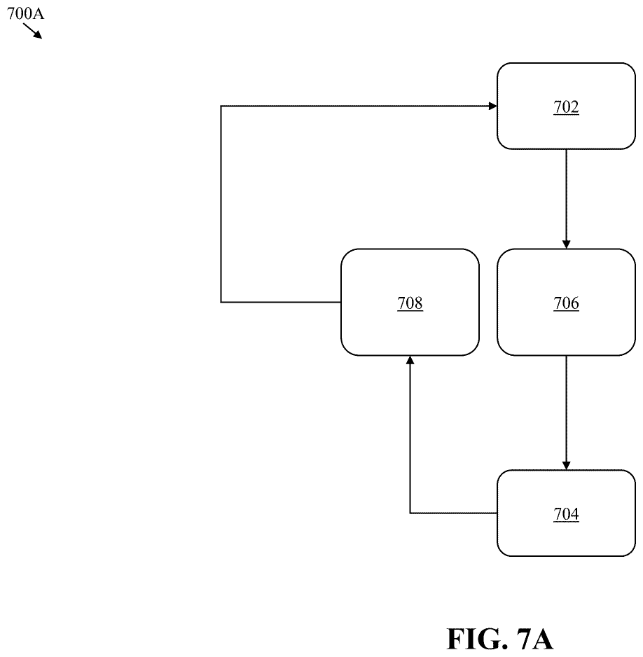

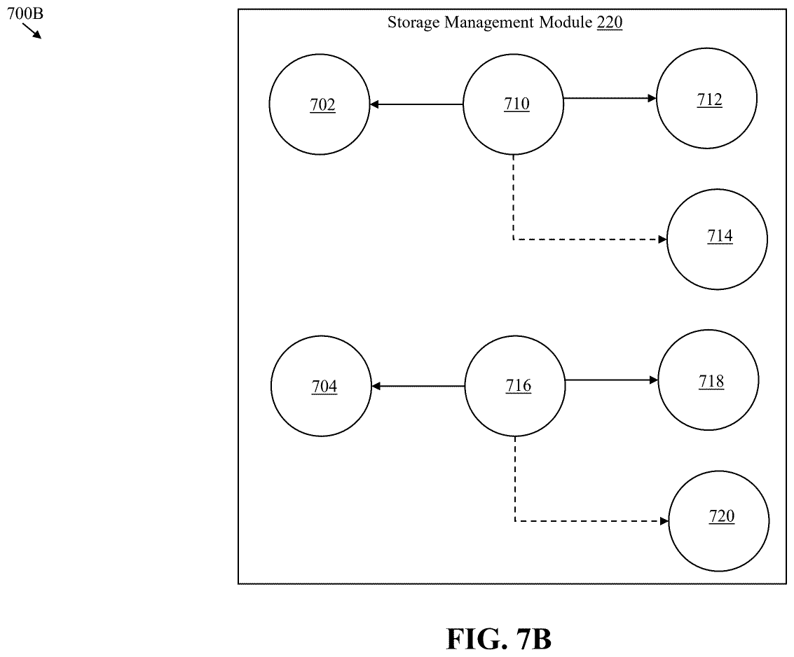

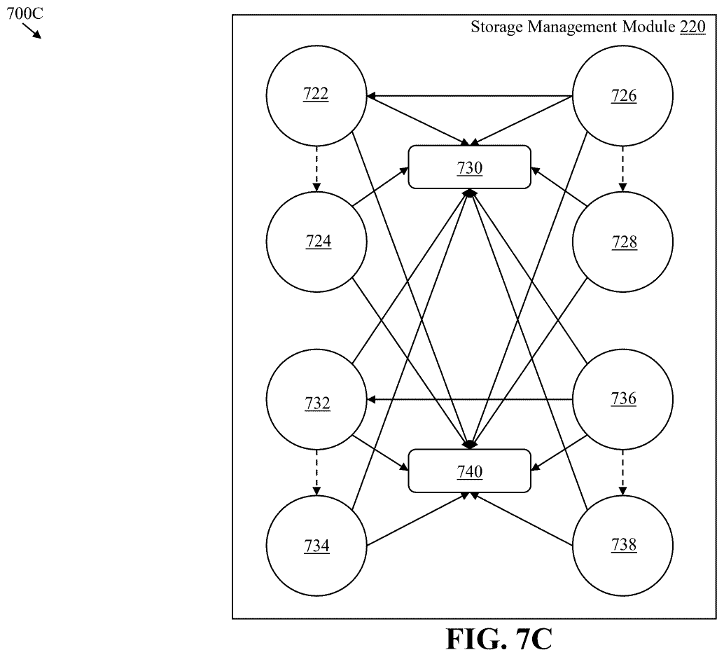

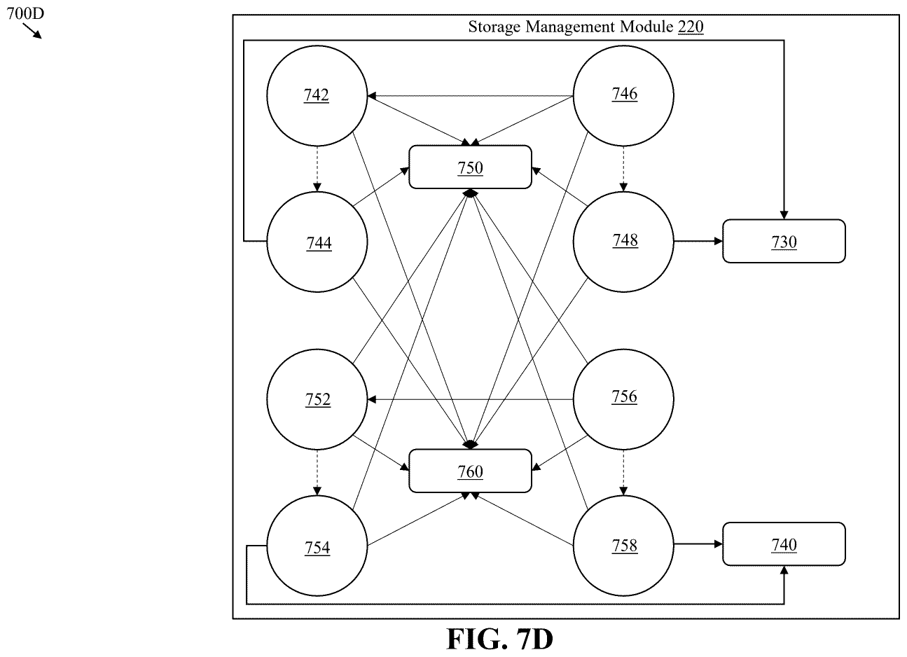

To summarize, FIG. 6 describes an operation associated with stimulus processing using the run-time bi-directional nodes in the executable graph-based model 100. As mentioned earlier, prior to execution of the operation associated with the stimulus, relevant nodes may be required to be loaded in the executable graph-based model 100. FIGS. 7A-7D, collectively, illustrates a process of loading of run-time bi-directional nodes required for processing of the stimulus (for example, the stimulus 230).

FIGS. 7A-7D are block diagrams 700A-700D that, collectively, illustrate a process of loading run-time bi-directional nodes, consistent with disclosed embodiments of the present disclosure. Referring to FIG. 7A, shown may be run-time bi-directional nodes 702 and 704 coupled by way of a run-time connection link 706 that enables the run-time bi-directional node 702 to transmit messages to the run-time bi-directional node 704. The run-time bi-directional nodes 702 and 704 may be further associated with a run-time connection link 708 that enables the run-time bi-directional node 704 to transmit messages to the run-time bi-directional node 702. In an instance, when the run-time bi-directional nodes 702 and 704 may not be used by the processing circuitry (for example, the controller module 206 and the transaction module 208) for any operation associated with the overlay system 202, the run-time bi-directional nodes 702 and 704 may be unloaded from the executable graph-based model 100. In a subsequent instance, the processing circuitry (for example, the controller module 206 and the transaction module 208) may require to use the run-time bi-directional node 702. Therefore, the processing circuitry (for example, the memory management module 218 and the storage management module 220) may load the run-time bi-directional node 702. Based on the association with the run-time bi-directional node 702, the run-time bi-directional node 704 may also be loaded in the executable graph-based model 100.

Referring to FIG. 7B, shown is the storage management module 220 of the overlay system 202 that along with the processing circuitry (for example, the controller module 206 and the transaction module 208 and the memory management module 218) manages storage, loading, and unloading of the run-time bi-directional nodes of the executable graph-based model 100. As shown, the run-time bi-directional node 702 has a manifest 710 that may be used to re-generate the run-time bi-directional node 702. The manifest 710 is associated with a manifest template 712 and a manifest instance 714 that may be required to be accessed to re-construct the manifest 710. Similarly, the run-time bi-directional node 704 has a manifest 716 that may be used to re-generate the run-time bi-directional node 704. The manifest 716 is associated with a manifest template 718 and a manifest instance 720 that may be required to be accessed to re-construct the manifest 716. The manifests 710 and 716 point towards node template, node instance, and one or more overlays, associated with the run-time bi-directional nodes 702 and 704, respectively. To summarize, while loading a run-time node an associated run-time node manifest is accessed first, and subsequently manifests of associated overlays, node template, and node instance may be accessed which leads to the loading of the run-time node as explained in conjunction with FIG. 5.

Referring now to FIG. 7C, as shown, a node template 722 of the run-time bi-directional node 702 has a run-time bi-directional node state template 724. The run-time bi-directional node state template 724 has a run-time bi-directional node manifest template 726 that has a run-time bi-directional node manifest state template 728. The run-time bi-directional node state template 724 has a description that is similar to the second state 506 of the base node 302 of FIG. 5. The run-time bi-directional node manifest template 726 has a description that is similar to the second manifest 516 of FIG. 5. The run-time bi-directional node manifest state template 728 has a description that is similar to the description of the manifest state of the second manifest 516 of FIG. 5. In addition, the node template 722, the run-time bi-directional node state template 724, the run-time bi-directional node manifest template 726, and the run-time bi-directional node manifest state template 728 may be associated with an identifier 730.

Similarly, a node template 732 of the run-time bi-directional node 704 has a run-time bi-directional node state template 734. The run-time bi-directional node state template 734 has a run-time bi-directional node manifest template 736 that has a run-time bi-directional node manifest state template 738. The run-time bi-directional node state template 734 has a description that is similar to the second state 506 of the base node 302 of FIG. 5. The run-time bi-directional node manifest template 736 has a description that is similar to the second manifest 516 of FIG. 5. The run-time bi-directional node manifest state template 738 has a description that is similar to the description of the manifest state of the second manifest 516 of FIG. 5. In addition, the node template 732, the run-time bi-directional node state template 734, the run-time bi-directional node manifest template 736, and the run-time bi-directional node manifest state template 738 may be associated with an identifier 740.

Notably, the node template 722, the run-time bi-directional node state template 724, the run-time bi-directional node manifest template 726, and the run-time bi-directional node manifest state template 728 may be associated with the identifier 740. In addition, the node template 732, the run-time bi-directional node state template 734, the run-time bi-directional node manifest template 736, and the run-time bi-directional node manifest state template 738 may be associated with the identifier 730.

It will be apparent to a person skilled in the art that a node template of a run-time bi-directional node may be loaded in a manner that is similar to the loading of the base node 302. Notably, node templates associated with overlay nodes are loaded in a manner that is similar to the loading of the executable generic run-time node 402.

While loading the node template 722 of the run-time bi-directional node 702, the processing circuitry (for example, the memory management module 218 and the storage management module 220) may determine the identifier 740 associated with the node template 732 of the run-time bi-directional node 704. Based on the determination of the identifier 740, the processing circuitry (for example, the memory management module 218 and the storage management module 220) may further load the node template 732 of the run-time bi-directional node 704 in a manner that is similar to the loading of the base node 302. Similarly, in other embodiments, while loading the node template 732 of the run-time bi-directional node 704, the processing circuitry (for example, the memory management module 218 and the storage management module 220) may load the node template 722 of the run-time bi-directional node 702.

Referring now to FIG. 7D, as shown, a node instance 742 of the run-time bi-directional node 702 has a run-time bi-directional node state instance 744. The run-time bi-directional node state instance 744 has a run-time bi-directional node manifest instance 746 that has a run-time bi-directional node manifest state instance 748. The run-time bi-directional node state instance 744 has a description that is similar to the second state 506 of the base node 302 of FIG. 5. The run-time bi-directional node manifest instance 746 has a description that is similar to the second manifest 516 of FIG. 5. The run-time bi-directional node manifest state instance 748 has a description that is similar to the description of the manifest state of the second manifest 516 of FIG. 5. In addition, the node instance 742, the run-time bi-directional node state instance 744, the run-time bi-directional node manifest instance 746, and the run-time bi-directional node manifest state instance 748 may be associated with an identifier 750.

Similarly, a node instance 752 of the run-time bi-directional node 704 has a run-time bi-directional node state instance 754. The run-time bi-directional node state instance 754 has a run-time bi-directional node manifest instance 756 that has a run-time bi-directional node manifest state instance 758. The run-time bi-directional node state instance 754 has a description that is similar to the second state 506 of the base node 302 of FIG. 5. The run-time bi-directional node manifest instance 756 has a description that is similar to the second manifest 516 of FIG. 5. The run-time bi-directional node manifest state instance 758 has a description that is similar to the description of the manifest state of the second manifest 516 of FIG. 5. In addition, the node instance 752, the run-time bi-directional node state instance 754, the run-time bi-directional node manifest instance 756, and the run-time bi-directional node manifest state instance 758 may be associated with an identifier 760.

Notably, the node instance 752, the run-time bi-directional node state instance 754, the run-time bi-directional node manifest instance 756, and the run-time bi-directional node manifest state instance 758 may be associated with the identifier 750. In addition, the node instance 742, the run-time bi-directional node state instance 744, the run-time bi-directional node manifest instance 746, and the run-time bi-directional manifest state instance 748 may be associated with the identifier 760.

Further, the run-time bi-directional node state instance 744 and the run-time bi-directional manifest state instance 748 may be associated with the identifier 730 of the node template 722. Similarly, the run-time bi-directional node state instance 754 and the run-time bi-directional manifest state instance 758 may be associated with the identifier 740 of the node template 732. Therefore, while loading the node instances 742 and 752 of the run-time bi-directional nodes 702 and 704, the node templates 722 and 732, respectively, may also be loaded. For example, based on a stimulus, the run-time bi-directional node 704 may have to be loaded. While loading the node instance 742, a reference to the node template 722 is determined based on the association of the identifier 730 with the run-time bi-directional node state instance 744 and the run-time bi-directional node manifest state instance 748. Based on the reference, the node template 722 may be loaded and subsequently, the node instance 742 may be loaded. The loading of the node template 722 and the node instance 742 results in the loading of the run-time bi-directional node 702. Further, the node template 722 may be associated with the identifier 740 of the node template 732 and the node instance 742 may be associated with the identifier 760 of the node instance 752. Therefore, based on the association, the node template 732 may be loaded while loading the node template 722. Similarly, the node instance 752 may be loaded while loading the node instance 742. Hence, the loading of the run-time bi-directional node 702 results in the loading of the run-time bi-directional node 704.

It will be apparent to a person skilled in the art that a node instance of a run-time bi-directional node may be loaded in a manner that is similar to the loading of the base node 302. Notably, node instances associated with overlay nodes may be loaded in a manner that is similar to the loading of the executable generic run-time node 402.

To summarize, based on reception of a stimulus associated with the run-time bi-directional node 702, the run-time bi-directional nodes 702 and 704, the run-time connection link 706, and overlay nodes associated with them may be loaded.

It will be apparent to a person skilled in the art that based on the run-time connection link 708 connecting the run-time bi-directional node 704 to the run-time bi-directional node 702, the run-time bi-directional node 702 may be loaded in an instance when the run-time bi-directional node 704 may be loaded.

In some embodiments, a run-time bi-directional node may inherit data and processing logic associated with one or more generic run-time nodes or one or more run-time bi-directional nodes. Based on the loading of the run-time bi-directional node, the one or more generic run-time nodes or one or more run-time bi-directional nodes may also be loaded.

In some embodiments, a run-time bi-directional node may have a dependency with one or more generic run-time nodes or the one or more run-time bi-directional nodes. Based on the loading of the run-time bi-directional node, the one or more generic run-time nodes or one or more run-time bi-directional nodes may also be loaded.

In some embodiments, a run-time bi-directional node may be associated with a run-time bi-directional overlay node via a run-time connection link. Based on the loading of the run-time bi-directional node, the run-time bi-directional overlay node may also be loaded.

In some embodiments, when the execution of the stimulus processing of the stimulus may be completed, the run-time bi-directional nodes 702 and 704, the run-time connection link 706, and overlay nodes associated therewith may be unloaded.

In some embodiments, a run-time bi-directional node may inherit data and processing logic associated with one or more generic run-time nodes or one or more run-time bi-directional nodes. Based on an unloading of the run-time bi-directional node, the one or more generic run-time nodes or one or more run-time bi-directional nodes may also be unloaded.

In some embodiments, a run-time bi-directional node may have a dependency with one or more generic run-time nodes or the one or more run-time bi-directional nodes. Based on an unloading of the run-time bi-directional node, the one or more generic run-time nodes or one or more run-time bi-directional nodes may also be unloaded.

In some embodiments, a run-time bi-directional node may be associated with a run-time bi-directional overlay node via a run-time connection link. Based on an unloading of the run-time bi-directional node, the run-time bi-directional overlay node may also be unloaded.

In some embodiments, the run-time bi-directional node 702 may have the share-shared dependency with the run-time bi-directional node 704. The run-time bi-directional node 704 may have a list with entries of run-time bi-directional nodes currently using data and processing logic associated therewith. In such embodiments, in case a count of entries in the list is non-zero, the run-time bi-directional node 704 may not be unloaded based on an unloading of the run-time bi-directional node 702.

Having discussed the primary features of run-time bi-directional nodes, the description now moves towards the discussion of additional features associated with the run-time bi-directional nodes in the executable graph-based model 100.

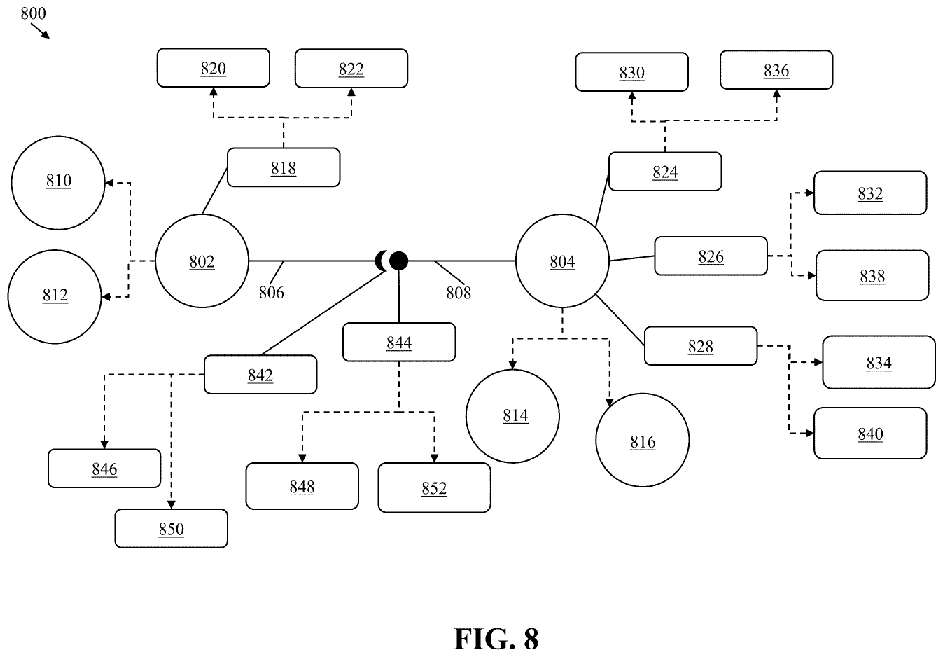

FIG. 8 is a block diagram 800 that illustrates an exemplary scenario of associations among run-time bi-directional nodes, consistent with disclosed embodiments of the present disclosure. As shown, a run-time bi-directional node 802 may be associated with another run-time bi-directional node 804 by way of a run-time connection link including an OCO 806 and an ICO 808. The OCO 806 may be associated with the run-time bi-directional node 802 and the ICO 808 may be associated with the run-time bi-directional node 804. The run-time bi-directional node 802 may include a node template 810 and a node instance 812. Similarly, the run-time bi-directional node 804 may include a node template 814 and a node instance 816.

Each of the run-time bi-directional nodes 802 and 804 may have corresponding attributes. As described in conjunction with FIGS. 3A and 3B each attribute may be realized by way of the corresponding attribute template and attribute instance. As shown, the run-time bi-directional node 802 may have an attribute 818 having an attribute template 820 and an attribute instance 822. Similarly, the run-time bi-directional node 804 may have attributes 824, 826, and 828. The attributes 824, 826, and 828 may include node templates 830, 832, and 834 and node instances 836, 838, and 840, respectively.

Moreover, the association of the OCO 806 with the run-time bi-directional node 802 and the association of the ICO 808 with the run-time bi-directional node 804 allows the run-time bi-directional node 802 to communicate messages (for example, signals, instructions, commands, queries, events, or the like) to the run-time bi-directional node 804. Further, the OCO 806 may be associated with an identifier ‘B’ of the run-time bi-directional node 804 whereas the ICO 808 may be associated with an identifier ‘A’ of the run-time bi-directional node 802. Further, the OCO 806 may include an indicator ‘OUT’ indicative of a direction of flow of communication between the run-time bi-directional nodes 802 and 804. Similarly, the ICO 808 may also include an indicator ‘IN’ indicative of a direction of flow of communication between the run-time bi-directional nodes 802 and 804. In other words, the OCO 806 may include the indicator ‘OUT’ indicative of a direction of flow of messages passing via the OCO 806 being outward. Similarly, the ICO 808 may include the indicator ‘IN’ indicative of a direction of flow of messages passing via the ICO 808 being inward. Additionally, the OCO 806 may also include a dependency indicator ‘OWN’ while the ICO 808 may include another dependency indicator ‘OWNED’. The dependency indicators ‘OWN’ and ‘OWNED’ may collectively indicate a dependency between the run-time bi-directional nodes being the own-owned dependency.

In some embodiments, the run-time connection link including the OCO 806 and the ICO 808 may further include a set of attributes including attributes 842 and 844. The set of attributes may be indicative of a loading strategy associated with the run-time bi-directional node 802 and/or the run-time bi-directional node 804. In an instance, the attribute 842 may be associated with the OCO 806 and may be indicative of the loading strategy of the run-time bi-directional node 802. Similarly, the attribute 844 may be associated with the ICO 808 and may be indicative of the loading strategy of the run-time bi-directional node 804. The loading strategy may be an eager loading strategy or a lazy loading strategy. When loaded using the eager loading strategy, a run-time bi-directional node may be loaded proactively and hence may be loaded prior to a time instance of its use. When loaded using the lazy loading strategy, the loading of a run-time bi-directional node may be deferred until a time instance of its use. In other words, the run-time bi-directional node when loaded using the lazy loading strategy may be loaded based on a requirement thereof. The set of attributes may be accessed by the processing circuitry (for example, the memory management module 218 and the storage management module 220) of the overlay system 202 while processing manifests of the run-time bi-directional nodes.

The run-time connection link including the OCO 806 and the ICO 808 may be implemented as a run-time bi-directional node with role node-type. Hence, the attributes 842 and 844 include node templates 846 and 848 and node instances 850 and 852, respectively.

Although, the run-time bi-directional nodes 802 and 804 may be shown to include node templates 810 and 814, respectively, in other embodiments, the run-time bi-directional nodes 802 and 804 may have a common/shared node template. In such an embodiment, the node instances 812 and 816 of the run-time bi-directional nodes 802 and 804, respectively, may be the implementation of the common/shared node template.

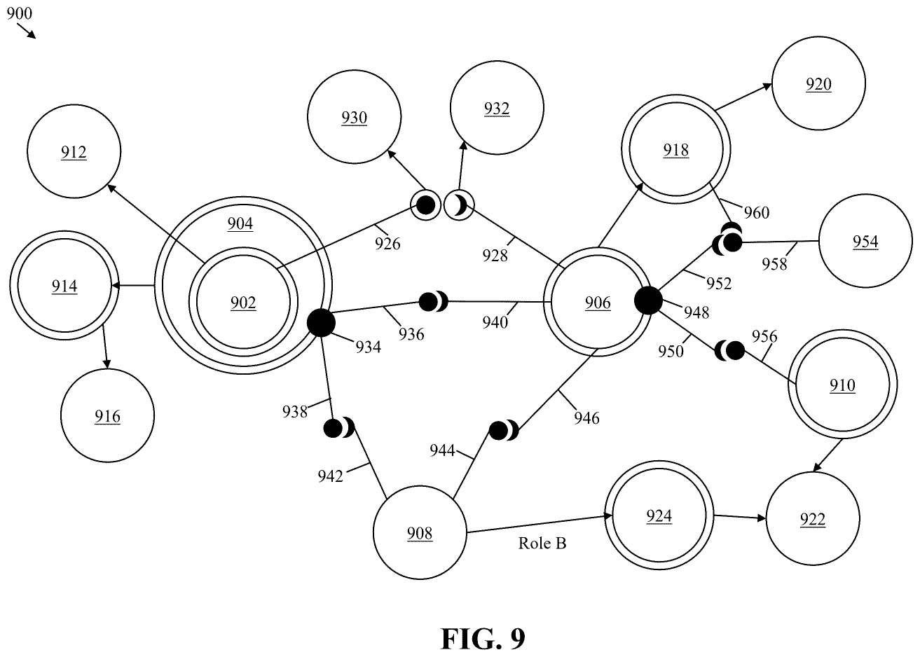

FIG. 8 briefly describes the coupling between run-time bi-directional nodes. Additional features and embodiments associated with the coupling between run-time bi-directional nodes are described in detail in conjunction with FIG. 9.

FIG. 9 illustrates a block diagram 900 that depicts a plurality of bi-directional nodes in the executable graph-based model, consistent with disclosed embodiments of the present disclosure. Referring to FIG. 9, shown may be run-time bi-directional nodes 902 through 910.

As shown, the run-time bi-directional node 902 (hereinafter, the executable run-time bi-directional node 902) is extended by way of a generic run-time overlay node 912 whereas the run-time bi-directional node 904 (hereinafter, the executable run-time bi-directional node 904) is extended by way of other generic run-time overlay node 914 that is further extended by way of a generic run-time overlay node 916. Such association of one run-time overlay node with another run-time overlay node is termed as cascading of run-time overlays. The executable run-time bi-directional node 902 is shown to be enclosed within the executable run-time bi-directional node 904. This indicates that the executable run-time bi-directional node 904 inherits the executable run-time bi-directional node 902. Therefore, data and processing logic associated with the executable run-time bi-directional node 902 and the overlay nodes (for example, the generic run-time overlay node 912) of the executable run-time bi-directional node 902 may be inherited by the executable run-time bi-directional node 904. In addition, dependency, inherited data and processing logic, and associations with other nodes, of the executable run-time bi-directional node 902 may be also inherited by the executable run-time bi-directional node 904.

The run-time bi-directional node 906 (hereinafter, the executable run-time bi-directional node 906) is extended by way of a run-time bi-directional overlay node 918 that is further extended by way of an overlay node 920. The overlay node 920 may be a generic run-time overlay node or a run-time bi-directional overlay node The run-time bi-directional node 910 (hereinafter, the executable run-time bi-directional node 910) is shown to be extended by way of a generic run-time overlay node 922. The executable graph-based model 100 further depicts a generic run-time node 924 (namely, an executable generic run-time node 924) that is extended by way of the generic run-time overlay node 922. As shown, the generic run-time overlay node 922 is being shared by the executable run-time bi-directional node 910 and the executable generic run-time node 924.

The executable run-time bi-directional node 902 may be associated with the executable run-time bi-directional node 906 by way of a run-time connection link that may include an ICO 926 and an OCO 928. The ICO 926 is coupled with the executable run-time bi-directional node 902 and the OCO 928 is coupled with the executable run-time bi-directional node 906. Notably, an ICO is associated with a first dependency indicator, a first communication direction, and a first node identifier of a node from which an associated run-time bi-directional node may receive one or more messages. Similarly, an OCO is associated with a second dependency indicator, a second communication direction, and a second node identifier of a run-time bi-directional node to which an associated run-time bi-directional node may communicate one or more messages. The first and second dependency indicators may, collectively, indicate a dependency between run-time bi-directional nodes associated with the ICO and OCO. The first communication direction and the second communication direction may, collectively, indicate a direction of flow of transmission of messages between the run-time bi-directional nodes associated with the ICO and OCO. The ICO 926 is associated with a first dependency indicator ‘SHARED’, a first communication direction ‘IN’, and a first node identifier of the executable run-time bi-directional node 906. The OCO 928 is associated with a second dependency indicator ‘SHARE’, a second communication direction ‘OUT’, and a second node identifier of the executable run-time bi-directional node 902. The first and second dependency indicators ‘SHARED’ and ‘SHARE’, respectively, indicate that a dependency between the executable run-time bi-directional nodes 902 and 906 is the share-shared dependency. The first and second communication directions are, collectively, indicative of the direction of flow of transmission of messages between the executable run-time bi-directional nodes 902 and 906 being from the executable run-time bi-directional node 906 to the executable run-time bi-directional node 902. The first and second node identifiers indicate that the executable run-time bi-directional nodes 902 and 906 associated with the ICO 926 and OCO 928, respectively, communicate with each other. This is indicative of the executable run-time bi-directional node 906 being able to transmit messages (for example, commands, events, queries, signals, instructions, or the like) to the executable run-time bi-directional node 902. Moreover, the run-time connection link between the executable run-time bi-directional nodes 902 and 906 is implemented as a run-time bi-directional node with role node-type. Therefore, the ICO 926 is extended by way of a generic run-time overlay node 930 and the OCO 928 is extended by way of a run-time bi-directional overlay node 932.

In an instance, a message is communicated by the executable run-time bi-directional node 906 to the executable run-time bi-directional node 902. In such an instance, the message is generated by the executable run-time bi-directional node 906 and transmitted to the executable run-time bi-directional node 902 by way of the OCO 928 and the ICO 926. The message transmitted by the executable run-time bi-directional node 906 passes through the OCO 928, where processing logic associated with the run-time bi-directional overlay node 932 is executed on the message. Subsequently, the message passes through the ICO 926, where processing logic associated with the generic run-time overlay node 930 is executed on the message. Subsequently, the message is received by the executable run-time bi-directional node 902, where processing logic associated with the generic run-time overlay node 912 is executed on the message.

As shown, the executable run-time bi-directional node 904 may be associated with the executable run-time bi-directional node 906 and the run-time bi-directional node 909 via an inward group object 934. Further, ICOs 936 and 938 converge at the inward group object 934. In an embodiment, when an overlay node may be associated with the inward group object 934, processing logic associated with the inward group object 934 may be executed either collectively on inputs received from the executable run-time bi-directional node 906 and the run-time bi-directional node 909 or separately on an input received from each of the executable run-time bi-directional nodes 906 and the run-time bi-directional node 909.

The executable run-time bi-directional node 904 may be associated with the executable run-time bi-directional node 906 by way of a run-time connection link that may include the ICO 936 and an OCO 940. The ICO 936 is coupled with the executable run-time bi-directional node 904 and the OCO 940 is coupled with the executable run-time bi-directional node 906.

The ICO 936 is associated with a first dependency indicator ‘SHARED’, a first communication direction ‘IN’, and a first node identifier of the executable run-time bi-directional node 906. Further, the OCO 940 is associated with a second dependency indicator ‘SHARE’, a communication direction ‘OUT’, and a second node identifier of the executable run-time bi-directional node 904. The first and second dependency indicators ‘SHARED’ and ‘SHARE’, respectively, indicate that a dependency between the executable run-time bi-directional nodes 904 and 906 is the share-shared dependency. The first and second communication directions are, collectively, indicative of the direction of flow of transmission of messages between the executable run-time bi-directional nodes 906 and 904 being from the executable run-time bi-directional node 906 to the executable run-time bi-directional node 904. The first and second node identifiers indicate that the executable run-time bi-directional nodes 904 and 906 associated with the ICO 936 and OCO 940, respectively, communicate with each other. This indicates that the executable run-time bi-directional node 906 can transmit messages (for example, commands, events, queries, signals, instructions, or the like) to the executable run-time bi-directional node 904. Moreover, the run-time connection link between the executable run-time bi-directional nodes 904 and 906 is implemented as a non-node structure of the executable graph-based model 100. Hence, the ICO 936 and the OCO 940 may not be extended by way of an overlay node.

The executable run-time bi-directional node 904 is further associated with the run-time bi-directional node 908 by way of a run-time connection link that may include the ICO 938 and an OCO 942. The ICO 938 is coupled with the executable run-time bi-directional node 904 and the OCO 942 is coupled with the run-time bi-directional node 908. The ICO 938 may be associated with a dependency indicator ‘SHARED’ that is indicative of a dependency between the executable run-time bi-directional node 904 and the run-time bi-directional node 908. The ICO 938 is further associated with a communication direction ‘IN’ that is indicative of a direction of flow of a transaction associated with transmission of a message between the executable run-time bi-directional node 904 and the run-time bi-directional node 908. Further, the OCO 942 may be associated with a dependency indicator ‘SHARED’ that is indicative of the dependency between the executable run-time bi-directional node 904 and the run-time bi-directional node 908. This is indicative of a dependency between the executable run-time bi-directional node 904 and the run-time bi-directional node 908 being the share-shared dependency. The OCO 942 is further associated with a communication direction ‘OUT’ that is indicative of the direction of flow of the transaction associated with the transmission of the message between the executable run-time bi-directional node 904 and the run-time bi-directional node 909. The OCO 942 is also associated with a node identifier associated with the executable run-time bi-directional node 904 to which the run-time bi-directional node 908 may transmit messages using the run-time connection link including the ICO 938 and the OCO 942. This is indicative of the run-time bi-directional node 909 being able to transmit messages (for example, commands, events, queries, signals, instructions, or the like) to the executable run-time bi-directional node 904. Moreover, the run-time connection link between the executable run-time bi-directional nodes 904 and 908 is implemented as a non-node structure of the executable graph-based model 100. Hence, the ICO 938 and the OCO 942 may not be extended by way of an overlay node.

The run-time bi-directional node 908 is further associated with the executable run-time bi-directional node 906 by way of a run-time connection link that may include an ICO 944 and an OCO 946. The ICO 944 is coupled with the run-time bi-directional node 908 and the OCO 946 is coupled with the executable run-time bi-directional node 906. The ICO 944 may be associated with a dependency indicator ‘USED’ that is indicative of a dependency between the executable run-time bi-directional node 906 and the run-time bi-directional node 909. The ICO 944 is further associated with a communication direction ‘IN’ that is indicative of a direction of flow of a transaction associated with transmission of a message between the executable run-time bi-directional node 906 and the run-time bi-directional node 908. The ICO 944 is also associated with a node identifier associated with the executable run-time bi-directional node 906 from which the run-time bi-directional node 908 may receive messages using the run-time connection link including the ICO 944 and the OCO 946. Further, the ICO 944 may be associated with a dependency indicator ‘USED’ and the OCO 946 may be associated with a dependency indicator ‘USE’ that is indicative of the dependency between the executable run-time bi-directional node 906 and the run-time bi-directional node 908 being the use-used dependency. The ICO 944 is further associated with a communication direction ‘IN’ that is indicative of the direction of flow of the transaction associated with the transmission of the message between the executable run-time bi-directional node 906 and the run-time bi-directional node 908. The OCO 946 is also associated with a node identifier associated with the run-time bi-directional node 908 to which the run-time bi-directional node 908 may transmit messages using the run-time connection link including the ICO 944 and the OCO 946. This is indicative of the executable run-time bi-directional node 906 being able to transmit messages (for example, commands, events, queries, signals, instructions, or the like) to the run-time bi-directional node 908. Moreover, the run-time connection link between the executable run-time bi-directional nodes 906 and 908 is implemented as run-time bi-directional nodes with role node-type. Hence, in other embodiments, the ICO 944 and the OCO 946 may be extended by way of one or more overlay nodes.

The run-time bi-directional node 908 is further associated with the executable generic run-time node 924 by way of a role (for example, Role B). The run-time bi-directional node 908 with the edge node-type may be directly associated with the executable generic run-time node 924 by way of the role A. Consequently, the run-time bi-directional node 908 may directly communicate with the generic run-time node 924 without requiring a connecting link therebetween. As the executable generic run-time node 924 is extended by way of the generic run-time overlay node 922, a message received by the executable generic run-time node 924 from the run-time bi-directional node 908 may be modified based on an execution of processing logic associated with the generic run-time overlay node 922.

As shown, the executable run-time bi-directional node 906 has an outward group object 948 from which OCOs 950 and 952 of run-time connection links that couple the executable run-time bi-directional node 906 with the executable run-time bi-directional node 910 and the run-time bi-directional overlay node 954, respectively. The executable run-time bi-directional node 906 is further associated with the executable run-time bi-directional node 910 by way of a run-time connection link that may include the OCO 950 and an ICO 956. The ICO 956 is coupled with the executable run-time bi-directional node 910 and the OCO 950 is coupled with the run-time bi-directional node 906. The ICO 956 may be associated with a dependency indicator ‘OWNED’ that is indicative of a dependency between the executable run-time bi-directional nodes 906 and 910. The ICO 956 is further associated with a communication direction ‘IN’ that is indicative of a direction of flow of a transaction associated with transmission of a message between the executable run-time bi-directional nodes 906 and 910. Further, the OCO 950 may be associated with a dependency indicator ‘OWN’ that is indicative of the dependency between the executable run-time bi-directional nodes 906 and 910. This is indicative of a dependency between the executable run-time bi-directional nodes 906 and 910 being own-owned dependency such that the executable run-time bi-directional node 906 owns the executable run-time bi-directional node 910. The OCO 950 is further associated with a communication direction ‘OUT’ that is indicative of the direction of flow of the transaction associated with the transmission of the message between the executable run-time bi-directional nodes 906 and 910. The OCO 950 is also associated with a node identifier associated with the executable run-time bi-directional node 910 to which the executable run-time bi-directional node 906 may transmit messages using the run-time connection link including the ICO 956 and the OCO 950. This is indicative of the executable run-time bi-directional node 906 being able to transmit messages (for example, commands, events, queries, signals, instructions, or the like) to the executable run-time bi-directional node 910. Moreover, the run-time connection link between the executable run-time bi-directional nodes 906 and 910 is implemented as a non-node structure of the executable graph-based model 100. Hence, the ICO 956 and the OCO 950 may not be extended by way of one or more overlay nodes.

The executable run-time bi-directional node 906 is further associated with the run-time bi-directional overlay node 954 by way of a run-time connection link that may include the OCO 952 and an ICO 958. As shown, the OCO 952 is coupled with the run-time bi-directional node 906 and the ICO 958 is coupled with the run-time bi-directional overlay node 954. The ICO 958 may be associated with a dependency indicator ‘SHARED’ that is indicative of a dependency between the executable run-time bi-directional node 906 and the run-time bi-directional overlay node 954. The ICO 958 is further associated with a communication direction ‘IN’ that is indicative of a direction of flow of a transaction associated with transmission of a message between the executable run-time bi-directional node 906 and the run-time bi-directional overlay node 954. Further, the OCO 952 may be associated with a dependency indicator ‘SHARED’ that is indicative of the dependency between the executable run-time bi-directional node 906 and the run-time bi-directional overlay node 954. This is indicative of a dependency between the executable run-time bi-directional node 906 and the run-time bi-directional overlay node 954 being share-shared dependency such that the executable run-time bi-directional node 906 uses the run-time bi-directional overlay node 954 while sharing with one or more other run-time bi-directional nodes (for example, the run-time bi-directional overlay node 918). The OCO 952 is further associated with a communication direction ‘OUT’ that is indicative of the direction of flow of the transaction associated with the transmission of the message between the executable run-time bi-directional node 906 and the run-time bi-directional overlay node 954. The OCO 952 is also associated with a node identifier associated with the run-time bi-directional overlay node 954 to which the executable run-time bi-directional node 906 may transmit messages using the run-time connection link including the ICO 958 and the OCO 952. This is indicative of the executable run-time bi-directional node 906 can transmit messages (for example, commands, events, queries, signals, instructions, or the like) to the run-time bi-directional overlay node 954 in order to access processing logic associated therewith.

The run-time bi-directional overlay node 954 is further associated with the run-time bi-directional overlay node 918 by way of a run-time connection link that may include the ICO 958 and an OCO 960. The OCO 960 may be associated with a dependency indicator ‘SHARED’ that is indicative of the dependency between the run-time bi-directional overlay nodes 918 and 954. This is indicative of a dependency between the run-time bi-directional overlay nodes 918 and 954 being share-shared dependency such that the run-time bi-directional overlay node 918 may share the run-time bi-directional overlay node 954 with the executable run-time bi-directional node 906. The OCO 960 is further associated with a communication direction ‘OUT’ that is indicative of the direction of flow of the transaction associated with the transmission of the message between the run-time bi-directional overlay nodes 918 and 954. The OCO 960 is also associated with a node identifier associated with the run-time bi-directional overlay node 954 to which the run-time bi-directional overlay node 918 may transmit messages using the run-time connection link including the ICO 958 and the OCO 960.

FIG. 9 shows that the ICO 958 is a part of two run-time connection links (for example, the run-time connection link coupling the executable run-time bi-directional node 906 and the run-time bi-directional overlay node 954 and the run-time connection link coupling the run-time bi-directional overlay nodes 918 and 954. It will be appreciated by a person skilled in the art that an OCO may also be part of two or more run-time connection links in a similar manner.

It will be appreciated by a person skilled in the art that although FIG. 9 depicts run-time bi-directional nodes, identical networks of corresponding node templates and corresponding node instances may also exist in the executable graph-based model 100.

It will be apparent to a person skilled in the art that each run-time bi-directional node and/or generic run-time node shown in FIG. 9 may be identified by the processing circuitry (for example, the controller module 206 and the transaction module 208) prior to utilization thereof. The processing circuitry (for example, the controller module 206 and the transaction module 208) may identify each run-time bi-directional node and/or generic run-time node based on a stimulus or a connection link associated therewith. Additionally, the processing circuitry (for example, the controller module 206 and the transaction module 208) may be configured to identify one or more run-time bi-directional overlay nodes and one or more generic run-time overlay nodes associated with run-time bi-directional nodes, generic run-time nodes, ICOs, OCOs, inward group objects, and outward group objects, depicted in FIG. 9, prior to its utilization.

To summarize, FIG. 9 describes various features of the executable graph-based model 100 including generic run-time nodes and run-time bi-directional nodes. The description now moves towards a mathematical implementation of the features of the run-time bi-directional nodes.

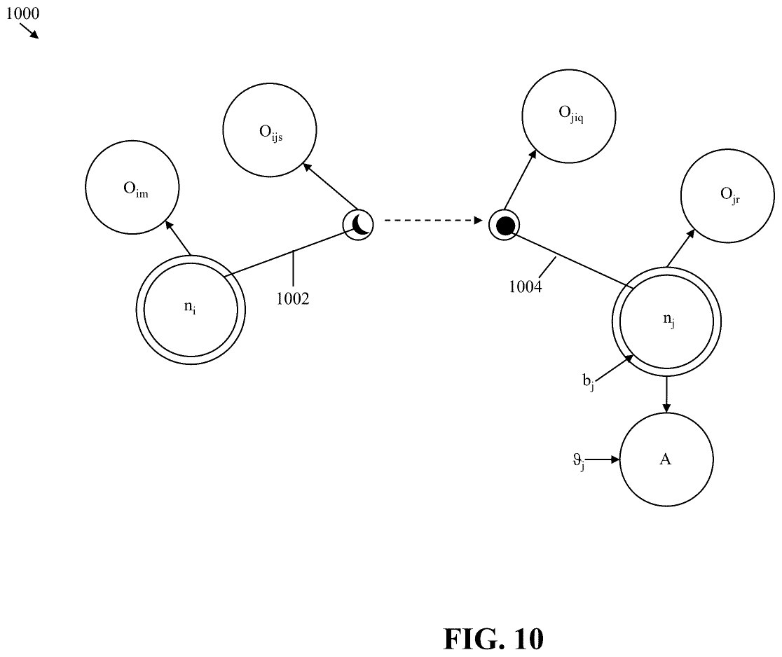

FIG. 10 illustrates a block diagram that depicts a mathematical representation of a neural network model 1000 that is implemented by way of the executable graph-based model 100, consistent with disclosed embodiments of the present disclosure. Referring to FIG. 10, the neural network model 1000 may include an input layer including an executable run-time bi-directional node nᵢ and an output layer including an executable run-time bi-directional node nⱼ, where ‘i’ is an index of nodes in the input layer and ‘j’ is an index of nodes in the output layer. For the sake of brevity, the executable run-time bi-directional node nᵢ in the input layer is shown to be associated with an OCO 1002. Additionally, the executable run-time bi-directional node nⱼ in the output layer is shown to be associated with an ICO 1004. In other embodiments, the input layer and the output layer may include any number of run-time bi-directional nodes associated with OCOs and/or ICOs without deviating from the scope of the disclosure. Further, the neural network model 1000 may include any number of hidden layers having any number of run-time bi-directional nodes associated with ICOs and/or OCOs without deviating from the scope of the disclosure. As shown, nodes in the input layer may be associated with nodes in the output layer by way of corresponding run-time connection links such that ICOs of the run-time connection links may be associated with the run-time bi-directional nodes in the input layer and the OCOs of the run-time connection link may be associated with the run-time bi-directional nodes in the output layer. Thus, there may be i*j connection pairs between the input layer and the output layer. That is to say that the executable run-time bi-directional node nᵢ may be associated with the executable run-time bi-directional node nⱼ by way of a run-time connection link such that the executable run-time bi-directional node nᵢ may be associated with an ICO 1004 and the executable run-time bi-directional node nⱼ may be associated with an OCO 1002.

Moreover, run-time bi-directional nodes in each layer may be extended by way of one or more overlay nodes (for example, generic overlay node or run-time bi-directional overlay node). For example, the executable run-time bi-directional nodes nᵢ is extended by way of ‘m’ (m>0) overlay nodes Oᵢₘ. Additionally, the executable run-time bi-directional nodes nⱼ is extended by way of ‘r’ (r>0) overlay nodes Oⱼᵣ. The executable run-time bi-directional node nᵢ has the OCO 1002 represented by ncᵢⱼ that forms a connection pair with the ICO 1004 associated with the executable run-time bi-directional node nⱼ and represented by ncⱼᵢ. The OCO 1002 has Oᵢⱼₛ overlay nodes associated therewith and the ICO 1004 O_{jiq} overlay nodes associated therewith.

Notably, processing logic associated with an overlay node of an executable run-time bi-directional node is executed on messages going to any node associated with the executable run-time bi-directional node. On the contrary, processing logic associated with an ICO or an OCO associated with a run-time bi-directional node is executed only on messages passing via the said ICO or OCO.

In operation, a stimulus (for example, the stimulus 230) may be provided to the executable run-time bi-directional node nᵢ that may generate a signal with an initial state ‘i’ based on the stimulus 230. Further, the processing circuitry (for example, the controller module 206 or the transaction module 208) may execute the processing logic associated with the overlay nodes Oᵢₘ on the signal. Based on the execution, the executable run-time bi-directional nodes nᵢ may generate a first intermediate signal represented by gᵢ(nᵢ), such that

$${g}_{i} ( {n}_{i} ) = ( {O}_{i 1} ∘ {O}_{i 2} ∘ {O}_{i 3} ∘ … {O}_{im} ) ( {n}_{i} ) = ( {O}_{i 1} ( {O}_{i 2} ( {O}_{i 3} ( … ( {O}_{im} ) ( {n}_{i} ) ) ) ) ) \qquad ( 1 )$$

where m is the number of overlays on nᵢ and m>0; otherwise gᵢ(nᵢ)=nᵢ where m=0

The processing logic of the overlay nodes Oᵢₘ may be executed on the signal in an order represented by (1). In other words, the processing logic of the overlay nodes Oᵢₘ may be executed such that processing logic of an overlay node with a higher index is executed prior to processing logic of an overlay node with a lower index number. In some embodiments, the processing logic of overlay nodes may be executed in a direction in the executable graph-based model 100 that follows a bottom-up approach. For example, the executable run-time bi-directional node nᵢ may be associated with a first overlay node that may be further associated with a second overlay node. In such an example, processing logic associated with the second overlay node may be executed prior to the execution of processing logic of the first overlay node.

Subsequently, the first intermediate signal passes through the OCO 1002. At the OCO 1002, the processing circuitry (for example, the controller module 206 or the transaction module 208) may execute processing logic associated with the overlay nodes Oᵢⱼₛ on the first intermediate signal. Based on the execution of the processing logic of the overlay nodes Oᵢⱼₛ on the first intermediate signal, a second intermediate signal represented by Vᵢⱼ may be generated, such that:

$${V}_{ij} = {h}_{ij} ( {g}_{i} ( {n}_{i} ) ) = ( {O}_{ij 1} ∘ {O}_{ij 2} ∘ {O}_{ij 3} ∘ … {O}_{ijs} ) ( {g}_{i} ( {n}_{i} ) ) = ( {O}_{ij 1} ( {O}_{ij 2} ( {O}_{ij 3} ( … ( {O}_{ijs} ) ( {g}_{i} ( {n}_{i} ) ) ) ) ) \qquad ( 2 )$$

where s is the number of overlays on ncᵢⱼ and s>0; otherwise Vᵢⱼ=gᵢ(nᵢ) where s=0.

At the OCO 1002, the processing circuitry (for example, the controller module 206 or the transaction module 208) may execute processing logic associated with the overlay nodes Oᵢⱼₛ in a manner that is similar to the execution of the processing logic associated with the overlay nodes Oᵢₘ. Subsequently, the second intermediate message represented by Vᵢⱼ is communicated to the ICO 1004.

At ICO 1004, the processing circuitry (for example, the controller module 206 or the transaction module 208) may execute processing logic associated with the overlay nodes O_{jiq} on the second intermediate signal. Based on the execution of the processing logic associated with the overlay nodes O_{jiq} a third intermediate signal represented by kⱼᵢ(Vᵢⱼ) is generated such that:

$$( {k}_{ji} ( {V}_{ij} ) ) = ( {O}_{ji 1} ∘ {O}_{ji 2} ∘ {O}_{ji 3} ∘ … {O}_{jiq} ) ( {V}_{ij} ) ) ) = ( {O}_{ji 1} ( {O}_{ji 2} ( {O}_{ji 3} ( … ( {O}_{jiq} ) ( {V}_{ij} ) ) ) ) ) \qquad ( 3 )$$

where q is the number of overlays on ncⱼᵢ and q>0; otherwise, kⱼᵢ(Vᵢⱼ)=Vᵢⱼ where q=0.

Subsequently, the third intermediate signal reaches the executable run-time bi-directional node nⱼ. At the executable run-time bi-directional node nⱼ, the processing circuitry (for example, the controller module 206 or the transaction module 208) may execute processing logic associated with the overlay nodes Oⱼᵣ on the third intermediate signal. Based on the execution of the processing logic associated with the overlay nodes Oⱼᵣ, a fourth intermediate signal represented by Xⱼᵢ is generated such that:

$${X}_{ji} = {l}_{ji} ( {k}_{ji} ( {V}_{ij} ) = ( {O}_{j 1} ∘ {O}_{j 2} ∘ {O}_{j 3} ∘ … ∘ {O}_{jr} ) ( {k}_{ji} ( {V}_{ij} ) ) = ( {O}_{j 1} ( {O}_{j 2} ( {O}_{j 3} ( … ( {O}_{jr} ) ( {k}_{ji} ( {V}_{ij} ) ) ) ) ) ) \qquad ( 4 )$$

where, r is the number of overlays on nⱼ and r>0 otherwise Xⱼᵢ=kⱼᵢ(Vᵢⱼ) where r=0.

Moreover, a weight defined as Wⱼᵢ is provided for the executable run-time bi-directional node nⱼ. Based on the application of the weight Wⱼᵢ on the fourth intermediate signal, a final signal that represents a value of the executable run-time bi-directional node nⱼ is generated, such that:

nⱼ=bⱼ+Σᵢ₌₁XⱼᵢWⱼᵢ, where bⱼ represents a bias.

Subsequently, an activation function A with a threshold ϑⱼ may be used to create the final signal. A final activation value for the executable run-time bi-directional node is:

$${a}_{j} = A ( {n}_{j} )$$

It will be appreciated by a person skilled in the art that the bias weight and the activation function may be applied by way of one or more overlay nodes associated with the executable run-time bi-directional node nⱼ. Beneficially, the use of overlay nodes for the application of processing logic allows for such application to be tied to a context. The execution of the processing logic for modification of the signal may be associated with one or more contexts such that the processing logic is executed based on a match of context of the stimulus 230 with one of the set of defined contexts.

To summarize, the mathematical representation of the neural network model 1000 provides a visual representation of a neural network and mathematical constructs may be derived from the neural network model 1000. Additionally, such representation allows for a direct execution of overlay structure as defined by the executable graph-based model 100.

Having described various concepts associated with the perturbation of signals in the overlay system 202, the description now moves towards a use case scenario associated with the overlay system 202 described herein.

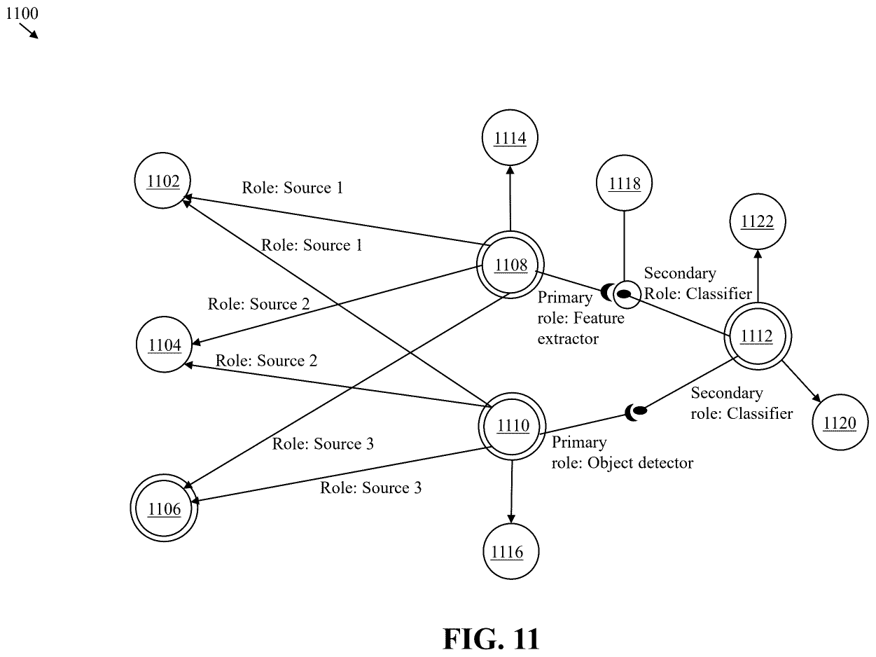

FIG. 11. is a block diagram that illustrates a neural network model 1100 for classification of images, consistent with disclosed embodiments of the present disclosure. Referring to FIG. 11, the neural network model 1000 may include an input layer, a hidden layer, and an output layer. The input layer may include a set of generic run-time nodes 1102, 1104, and 1106, the hidden layer may include a first set of executable run-time bi-directional nodes including executable run-time bi-directional nodes 1108 and 1110, and the output layer may include a second set of executable run-time bi-directional nodes including an executable run-time bi-directional node 1112.

The set of generic run-time nodes 1102, 1104, and 1106 may represent a set of pixels that form an image to be classified in one of a plurality of image classes. Each of the set of generic run-time nodes 1102, 1104, and 1106 may be associated with each of the first set of executable run-time bi-directional nodes by way of a corresponding role. For example, the generic run-time node 1102 may be associated with each of the second set of executable run-time bi-directional nodes by way of a role ‘Source 1’, the generic run-time node 1104 may be associated with each of the second set of executable run-time bi-directional nodes by way of a role ‘Source 2’, and the generic run-time node 1106 may be associated with each of the second set of executable run-time bi-directional nodes by way of a role ‘Source 3’.

The executable run-time bi-directional nodes 1108 and 1110 may acquire the set of pixels from the set of generic run-time nodes 1102, 1104, and 1106. In an example, the executable run-time bi-directional nodes 1108 and 1110 may acquire the set of pixels by executing a PULL operation. In some embodiments, the executable run-time bi-directional nodes 1108 and 1110 may acquire the set of pixels based on the reception of a stimulus to classify an image. In other embodiments, the executable run-time bi-directional nodes 1108 and 1110 may acquire the set of pixels based on a change in pixel values represented by the set of pixels.

The executable run-time bi-directional node 1108 serves as a feature extractor and the executable run-time bi-directional node 1110 serves as an object detector. The feature extractor extracts various features such as contrast, intensity, pixel value, luminosity, or the like associated with the pixels represented by the set of generic run-time nodes. The object detector detects one or more objects depicted in the image formed by the set of pixels. The executable run-time bi-directional nodes 1108 and 1110 may be associated with the executable run-time bi-directional node 1112 by way of a first run-time connection link and a second run-time connection link, respectively. The first run-time connection link may include an OCO indicative of a primary role ‘Feature extractor’ associated with the executable run-time bi-directional node 1108 and an ICO indicative of a secondary role ‘Classifier’ associated with the executable run-time bi-directional node 1112. Any operation using the executable run-time bi-directional node 1108 and the executable run-time bi-directional node 1112 may be executed in conformity with the primary role and the secondary role. The second run-time connection link may include an OCO indicative of a primary role ‘Object detector’ associated with the executable run-time bi-directional node 1110 and an ICO indicative of a secondary role ‘Classifier’ associated with the executable run-time bi-directional node 1112. The executable run-time bi-directional node 1112 serves as a classifier and classifies the image into one or more of the plurality of classes.

In an instance, when the image formed by the set of pixels is to be classified, the processing circuitry (for example, the memory management module 218 and the storage management module 220) may load the set of generic run-time nodes that represent the set of pixels. In addition, the processing circuitry (for example, the memory management module 218 and the storage management module 220) may load the first set of bi-directional nodes that may be required for classifying the image. Further, based on the first run-time connection link coupling the executable run-time bi-directional node 1108 with the executable run-time bi-directional node 1112, the processing circuitry (for example, the memory management module 218 and the storage management module 220) may load the executable run-time bi-directional node 1112. Further, based on the second run-time connection link coupling the executable run-time bi-directional node 1110 with the executable run-time bi-directional node 1112, the processing circuitry (for example, the controller module 206 and the transaction module 208) may determine that the executable run-time bi-directional node 1112 is already loaded in the executable graph-based model 100 and does not require to be loaded again.

Subsequently, pixel values of the set of pixels represented by the set of generic run-time nodes may be provided to each executable run-time bi-directional node of the first set of executable run-time bi-directional nodes. The executable run-time bi-directional node 1108 may be associated with a run-time bi-directional overlay node 1114 which may include processing logic, that when executed on the pixel values received by the executable run-time bi-directional node 1108, extracts various features associated with each of the set of pixels based on pixel values therein. Moreover, the executable run-time bi-directional node 1110 may be associated with a run-time bi-directional overlay node 1116 which may include processing logic, that when executed on the set of pixels received by the executable run-time bi-directional node 1110, identifies, based on the pixel values, one or more objects illustrated in the image.

The executable run-time bi-directional node 1108 may communicate the extracted features to the executable run-time bi-directional node 1112 via the first run-time connection link. As shown, the ICO of the first run-time connection link may be associated with a run-time bi-directional overlay node 1118 that may include a processing logic that when executed on the extracted features, may perform an amplification operation thereon. Additionally, the executable run-time bi-directional node 1010 may communicate the detected objects to the executable run-time bi-directional node 1112 via the second run-time connection link. Further, as shown, the executable run-time bi-directional node 1112 may be associated with a run-time bi-directional overlay node 1120. Upon reception of the extracted features and detected objects received by the executable run-time bi-directional node 1112, the processing circuitry (for example, the controller module 206 and the transaction module 208) may execute processing logic of the run-time bi-directional overlay node 1120 on the extracted features and detected objects. Based on the execution, the image represented by the set of pixels may be classified into one or more classes of the plurality of classes. Subsequently, a publisher overlay node 1122, which is a generic run-time overlay node associated with the executable run-time bi-directional node 1112, may publish a classification of the image in the one or more classes of the plurality of classes.

It will be apparent to a person skilled in the art that although a use case scenario for the overlay system 202 is described for an image classification model, implementations of the overlay system 202 may be not limited to it. The overlay system 202 may also be implemented for applications in natural language processing, audio processing, robotics, database management, or the like.

Although FIG. 11 depicts generic run-time nodes and run-time bi-directional nodes of the neural network model 1100, identical networks of corresponding node templates and node instances may exist in a practical implementation of the neural network model 1100.

Having discussed various concepts, operations, and usage associated with the overlay system 202, the description now moves towards a computing system for implementing the overlay system 202 that implements the run-time bi-directional nodes.

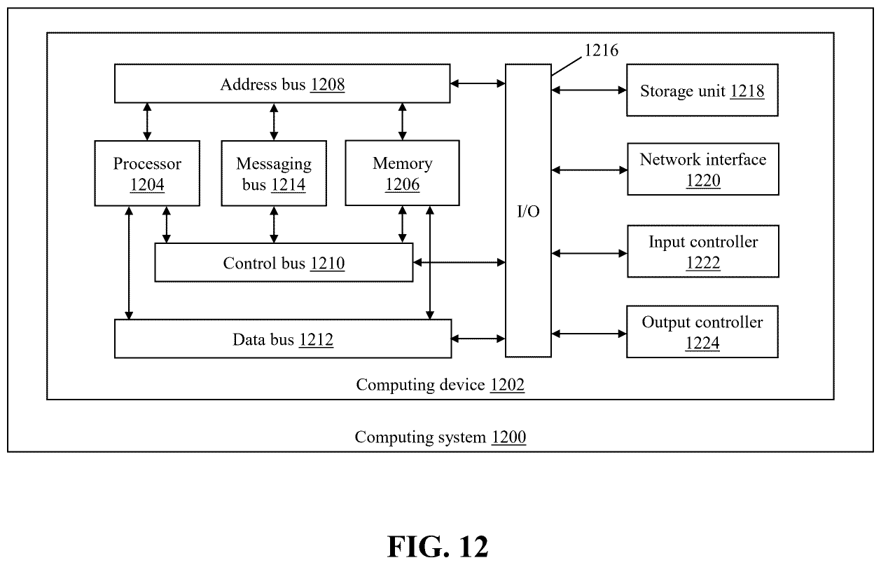

FIG. 12 shows an example computing system 1200 for carrying out the methods of the present disclosure, consistent with disclosed embodiments of the present disclosure. Specifically, FIG. 12 shows a block diagram of an embodiment of the computing system 1200 according to example embodiments of the present disclosure.

The computing system 1200 may be configured to perform any of the operations disclosed herein, for example, any of the operations discussed with reference to the functional modules described in relation to FIG. 2. The computing system 1200 can be implemented as a conventional computer system, an embedded controller, a laptop, a server, a mobile device, a smartphone, a set-top box, a kiosk, a vehicular information system, one or more processors associated with a television, a customized machine, any other hardware platform, or any combination or multiplicity thereof. In one embodiment, the computing system 1200 is a distributed system configured to function using multiple computing machines interconnected via a data network or bus system.

The computing system 1200 may include computing devices (such as a computing device 1202). The computing device 1202 may include one or more processors (such as a processor 1204) and a memory 1206. The processor 1204 may be any general-purpose processor(s) configured to execute a set of instructions. For example, the processor 1204 may be a processor core, a multiprocessor, a reconfigurable processor, a microcontroller, a digital signal processor (DSP), an application-specific integrated circuit (ASIC), a graphics processing unit (GPU), a neural processing unit (NPU), an accelerated processing unit (APU), a brain processing unit (BPU), a data processing unit (DPU), a holographic processing unit (HPU), an intelligent processing unit (IPU), a microprocessor/microcontroller unit (MPU/MCU), a radio processing unit (RPU), a tensor processing unit (TPU), a vector processing unit (VPU), a wearable processing unit (WPU), a field programmable gate array (FPGA), a programmable logic device (PLD), a controller, a state machine, gated logic, discrete hardware component, any other processing unit, or any combination or multiplicity thereof. In one embodiment, the processor 1204 may be multiple processing units, a single processing core, multiple processing cores, special purpose processing cores, co-processors, or any combination thereof. The processor 1204 may be communicatively coupled to the memory 1206 via an address bus 1208, a control bus 1210, a data bus 1212, and a messaging bus 1212.

The memory 1206 may include non-volatile memories such as a read-only memory (ROM), a programable read-only memory (PROM), an erasable programmable read-only memory (EPROM), a flash memory, or any other device capable of storing program instructions or data with or without applied power. The memory 1206 may also include volatile memories, such as a random-access memory (RAM), a static random-access memory (SRAM), a dynamic random-access memory (DRAM), and a synchronous dynamic random-access memory (SDRAM). The memory 1206 may include single or multiple memory modules. While the memory 1206 is depicted as part of the computing device 1202, a person skilled in the art will recognize that the memory 1206 can be separate from the computing device 1202.

The memory 1206 may store information that can be accessed by the processor 1204. For instance, the memory 1206 (e.g., one or more non-transitory computer-readable storage mediums, memory devices) may include computer-readable instructions (not shown) that can be executed by the processor 1204. The computer-readable instructions may be software written in any suitable programming language or may be implemented in hardware. Additionally, or alternatively, the computer-readable instructions may be executed in logically and/or virtually separate threads on the processor 1204. For example, the memory 1206 may store instructions (not shown) that when executed by the processor 1204 cause the processor 1204 to perform operations such as any of the operations and functions for which the computing system 1200 is configured, as described herein. Additionally, or alternatively, the memory 1206 may store data (not shown) that can be obtained, received, accessed, written, manipulated, created, and/or stored. The data can include, for instance, the data and/or information described herein in relation to FIGS. 1-11. In some implementations, the computing device 1202 may obtain from and/or store data in one or more memory device(s) that may be remote from the computing system 1200.

The computing device 1202 may further include an input/output (I/O) interface 1216 communicatively coupled to the address bus 1208, the control bus 1210, and the data bus 1212. The data bus 1212 and messaging bus 1214 may include a plurality of tunnels that may support parallel execution of messages by the overlay system 202. The I/O interface 1216 is configured to couple to one or more external devices (e.g., to receive and send data from/to one or more external devices). Such external devices, along with the various internal devices, may also be known as peripheral devices. The I/O interface 1216 may include both electrical and physical connections for operably coupling the various peripheral devices to the computing device 1202. The I/O interface 1216 may be configured to communicate data, addresses, and control signals between the peripheral devices and the computing device 1202. The I/O interface 1216 may be configured to implement any standard interface, such as a small computer system interface (SCSI), a serial-attached SCSI (SAS), a fiber channel, a peripheral component interconnect (PCI), a PCI express (PCIe), a serial bus, a parallel bus, an advanced technology attachment (ATA), a serial ATA (SATA), a universal serial bus (USB), Thunderbolt, Fire Wire, various video buses, or the like. The I/O interface 1216 is configured to implement only one interface or bus technology. Alternatively, the I/O interface 1216 is configured to implement multiple interfaces or bus technologies. The I/O interface 1216 may include one or more buffers for buffering transmissions between one or more external devices, internal devices, the computing device 1202, or the processor 1204. The I/O interface 1216 may couple the computing device 1202 to various input devices, including mice, touch screens, scanners, biometric readers, electronic digitizers, sensors, receivers, touchpads, trackballs, cameras, microphones, keyboards, any other pointing devices, or any combinations thereof. The I/O interface 1216 may couple the computing device 1202 to various output devices, including video displays, speakers, printers, projectors, tactile feedback devices, automation control, robotic components, actuators, motors, fans, solenoids, valves, pumps, transmitters, signal emitters, lights, and so forth.

The computing system 1200 may further include a storage unit 1218, a network interface 1220, an input controller 1222, and an output controller 1224. The storage unit 1218, the network interface 1220, the input controller 1222, and the output controller 1224 may be communicatively coupled to the central control unit (e.g., the memory 1206, the address bus 1208, the control bus 1210, and the data bus 1212) via the I/O interface 1216. The network interface 1220 communicatively couples the computing system 1200 to one or more networks such as wide area networks (WAN), local area networks (LAN), intranets, the Internet, wireless access networks, wired networks, mobile networks, telephone networks, optical networks, or combinations thereof. The network interface 1220 may facilitate communication with packet-switched networks or circuit-switched networks which use any topology and may use any communication protocol. Communication links within the network may involve various digital or analog communication media such as fiber optic cables, free-space optics, waveguides, electrical conductors, wireless links, antennas, radio-frequency communications, and so forth.

The storage unit 1218 is a computer-readable medium, preferably a non-transitory computer-readable medium, comprising one or more programs, the one or more programs comprising instructions which when executed by the processor 1204 cause the computing system 1200 to perform the method steps of the present disclosure. Alternatively, the storage unit 1218 is a transitory computer-readable medium. The storage unit 1218 can include a hard disk, a floppy disk, a compact disc read-only memory (CD-ROM), a digital versatile disc (DVD), a Blu-ray disc, a magnetic tape, a flash memory, another non-volatile memory device, a solid-state drive (SSD), any magnetic storage device, any optical storage device, any electrical storage device, any semiconductor storage device, any physical-based storage device, any other data storage device, or any combination or multiplicity thereof. In one embodiment, the storage unit 1218 stores one or more operating systems, application programs, program modules, data, or any other information. The storage unit 1218 is part of the computing device 1202. Alternatively, the storage unit 1218 is part of one or more other computing machines that may be in communication with the computing device 1202, such as servers, database servers, cloud storage, network attached storage, and so forth.

The input controller 1222 may include suitable logic, circuitry, interfaces, and/or code, executable by the circuitry, that may be configured to control one or more input devices that may be configured to receive an input (the stimulus 230) for the overlay system 202. The output controller 1224 may include suitable logic, circuitry, interfaces, and/or code, executable by the circuitry, that may be configured to control one or more output devices that may be configured to render/output the outcome of the operation executed to process the received input (the stimulus 230).

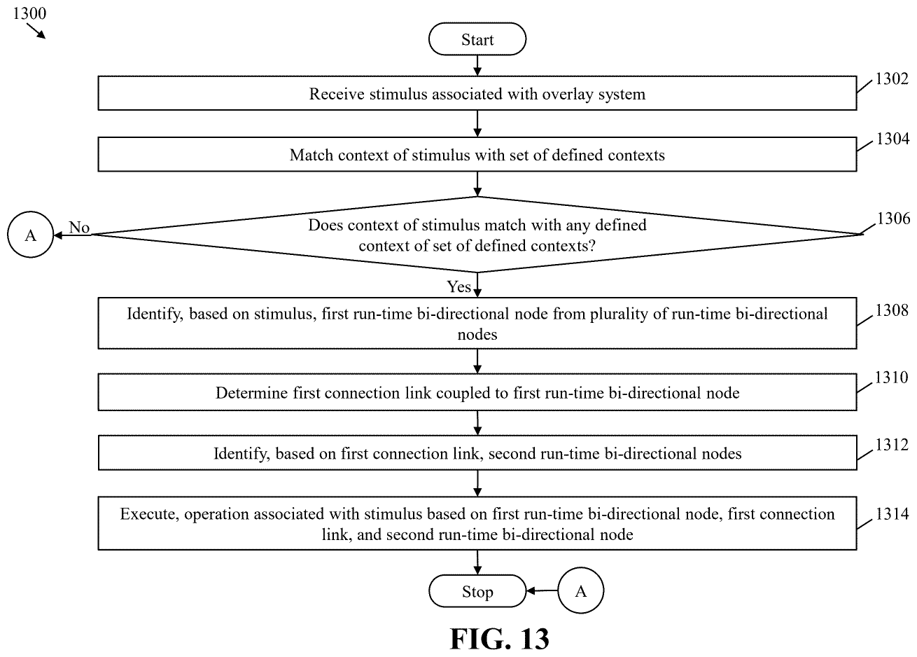

FIG. 13 illustrates a flowchart 1300 of a method for processing a stimulus using a run-time bi-directional node (for example, the executable run-time bi-directional node 602), consistent with disclosed embodiments of the present disclosure. Referring to FIG. 13, at 1302, a stimulus is received. The processing circuitry (such as the controller module 206 and the stimuli management module 212) receives the stimulus associated with the overlay system 202. The stimulus is indicative of an operation to be performed using a first run-time bi-directional node. At 1304, the context of the stimulus is matched with the set of defined contexts. The processing circuitry (such as the controller module 206 and the stimuli management module 212) may match the context of the stimulus with the set of defined contexts. At 1306, it is determined whether a context of the stimulus matches with any defined context of the set of defined contexts. The processing circuitry (such as the context module 210) may determine whether the context of the stimulus matches any defined context of the set of defined contexts. In an instance, when it is determined that the context of the stimulus does not match with any of the set of defined contexts, the method terminates. In another instance, when it is determined that the context of the stimulus matches with one or more of the contexts of the set of defined contexts, 1308 is executed.

At 1308, a first run-time bi-directional node is identified from the plurality of run-time bi-directional nodes of the executable graph-based model 100 based on the context of the stimulus. The processing circuitry (such as the controller module 206, the context module 210, and the stimuli management module 212) may identify the first run-time bi-directional node from the plurality of run-time bi-directional nodes.

At 1310, a first run-time connection link coupled to the first run-time bi-directional node is determined based on the identification of the first run-time bi-directional node. The first run-time connection link couples the first run-time bi-directional node and a second run-time bi-directional node. The first run-time connection link may include an OCO and an ICO coupled with the first run-time bi-directional node and the second run-time bi-directional node, respectively. The processing circuitry (such as the controller module 206, the context module 210, and the stimuli management module 212) may determine the first run-time connection link while loading the first run-time bi-directional link in the executable graph-based model 100. The processing circuitry may determine the first run-time connection link based on an identifier of the second run-time bi-directional node being stored along with the first run-time bi-directional node.

At 1312, the second run-time bi-directional node is identified based on the determination of the first run-time connection link. The processing circuitry (such as the controller module 206, the context module 210, and the stimuli management module 212) may identify the second run-time bi-directional node while loading the first run-time bi-directional link in the executable graph-based model 100. The processing circuitry (such as the controller module 206, the context module 210, and the stimuli management module 212) may identify the second run-time bi-directional node based on the identifier of the second run-time bi-directional node being stored along with the first run-time bi-directional node as well as the association of the second run-time bi-directional node with the first run-time connection link.

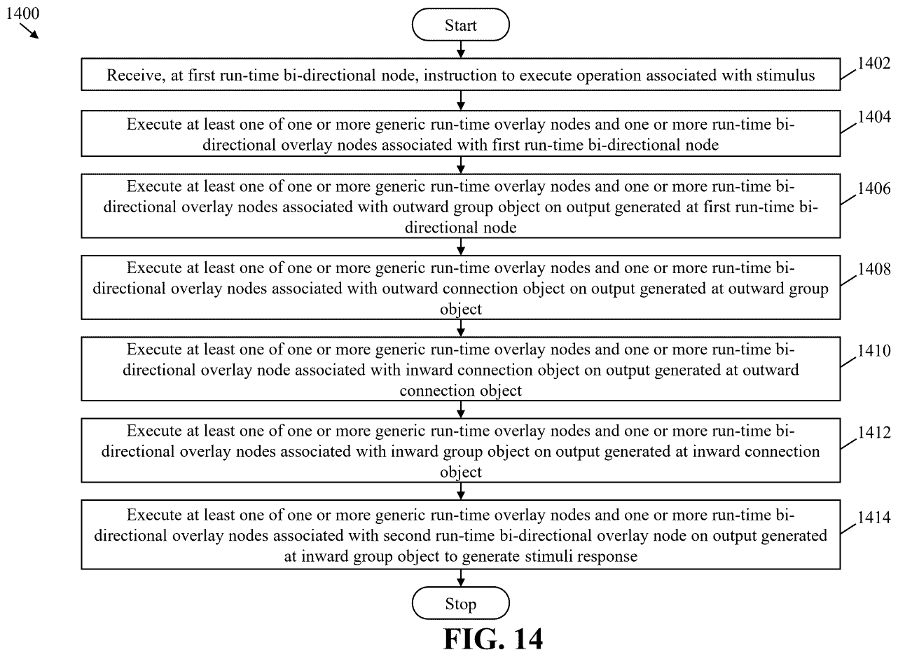

At 1314, an operation associated with the stimulus is executed based on the first run-time bi-directional node, the first run-time connection link, and the second run-time bi-directional node. The processing circuitry (such as the controller module 206, the context module 210, and the stimuli management module 212) may execute the operation associated with the stimulus based on the first run-time bi-directional node, the first run-time connection link, and the second run-time bi-directional node. FIG. 14 describes the execution of the operation associated with the stimulus in detail.

FIG. 14 illustrates a flowchart 1400 of a method for execution of the operation associated with the stimulus, consistent with disclosed embodiments of the present disclosure. Referring to FIG. 14, at 1402, the first run-time bi-directional node may receive an instruction to execute the operation associated with the stimulus. The processing circuitry (such as the controller module 206, the context module 210, and the stimuli management module 212) may receive, using the first run-time bi-directional node, the instruction to execute the operation associated with the stimulus. At 1404, one or more generic run-time overlay nodes and/or one or more run-time bi-directional overlay nodes associated with the first run-time bi-directional node may be executed to generate a first intermediate message. The processing circuitry (such as the controller module 206, the context module 210, and the stimuli management module 212) may execute the one or more generic run-time overlay nodes and/or the one or more run-time bi-directional overlay nodes associated with the first run-time bi-directional node to generate the first intermediate message.

At 1406, one or more generic run-time overlay nodes and/or one or more run-time bi-directional overlay nodes associated with an outward group object associated with the first run-time bi-directional node may be executed on the first intermediate message to generate a second intermediate message. The processing circuitry (such as the controller module 206, the context module 210, and the stimuli management module 212) may execute the one or more generic run-time overlay nodes and/or the one or more run-time bi-directional overlay nodes associated with the outward group object to generate the second intermediate message.

At 1408, one or more generic run-time overlay nodes and/or one or more run-time bi-directional overlay nodes associated with the OCO associated with the first run-time bi-directional node may be executed on the second intermediate message to generate a third intermediate message. The processing circuitry (such as the controller module 206, the context module 210, and the stimuli management module 212) may execute the one or more generic run-time overlay nodes and/or the one or more run-time bi-directional overlay nodes associated with the OCO to generate the third intermediate message.

At 1410, one or more generic run-time overlay nodes and/or one or more run-time bi-directional overlay nodes associated with the ICO associated with the second run-time bi-directional node may be executed on the third intermediate message to generate a fourth intermediate message. The processing circuitry (such as the controller module 206, the context module 210, and the stimuli management module 212) may execute the one or more generic run-time overlay nodes and/or the one or more run-time bi-directional overlay nodes associated with the ICO to generate the fourth intermediate message.

At 1412, one or more generic overlay nodes and/or one or more run-time bi-directional overlay nodes associated with an inward group object associated with the second run-time bi-directional node may be executed on the fourth intermediate message to generate a fifth intermediate message. The processing circuitry (such as the controller module 206, the context module 210, and the stimuli management module 212) may execute the one or more generic run-time overlay nodes and/or the one or more run-time bi-directional overlay nodes associated with the inward group object to generate the fifth intermediate message.

At 1414, one or more generic run-time overlay nodes and/or one or more run-time bi-directional overlay nodes associated with the second run-time bi-directional node may be executed on the fifth intermediate message to generate a stimulus response for the stimulus. The processing circuitry (such as the controller module 206, the context module 210, and the stimuli management module 212) may execute the one or more generic run-time overlay nodes and/or the one or more run-time bi-directional overlay nodes associated with the second run-time bi-directional node to generate the stimulus response for the stimulus.

The disclosed embodiments encompass numerous advantages including a simple and user-friendly implementation of the executable graph-based model 100 that may be in turn used to implement various complex and advanced applications. Further, the disclosed systems and methods allow for the facilitation of run-time bi-directional nodes in the executable graph-based model 100. Notably, the present disclosure facilitates a plurality of run-time bi-directional nodes in an executable graph-based model. A first run-time bi-directional node may be associated with a second run-time bi-directional node by way of a run-time connection link that may include a primary role for the first run-time bi-directional node and a secondary role for the second run-time bi-directional node. The primary role and the secondary role indicate a capacity in which the first and second run-time bi-directional nodes may be mutually associated. To ensure optimal use of resources, the first and second run-time bi-directional nodes may be unloaded from the executable graph-based model and stored in a storage element associated with the executable graph-based model 100. Subsequently, in an instance when the first run-time bi-directional node may be required to be used, the first run-time bi-directional node is loaded. The use of the first run-time bi-directional node also requires the use of other run-time bi-directional nodes associated with the first run-time bi-directional node. Notably, the first run-time bi-directional node is stored with an identifier of the second run-time bi-directional node. This allows for an identification of the association between the first and second run-time bi-directional nodes. Based on the identification the second run-time bi-directional node may be loaded. This allows for quick identification of run-time bi-directional nodes associated with the first run-time bi-directional node by way of dependency, inheritance, role, or the like. Such identification eliminates the requirement of executing multiple look-up operations for identifying the run-time bi-directional nodes associated with the first run-time bi-directional nodes. Hence, the run-time bi-directional nodes may be loaded in significantly less time and thus increase throughput and decrease latency associated with operations performed in the overlay system. In a real-life scenario, when each run-time bi-directional node in the executable graph-based model 100 may be associated with multiple other run-time bi-directional nodes, such an approach of identification of association among run-time bi-directional nodes and loading of the run-time bi-directional nodes allows for a seamless and simplified approach for implementing solutions associated with various domains. Application areas of the systems and methods disclosed herein may be fintech platforms, social media platforms, gaming platforms, research and analytics platforms, robotics, or the like.

Moreover, implementation of run-time nodes by way of node templates and node instances allows for the reusability of resources. For example, a node template may be shared among multiple node instances. This allows for an efficient utilization of memory, processing capability, and execution prowess of the overlay system 202.

Moreover, for example, the present technology/system may achieve the following configurations:

1. An overlay system, comprising:
a storage element configured to store an executable graph-based model that includes:
   a plurality of run-time bi-directional nodes, with each run-time bi-directional node including (i) a node template that corresponds to a predefined bi-directional node structure, and (ii) a node instance that corresponds to an implementation of the node template; and
   a plurality of run-time connection links; and
processing circuitry that is coupled to the storage element, and configured to:
   receive a stimulus;
   identify, based on the stimulus, a first run-time bi-directional node from the plurality of run-time bi-directional nodes;
   determine a first run-time connection link, of the plurality of run-time connection links, coupled to the first run-time bi-directional node, the first run-time connection link including a first outward connection object defining association with the first run-time bi-directional node and a first inward connection object defining association with a second run-time bi-directional node of the plurality of run-time bi-directional nodes;
   identify, based on the first run-time connection link, the second run-time bi-directional node; and
   execute an operation associated with the stimulus based on the first run-time bi-directional node, the second run-time bi-directional node, and the first run-time connection link.

2. The overlay system of 1,
wherein the first outward connection object and the first inward connection object have a primary role and a secondary role, respectively,
wherein the primary role and the secondary role, collectively, indicate a capacity in which the first run-time bi-directional node and the second run-time bi-directional node are mutually associated, and
wherein the operation associated with the stimulus is executed in conformity with the primary role and the secondary role.

3. The overlay system of 1,
wherein the executable graph-based model further includes a plurality of run-time bi-directional overlay nodes with each run-time bi-directional overlay node including (i) an overlay node template that corresponds to a predefined bi-directional overlay node structure, and (ii) an overlay node instance that corresponds to an implementation of the overlay node template,
wherein the processing circuitry is further configured to determine a first set of run-time bi-directional overlay nodes, of the plurality of run-time bi-directional overlay nodes, that is associated with the first run-time bi-directional node,
wherein each of the first set of run-time bi-directional overlay nodes is configured to extend functionality of the first run-time bi-directional node, and
wherein the operation associated with the stimulus is executed further based on the first set of run-time bi-directional overlay nodes.

4. The overlay system of 3,
wherein the executable graph-based model further includes a plurality of generic run-time overlay nodes with each generic run-time overlay node including (i) an overlay node template that corresponds to a predefined generic overlay node structure, and (ii) an overlay node instance that corresponds to an implementation of the overlay node template,
wherein the processing circuitry is further configured to determine a first set of generic run-time overlay nodes, of the plurality of generic run-time overlay nodes, that is associated with the first run-time bi-directional node,
wherein each of the first set of generic run-time overlay nodes is configured to extend functionality of the first run-time bi-directional node, and
wherein the operation associated with the stimulus is executed further based on the first set of generic run-time overlay nodes.

5. The overlay system of 4,
wherein the first run-time bi-directional node includes an overlay manager that is configured to:
   maintain a ledger of functionalities of the first set of generic run-time overlay nodes and the first set of run-time bi-directional overlay nodes; and
   trigger, based on the stimulus, at least one of a group consisting of (i) one or more generic run-time overlay nodes of the first set of generic run-time overlay nodes or (ii) one or more run-time bi-directional overlay nodes of the first set of run-time bi-directional overlay nodes, and
wherein the operation associated with the stimulus is executed further based on the one or more generic run-time overlay nodes and the one or more run-time bi-directional overlay nodes.

6. The overlay system of 3, wherein the first set of run-time bi-directional overlay nodes is associated with the first run-time bi-directional node by way of one of a group consisting of a direct association and a second run-time connection link of the plurality of run-time connection links.

7. The overlay system of 3, wherein a run-time bi-directional overlay node, of the first set of run-time bi-directional overlay nodes, is one of a group consisting of a stateless node and a stateful node.

8. The overlay system of 1,
wherein the executable graph-based model further includes a plurality of run-time bi-directional overlay nodes with each run-time bi-directional overlay node including (i) an overlay node template that corresponds to a predefined bi-directional overlay node structure, and (ii) an overlay node instance that corresponds to an implementation of the overlay node template,
wherein the processing circuitry is further configured to determine a second set of run-time bi-directional overlay nodes, of the plurality of run-time bi-directional overlay nodes, that is associated with the second run-time bi-directional node,
wherein each of the second set of run-time bi-directional overlay nodes is configured to extend functionality of the second run-time bi-directional node, and
wherein the operation associated with the stimulus is executed further based on the second set of run-time bi-directional overlay nodes.

9. The overlay system of 1,
wherein the executable graph-based model further includes a plurality of run-time bi-directional overlay nodes with each run-time bi-directional overlay node including (i) an overlay node template that corresponds to a predefined bi-directional overlay node structure, and (ii) an overlay node instance that corresponds to an implementation of the overlay node template,
wherein the processing circuitry is further configured to determine a third set of run-time bi-directional overlay nodes, of the plurality of run-time bi-directional overlay nodes, that is associated with the first outward connection object,
wherein each of the third set of run-time bi-directional overlay nodes is configured to extend functionality of the first outward connection object, and
wherein the operation associated with the stimulus is executed further based on the third set of run-time bi-directional overlay nodes.

10. The overlay system of 1,
wherein the executable graph-based model further includes a plurality of run-time bi-directional overlay nodes with each run-time bi-directional overlay node including (i) an overlay node template that corresponds to a predefined bi-directional overlay node structure, and (ii) an overlay node instance that corresponds to an implementation of the overlay node template,
wherein the processing circuitry is further configured to determine a fourth set of run-time bi-directional overlay nodes, of the plurality of run-time bi-directional overlay nodes, that is associated with the first inward connection object,
wherein each of the fourth set of run-time bi-directional overlay nodes is configured to extend functionality of the first inward connection object, and
wherein the operation associated with the stimulus is executed further based on the fourth set of run-time bi-directional overlay nodes.

11. The overlay system of 1, wherein a node-type of a run-time bi-directional node of the plurality of run-time bi-directional nodes is an edge node-type.

12. The overlay system of 1,
wherein the first run-time bi-directional node is further coupled to a third run-time bi-directional node of the plurality of run-time bi-directional nodes by way of a third run-time connection link of the plurality of run-time connection links,
wherein the third run-time connection link includes a second outward connection object and a second inward connection object that define association with the first run-time bi-directional node and the third run-time bi-directional node, respectively,
wherein the first outward connection object and the second outward connection object constitute an outward group object associated with the first run-time bi-directional node, and
wherein the operation associated with the stimulus is executed further based on the outward group object, the third run-time bi-directional node, and the third run-time connection link.

13. The overlay system of 12, wherein the operation is executed based on the first run-time bi-directional node communicating with the second run-time bi-directional node and the third run-time bi-directional node by way of the outward group object.

14. The overlay system of 11,
wherein the executable graph-based model further includes a plurality of run-time bi-directional overlay nodes with each run-time bi-directional overlay node including (i) an overlay node template that corresponds to a predefined bi-directional overlay node structure, and (ii) an overlay node instance that corresponds to an implementation of the overlay node template,
wherein the processing circuitry is further configured to determine a fifth set of run-time bi-directional overlay nodes, of the plurality of run-time bi-directional overlay nodes, that is associated with the outward group object,
wherein each of the fifth set of run-time bi-directional overlay nodes is configured to extend functionality of the outward group object, and
wherein the operation associated with the stimulus is executed further based on the fifth set of run-time bi-directional overlay nodes.

15. The overlay system of 11,
wherein the executable graph-based model further includes a plurality of generic run-time overlay nodes with each generic run-time overlay node including (i) an overlay node template that corresponds to a predefined generic overlay node structure, and (ii) an overlay node instance that corresponds to an implementation of the overlay node template,
wherein the processing circuitry is further configured to determine a second set of generic run-time overlay nodes, of the plurality of generic run-time overlay nodes, that is associated with the outward group object,
wherein each of the second set of generic run-time overlay nodes is configured to extend functionality of the outward group object, and
wherein the operation associated with the stimulus is executed further based on the second set of generic run-time overlay nodes.

16. The overlay system of 1,
wherein the first run-time bi-directional node is further coupled to a fourth run-time bi-directional node and a fifth run-time bi-directional node, of the plurality of run-time bi-directional nodes, by way of a fourth run-time connection link and a fifth run-time connection link, of the plurality of run-time connection links, respectively,
wherein the fourth run-time connection link includes a third inward connection object and a third outward connection object that define association with the first run-time bi-directional node and the fourth run-time bi-directional node, respectively,
wherein the fifth run-time connection link includes a fourth inward connection object and a fourth outward connection object that define association with the first run-time bi-directional node and the fifth run-time bi-directional node, respectively,
wherein the third inward connection object and the fourth inward connection object constitute an inward group object associated with the first run-time bi-directional node, and
wherein the operation associated with the stimulus is executed further based on the inward group object, the fourth run-time bi-directional node, the fifth run-time bi-directional node, the fourth run-time connection link, and the fifth run-time connection link.

17. The overlay system of 16, wherein the operation is executed further based on the first run-time bi-directional node communicating with the fourth run-time bi-directional node and the fifth run-time bi-directional node by way of the inward group object.

18. The overlay system of 16,
wherein the executable graph-based model further includes a plurality of run-time bi-directional overlay nodes with each run-time bi-directional overlay node including (i) an overlay node template that corresponds to a predefined bi-directional overlay node structure, and (ii) an overlay node instance that corresponds to an implementation of the overlay node template,
wherein the processing circuitry is further configured to determine a sixth set of run-time bi-directional overlay nodes, of the plurality of run-time bi-directional overlay nodes, that is associated with the inward group object,
wherein each of the sixth set of run-time bi-directional overlay nodes is configured to extend functionality of the inward group object, and
wherein the operation associated with the stimulus is executed further based on the sixth set of run-time bi-directional overlay nodes.

19. The overlay system of 16,
wherein the executable graph-based model further includes a plurality of generic run-time overlay nodes with each generic run-time overlay node including (i) an overlay node template that corresponds to a predefined generic overlay node structure, and (ii) an overlay node instance that corresponds to an implementation of the overlay node template,
wherein the processing circuitry is further configured to determine a third set of generic run-time overlay nodes, of the plurality of generic run-time overlay nodes, that is associated with the inward group object,
wherein each of the third set of generic run-time overlay nodes is configured to extend functionality of the inward group object, and
wherein the operation associated with the stimulus is executed further based on the third set of generic run-time overlay nodes.

20. The overlay system of 1, wherein the first run-time connection link is a run-time bi-directional node.

21. The overlay system of 1, wherein the first run-time connection link has a role node-type.

22. The overlay system of 1,
wherein the first run-time connection link is indicative of a dependency between the first run-time bi-directional node and the second run-time bi-directional node, and
wherein the dependency between the first run-time bi-directional node and the second run-time bi-directional node is one of a group consisting of: an own-owned dependency, a use-used dependency, and a share-shared dependency.

23. The overlay system of 22, wherein based on the dependency being the own-owned dependency, the first run-time bi-directional node owns the second run-time bi-directional node.

24. The overlay system of 22, wherein based on the dependency being the share-shared dependency, the first run-time bi-directional node shares the second run-time bi-directional node with one or more run-time bi-directional nodes of the plurality of run-time bi-directional nodes.

25. The overlay system of 22, wherein based on the dependency being the use-used dependency, the first run-time bi-directional node uses the second run-time bi-directional node based on an absence of simultaneous use of the second run-time bi-directional node by one or more other run-time bi-directional nodes of the plurality of run-time bi-directional nodes.

26. The overlay system of 1, wherein at least one of the first inward connection object and the first outward connection object is associated with a set of attributes pertaining to a loading strategy associated with at least one of from a group consisting of the first run-time bi-directional node and the second run-time bi-directional node.

27. The overlay system of 1, wherein prior to the execution of the operation associated with the stimulus, the processing circuitry is further configured to load, in the executable graph-based model, at least one of a group consisting of: the first run-time bi-directional node, the second run-time bi-directional node, or the first run-time connection link.

28. The overlay system of 27, wherein the loading of the first run-time bi-directional node includes loading of an associated node template and an associated node instance.

29. The overlay system of 27, wherein the processing circuitry is further configured to load, in the executable graph-based model, one or more sets of run-time bi-directional overlay nodes that are associated with at least one of a group consisting of: the first run-time bi-directional node, the second run-time bi-directional node, the first inward connection object, or the first outward connection object.

30. The overlay system of 27, wherein the processing circuitry is further configured to load, in the executable graph-based model, one or more sets of generic run-time overlay nodes that are associated with at least one of a group consisting of: the first run-time bi-directional node, the second run-time bi-directional node, the first inward connection object, or the first outward connection object.

31. The overlay system of 27,
wherein based on the loading of the first run-time bi-directional node, the processing circuitry is further configured to load at least one of a group consisting of (i) one or more run-time bi-directional nodes of the plurality of run-time bi-directional nodes or (ii) one or more generic run-time nodes of a plurality of generic run-time nodes of the executable graph-based model, with which the first run-time bi-directional node has a dependency, and
wherein the dependency is one of a group consisting of: an own-owned dependency, a share-shared dependency, and a use-used dependency.

32. The overlay system of 27,
wherein the first run-time bi-directional node is further configured to inherit at least one of a group consisting of (i) a sixth run-time bi-directional node of the plurality of run-time bi-directional nodes or (ii) one or more generic run-time nodes of a plurality of generic run-time nodes of the executable graph-based model, and
wherein based on the loading of the first run-time bi-directional node, the processing circuitry is further configured to load at least one of the group consisting of (i) the sixth run-time bi-directional node or (ii) the one or more generic run-time nodes.

33. The overlay system of 1, wherein upon execution of the operation associated with the stimulus, the processing circuitry is further configured to unload at least one of a group consisting of: the first run-time bi-directional node, the second run-time bi-directional node, or the first run-time connection link, from the executable graph-based model.

34. The overlay system of 33,
wherein based on the unloading of the first run-time bi-directional node, the processing circuitry is further configured to unload at least one of a group consisting of (i) one or more run-time bi-directional nodes of the plurality of run-time bi-directional nodes and (ii) one or more generic run-time nodes of a plurality of generic run-time nodes of the executable graph-based model, with which the first run-time bi-directional node has a dependency, and
wherein the dependency is one of a group consisting of: an own-owned dependency, a share-shared dependency, and a use-used dependency.

35. The overlay system of 33,
wherein the first run-time bi-directional node is further configured to inherit at least one of a group consisting of (i) a second set of run-time bi-directional nodes of the plurality of run-time bi-directional nodes or (ii) a third set of generic run-time nodes of a plurality of generic run-time nodes of the executable graph-based model, and
wherein based on the unloading of the first run-time bi-directional overlay node, the processing circuitry is further configured to unload at least one of the group consisting of (i) the second set of run-time bi-directional nodes or (ii) the third set of generic run-time nodes.

36. The overlay system of 1,
wherein the executable graph-based model further includes a plurality of generic run-time nodes with each generic run-time node including (i) a generic node template that corresponds to a predefined node structure, and (ii) a generic node instance that corresponds to an implementation of the generic node template,
wherein a node-type of each generic run-time node of the plurality of generic run-time nodes is one of a group consisting of: a vertex node-type, an edge node-type, a role node-type, or an overlay node-type,
wherein the processing circuitry is further configured to determine a first generic run-time node, of the plurality of generic run-time nodes, that is associated with the first run-time bi-directional node by way of a first generic role that indicates a capacity in which the first run-time bi-directional node is associated with the first generic run-time node, and
wherein the operation associated with the stimulus is executed further based on the first generic run-time node and the first generic role.

37. The overlay system of 1,
wherein the second run-time bi-directional node is further associated with a seventh run-time bi-directional node of the plurality of run-time bi-directional nodes by way of a sixth run-time connection link, and
wherein the sixth run-time connection link includes the first inward connection object and a fifth outward connection object that define association with the second run-time bi-directional node and the seventh run-time bi-directional node, respectively.

38. The overlay system of 1, wherein the first run-time bi-directional node and the second run-time bi-directional node have a same node template and different node instances.

39. A method, comprising:
receiving, by processing circuitry of an overlay system, a stimulus,
   wherein an executable graph-based model is stored in a storage element of the overlay system,
   wherein the executable graph-based model includes a plurality of run-time bi-directional nodes and a plurality of run-time connection links, and
   wherein each run-time bi-directional node includes (i) a node template that corresponds to a predefined bi-directional node structure, and (ii) a node instance that corresponds to an implementation of the node template;
identifying, by the processing circuitry, based on the stimulus, a first run-time bi-directional node from the plurality of run-time bi-directional nodes;
determining, by the processing circuitry, a first run-time connection link, of the plurality of run-time connection links, coupled to the first run-time bi-directional node, the first run-time connection link including a first outward connection object defining association with the first run-time bi-directional node and a first inward connection object defining association with a second run-time bi-directional node of the plurality of run-time bi-directional nodes;
identifying, by the processing circuitry, based on the first run-time connection link, the second run-time bi-directional node; and
executing, by the processing circuitry, an operation associated with the stimulus based on the first run-time bi-directional node, the second run-time bi-directional node, and the first run-time connection link.

1. An overlay system, comprising:
a storage element configured to store an executable graph-based model that includes:
a plurality of run-time bi-directional nodes, with each run-time bi-directional node including (i) a node template that corresponds to a predefined bi-directional node structure, and (ii) a node instance that corresponds to an implementation of the node template; and
a plurality of run-time connection links; and
processing circuitry that is coupled to the storage element, and configured to:
receive a stimulus;
identify, based on the stimulus, a first run-time bi-directional node from the plurality of run-time bi-directional nodes;
determine a first run-time connection link, of the plurality of run-time connection links, coupled to the first run-time bi-directional node, the first run-time connection link including a first outward connection object defining association with the first run-time bi-directional node and a first inward connection object defining association with a second run-time bi-directional node of the plurality of run-time bi-directional nodes;
identify, based on the first run-time connection link, the second run-time bi-directional node;
load, based on the first run-time connection link, the second run-time bi-directional node from the storage element; and
execute an operation associated with the stimulus based on the first run-time bi-directional node, the second run-time bi-directional node, and the first run-time connection link.

2. The overlay system of claim 1,
wherein the first outward connection object and the first inward connection object have a primary role and a secondary role, respectively,
wherein the primary role and the secondary role, collectively, indicate a capacity in which the first run-time bi-directional node and the second run-time bi-directional node are mutually associated, and
wherein the operation associated with the stimulus is executed in conformity with the primary role and the secondary role.

3. The overlay system of claim 1,
wherein the executable graph-based model further includes a plurality of run-time bi-directional overlay nodes with each run-time bi-directional overlay node including (i) an overlay node template that corresponds to a predefined bi-directional overlay node structure, and (ii) an overlay node instance that corresponds to an implementation of the overlay node template,
wherein the processing circuitry is further configured to determine a first set of run-time bi-directional overlay nodes, of the plurality of run-time bi-directional overlay nodes, that is associated with the first run-time bi-directional node,
wherein each of the first set of run-time bi-directional overlay nodes is configured to extend functionality of the first run-time bi-directional node, and
wherein the operation associated with the stimulus is executed further based on the first set of run-time bi-directional overlay nodes.

4. The overlay system of claim 3,
wherein the executable graph-based model further includes a plurality of generic run-time overlay nodes with each generic run-time overlay node including (i) another overlay node template that corresponds to a predefined generic overlay node structure, and (ii) another overlay node instance that corresponds to an implementation of the overlay node template,
wherein the processing circuitry is further configured to determine a first set of generic run-time overlay nodes, of the plurality of generic run-time overlay nodes, that is associated with the first run-time bi-directional node,
wherein each of the first set of generic run-time overlay nodes is configured to extend functionality of the first run-time bi-directional node, and
wherein the operation associated with the stimulus is executed further based on the first set of generic run-time overlay nodes.

5. The overlay system of claim 4,
wherein the first run-time bi-directional node includes an overlay manager that is configured to:
maintain a ledger of functionalities of the first set of generic run-time overlay nodes and the first set of run-time bi-directional overlay nodes; and
trigger, based on the stimulus, at least one of a group consisting of (i) one or more generic run-time overlay nodes of the first set of generic run-time overlay nodes or (ii) one or more run-time bi-directional overlay nodes of the first set of run-time bi-directional overlay nodes, and
wherein the operation associated with the stimulus is executed further based on the one or more generic run-time overlay nodes and the one or more run-time bi-directional overlay nodes.

6. The overlay system of claim 3, wherein the first set of run-time bi-directional overlay nodes is associated with the first run-time bi-directional node by way of one of a group consisting of a direct association and a second run-time connection link of the plurality of run-time connection links.

7. The overlay system of claim 1,
wherein the executable graph-based model further includes a plurality of run-time bi-directional overlay nodes with each run-time bi-directional overlay node including (i) an overlay node template that corresponds to a predefined bi-directional overlay node structure, and (ii) an overlay node instance that corresponds to an implementation of the overlay node template,
wherein the processing circuitry is further configured to determine a second set of run-time bi-directional overlay nodes, of the plurality of run-time bi-directional overlay nodes, that is associated with the second run-time bi-directional node,
wherein each of the second set of run-time bi-directional overlay nodes is configured to extend functionality of the second run-time bi-directional node, and
wherein the operation associated with the stimulus is executed further based on the second set of run-time bi-directional overlay nodes.

8. The overlay system of claim 1,
wherein the executable graph-based model further includes a plurality of run-time bi-directional overlay nodes with each run-time bi-directional overlay node including (i) an overlay node template that corresponds to a predefined bi-directional overlay node structure, and (ii) an overlay node instance that corresponds to an implementation of the overlay node template,
wherein the processing circuitry is further configured to determine a third set of run-time bi-directional overlay nodes, of the plurality of run-time bi-directional overlay nodes, that is associated with the first outward connection object,
wherein each of the third set of run-time bi-directional overlay nodes is configured to extend functionality of the first outward connection object, and
wherein the operation associated with the stimulus is executed further based on the third set of run-time bi-directional overlay nodes.

9. The overlay system of claim 1,
wherein the executable graph-based model further includes a plurality of run-time bi-directional overlay nodes with each run-time bi-directional overlay node including (i) an overlay node template that corresponds to a predefined bi-directional overlay node structure, and (ii) an overlay node instance that corresponds to an implementation of the overlay node template,
wherein the processing circuitry is further configured to determine a fourth set of run-time bi-directional overlay nodes, of the plurality of run-time bi-directional overlay nodes, that is associated with the first inward connection object,
wherein each of the fourth set of run-time bi-directional overlay nodes is configured to extend functionality of the first inward connection object, and
wherein the operation associated with the stimulus is executed further based on the fourth set of run-time bi-directional overlay nodes.

10. The overlay system of claim 1,
wherein the first run-time bi-directional node is further coupled to a third run-time bi-directional node of the plurality of run-time bi-directional nodes by way of a third run-time connection link of the plurality of run-time connection links,
wherein the third run-time connection link includes a second outward connection object and a second inward connection object that define association with the first run-time bi-directional node and the third run-time bi-directional node, respectively,
wherein the first outward connection object and the second outward connection object constitute an outward group object associated with the first run-time bi-directional node, and
wherein the operation associated with the stimulus is executed further based on the outward group object, the third run-time bi-directional node, and the third run-time connection link.

11. The overlay system of claim 10, wherein the operation is executed based on the first run-time bi-directional node communicating with the second run-time bi-directional node and the third run-time bi-directional node by way of the outward group object.

12. The overlay system of claim 10,
wherein the executable graph-based model further includes a plurality of run-time bi-directional overlay nodes with each run-time bi-directional overlay node including (i) an overlay node template that corresponds to a predefined bi-directional overlay node structure, and (ii) an overlay node instance that corresponds to an implementation of the overlay node template,
wherein the processing circuitry is further configured to determine a fifth set of run-time bi-directional overlay nodes, of the plurality of run-time bi-directional overlay nodes, that is associated with the outward group object,
wherein each of the fifth set of run-time bi-directional overlay nodes is configured to extend functionality of the outward group object, and
wherein the operation associated with the stimulus is executed further based on the fifth set of run-time bi-directional overlay nodes.

13. The overlay system of claim 1,
wherein the first run-time bi-directional node is further coupled to a fourth run-time bi-directional node and a fifth run-time bi-directional node, of the plurality of run-time bi-directional nodes, by way of a fourth run-time connection link and a fifth run-time connection link, of the plurality of run-time connection links, respectively,
wherein the fourth run-time connection link includes a third inward connection object and a third outward connection object that define association with the first run-time bi-directional node and the fourth run-time bi-directional node, respectively,
wherein the fifth run-time connection link includes a fourth inward connection object and a fourth outward connection object that define association with the first run-time bi-directional node and the fifth run-time bi-directional node, respectively,
wherein the third inward connection object and the fourth inward connection object constitute an inward group object associated with the first run-time bi-directional node, and
wherein the operation associated with the stimulus is executed further based on the inward group object, the fourth run-time bi-directional node, the fifth run-time bi-directional node, the fourth run-time connection link, and the fifth run-time connection link.

14. The overlay system of claim 13, wherein the operation is executed further based on the first run-time bi-directional node communicating with the fourth run-time bi-directional node and the fifth run-time bi-directional node by way of the inward group object.

15. The overlay system of claim 13,
wherein the executable graph-based model further includes a plurality of run-time bi-directional overlay nodes with each run-time bi-directional overlay node including (i) an overlay node template that corresponds to a predefined bi-directional overlay node structure, and (ii) an overlay node instance that corresponds to an implementation of the overlay node template,
wherein the processing circuitry is further configured to determine a sixth set of run-time bi-directional overlay nodes, of the plurality of run-time bi-directional overlay nodes, that is associated with the inward group object,
wherein each of the sixth set of run-time bi-directional overlay nodes is configured to extend functionality of the inward group object, and
wherein the operation associated with the stimulus is executed further based on the sixth set of run-time bi-directional overlay nodes.

16. The overlay system of claim 1,
wherein the first run-time connection link is indicative of a dependency between the first run-time bi-directional node and the second run-time bi-directional node,
wherein the dependency between the first run-time bi-directional node and the second run-time bi-directional node is one of a group consisting of: an own-owned dependency, a use-used dependency, and a share-shared dependency,
wherein based on the dependency being the own-owned dependency, the first run-time bi-directional node owns the second run-time bi-directional node,
wherein based on the dependency being the share-shared dependency, the first run-time bi-directional node shares the second run-time bi-directional node with one or more run-time bi-directional nodes of the plurality of run-time bi-directional nodes, and
wherein based on the dependency being the use-used dependency, the first run-time bi-directional node uses the second run-time bi-directional node based on an absence of simultaneous use of the second run-time bi-directional node by one or more other run-time bi-directional nodes of the plurality of run-time bi-directional nodes.

17. The overlay system of claim 1, wherein at least one of the first inward connection object and the first outward connection object is associated with a set of attributes pertaining to a loading strategy associated with at least one of from a group consisting of the first run-time bi-directional node and the second run-time bi-directional node.

18. The overlay system of claim 1,
wherein the second run-time bi-directional node is further associated with a seventh run-time bi-directional node of the plurality of run-time bi-directional nodes by way of a sixth run-time connection link, and
wherein the sixth run-time connection link includes the first inward connection object and a fifth outward connection object that define association with the second run-time bi-directional node and the seventh run-time bi-directional node, respectively.

19. The overlay system of claim 1, wherein the first run-time bi-directional node and the second run-time bi-directional node have a same node template and different node instances.

20. A method, comprising:
receiving, by processing circuitry of an overlay system, a stimulus,
wherein an executable graph-based model is stored in a storage element of the overlay system,
wherein the executable graph-based model includes a plurality of run-time bi-directional nodes and a plurality of run-time connection links, and
wherein each run-time bi-directional node includes (i) a node template that corresponds to a predefined bi-directional node structure, and (ii) a node instance that corresponds to an implementation of the node template;
identifying, by the processing circuitry, based on the stimulus, a first run-time bi-directional node from the plurality of run-time bi-directional nodes;
determining, by the processing circuitry, a first run-time connection link, of the plurality of run-time connection links, coupled to the first run-time bi-directional node, the first run-time connection link including a first outward connection object defining association with the first run-time bi-directional node and a first inward connection object defining association with a second run-time bi-directional node of the plurality of run-time bi-directional nodes;
identifying, by the processing circuitry, based on the first run-time connection link, the second run-time bi-directional node;
loading, by the processing circuitry, based on the first run-time connection link, the second run-time bi-directional node from the storage element; and
executing, by the processing circuitry, an operation associated with the stimulus based on the first run-time bi-directional node, the second run-time bi-directional node, and the first run-time connection link.
